(19) United States
(12) Patent Application Publication
(10) Pub. No.: US 2016/0316759 A1
(43) Pub. Date: Nov. 3, 2016

(54) MIXTURES COMPRISING A SUPERABSORBENT POLYMER (SAP) AND A BIOPESTICIDE

(71) Applicant: BASF SE, Ludwigshafen (DE)

(72) Inventors: Jeremy BOUGOURE, Willagee (AU); Richard FLAVEL, Armidale (AU); Alban GLASER, Mannheim (DE); Harald KOEHLE, Bobenheim (DE); David MAINWARING, Parkville (AU); Tina MARK, Hassloch (DE); Falko MATHES, Bedford (AU); Daniel MURPHY, Woodvale (AU); Pandiyan MURUGARAJ, Clayton South (AU); Jeremy David PEARCE, Bosham, West Sussex (GB); Geetha PERERA, Palmerston (AU); Pilar PUENTE, Speyer (DE); Angel RODRIGUEZ-TELLO, El Bosque (ES); Peter RYAN, Watson (AU); Jorge SANZ-GOMEZ, Heidelberg (DE); Stephan SAUM, Speyer (DE); Markus SCHMID, Deidesheim (DE); Michael SEUFERT, Bad Duerkheim (DE); Vi Khanh TRUONG, Sunshine (AU); Michelle WATT, Griffith (AU); Alexander WISSEMEIER, Speyer (DE)

(21) Appl. No.: 15/105,249

(22) PCT Filed: Dec. 19, 2014
(86) PCT No.: PCT/EP2014/078774

§ 371 Date: Jun. 16, 2016

(30) Foreign Application Priority Data
Dec. 19, 2013 (EP) 13198612.7

(51) Int. Cl. A01N 63/00; A01N 63/04; C05G 3/04; C09K 17/32; C09K 17/18; C05G 3/02; A01N 63/02; A01N 25/10

(52) U.S. Cl. CPC A01N 63/00; A01N 63/02; A01N 63/04; A01N 25/10; C09K 17/32; C09K 17/18; C05G 3/02; C05G 3/04

(57) ABSTRACT

A mixture or kit-of-parts comprising a superabsorbent polymer (hereinafter referred to as “SAP” or “SAPs”) and a biopesticide, their application in agriculture, or the method for conducting the combined application of SAP and biopesticide in agriculture.

The present invention relates to a mixture or kit-of-parts comprising a superabsorbent polymer (hereinafter referred to as “SAP” or “SAPs”) and a biopesticide, their application in agriculture, or the method for conducting the combined application of SAP and biopesticide in agriculture.

### DESCRIPTION OF THE PRIOR ART

GB 2492171 A discloses a sanitary article comprising at least one biodegradable plastic material characterized in that Bacillus spores are incorporated into the polymer matrix of said biodegradable plastic material. The Bacillus spores according to the invention of GB 2492171 A are non-pathogenic and may, for example, be any of B. subtilis (ATCC 6633), B. megaterium (DSM 32), B. pumilus (ATCC 14884), B. licheniformis (DSM 13), B. mycoides (ATCC 6462), B. stearotermophifus (DSM 22), B. polymyxa (DSM 36). The biodegradable plastic material is for example made of any of the following materials: cellulose based materials including lyocell, cellofane and viscose; materials based on starch or modified starch; materials based on other naturally occurring polymers or monomers including polylactic acid (PLA), or bacterially produced polyesters (ex PHAs), and chitosan.

KR101054689 B1 discloses a soil conditioner comprising
absorptive high molecular resin (100 parts by weight),
chitosan with a molecular weight of 1,000 to 5,000 (30 to 70 parts by weight),
culture (20 to 40 parts by weight) obtained by inoculating at least one selected from the group consisting of Bacillus subtilis, Lactobacillus, yeast and fungi,
muscovite (20 to 40 parts by weight), and
calcium oxide powder (20 to 40 parts by weight).

WO 2009/050482 A1 discloses a method of delivering a biopesticide to a plant, the method comprising (i) providing a pesticidal composition comprising an absorbent, water and a biopesticide; and (ii) applying the pesticidal composition to the plant. The biopesticide can comprise a bioactive organism which is for example an entomopathogenic nematode such as a Steinernema or Heterorhabditis species. Examples of suitable absorbents include starch, methyl cellulose powder, polyacrylate starch powder and anhydrous polyacrylamide. The pesticidal composition can for example be a paste having a viscosity in the range of from 0.5-107 mPa/s.

Yanyan Zhao, Shaotong Jiang, “Study on biodegradation of starch graft sodium acrylate superabsorbent”, in: Journal of Hefei University of Technology, Vol. 32, No. 6, June 2009, page 841-844, discloses the biodegradation of a starch graft sodium acrylate superabsorbent film coated with a dispersion containing Aspergillus niger, Aspergillus oryzae, Bacillus subtilis or Bacillus licheniformis and placed into an inorganic salt nutrient plate. This starch graft sodium acrylate superabsorbent is prepared in the following way:

4.0 g potato starch and an appropriate amount of deionized water was placed at room temperature into 250 mL beaker under magnetic stirring, sodium hydroxide was added to form a paste for 30 min, then the partially neutralized sodium acrylate monomer and potassium persulfate and glycerol solution were added, the reaction mixture was stirred, placed into the oven, and dried at 70° C., the superabsorbent was obtained after crushing (preparation method see: Shaotong Jiang, Yahua Wu, Yan-yan Zhao, “New method of preparing the super absorbent polymer with sweet potato starch”, in: Journal of Hefei University of Technology, Vol. 29, No. 3, March 2006, page 260-263)

SAPs are generally materials that imbibe or absorb at least 10 times their own weight in aqueous fluid and that retain the imbibed or absorbed aqueous fluid under moderate pressure. The imbibed or absorbed aqueous fluid is taken into the molecular structure of the SAP rather than being contained in pores from which the fluid could be eliminated by squeezing. Some SAPs can absorb up to, or more than, 1,000 times their weight in aqueous fluid. In one embodiment, SAPs can absorb between 200 to 600 times their weight in aqueous fluid.

SAPs may be used in agricultural or horticultural applications. The terms “agriculture”/“agricultural” and “horticulture”/“horticultural” are used synonymously and interchangeably throughout the present disclosure. Applying SAPs to soil in agricultural settings have resulted in earlier seed germination and/or blooming, decreased irrigation requirements, increased propagation, increased crop growth and production, increased crop quality, decreased soil crusting, increased yield and decreased time of emergence.

Biopesticides have been defined as a form of pesticides based on micro-organisms (bacteria, fungi, viruses, nematodes, etc.) or natural products (compounds, such as metabolites, proteins, or extracts from biological or other natural sources). The biopesticide does not necessary need to have a pesticidal effect, micro-organisms having for example plant health effects, plant growth regulating effects, nitrogen management effects or micro-organisms improving plant defense etc. are also understood to be biopesticides in the context of this patent application.

Biopesticides are typically created by growing and concentrating naturally occurring organisms and/or their metabolites including bacteria and other microbes, fungi, viruses, nematodes, proteins, etc. They are often considered to be important components of integrated pest management (IPM) programmes, and have received much practical attention as substitutes to synthetic chemical plant protection products (PPPs).

Biopesticides fall into two major classes, microbial and biochemical pesticides:
(1) Microbial pesticides consist of bacteria, fungi or viruses (and often include the metabolites that bacteria and fungi produce). Entomopathogenic nematodes are also classified as microbial pesticides, even though they are multi-cellular.
(2) Biochemical pesticides are naturally occurring substances or structurally-similar and functionally identical to a naturally-occurring substance and extracts from biological sources that control pests or provide other crop protection uses as defined below, but have non-toxic mode of actions (such as growth or developmental regulation, attractents, repellents or defense activators (e.g. induced resistance) and are relatively non-toxic to mammals.

Examples for biochemical pesticides include, but are not limited to semiochemicals (insect pheromones and kairomones), natural plant and insect regulators, naturally-occurring repellents and attractants, and proteins (e.g. enzymes).

### OBJECTS OF THE INVENTION

The object of the present invention is to:
(i) enhance the water storage capacity of the soil, and/or
(ii) improve the water use efficiency and drought resistance, and/or
(iii) prevent nutrient leaching and improve cation exchange capacity (CEC) of the SAP, and/or
(iv) improve the nutrient use efficiency, and/or
(v) improve the biodegradation of the SAP, and/or
(vi) improve the delivery of the biopesticide to the plant, and/or
(vii) improve the plant growth (e.g. biomass, yield, root branching and length; compact growth in case of ornamental plants),
(viii) enable a better developed root system, a larger leaf area, greener leaves, and/or stronger shoots and/or
(ix) improve the plant defense of the plants, and/or
(x) improve the plant health of the plants, and/or
(xi) improve the storage or survivability of the biopesticide, and/or
(xii) enhance the pesticidal effect of the biopesticide,
(xiii) create artificial humus, and/or
(xiv) increase the survivability rate of seedlings, for example transplanted seedlings, and/or
(xv) reduce the toxicity in the soil, for example by complexing toxic ions such as Aluminium(III) ions, and/or
(xvi) improve the irrigation with brackish or saline water, and/or
(xvii) reduce or avoid unfavorable environmental or toxicological effects whilst still allowing effective pest control, and/or
(xviii) enable earlier seed germination and/or blooming, and/or
(xix) decrease soil crusting, and/or
(xx) reduce the dosage rate of the biopesticide, and/or
(xxi) enhance the spectrum of the activity of the biopesticide, and/or
(xxii) enhance the interaction between biopesticide, SAP, rhizosphere and the plant, and/or
(xxiii) enhance the non-pesticidal effect, such as plant health, plant defense, plant growth regulating or nitrogen management effects, of the biopesticide, and/or
(xxiv) enhance the nitrogen-fixation rate of the plants, and/or
(xxv) prolong the availability of biopesticides to the plants, and/or
(xxvi) enable a new way of applying biopesticides.

The objects (vii), (viii), (ix), (x) and (xiv) particularly pertains to such plants or seedlings wherein such plants or seedlings were, or the soil in which the such plants or seedlings were placed was subject to the application of the mixture or kit-of-parts of the present invention or subject to the combined application of the present invention.

The preferred objects of the present invention are (i), (ii), (iii), (iv), (v), (vi), (vii), (viii), (xiii), (xv) and/or (xviii), the more preferred objects of the present invention are (ii), (iii), (iv), (v), (vi), (vii) and/or (xv), the most preferred objects of the present invention are (ii), (iv) and/or (vii).

The term “plant or plants” is to be understood as plants of economic importance and/or men-grown plants. They are preferably selected from agricultural, silvicultural, ornamental and horticultural plants, each in its natural or genetically modified form. The term “plant” as used herein includes all parts of a plant such as germinating seeds, emerging seedlings, herbaceous vegetation as well as established woody plants including all belowground portions (such as the roots) and aboveground portions.

The term “soil” is to be understood as a natural body comprised of living (e.g. microorganisms (such as bacteria and fungi), animals and plants) and non-living matter (e.g. minerals and organic matter (e.g. organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

The term “plant health” is to be understood to denote a condition of the plant and/or its products which is determined by several indicators alone or in combination with each other such as yield (e. g. increased biomass and/or increased content of valuable ingredients), plant vigor (e. g. improved plant growth and/or greener leaves (“greening effect”)), quality (e. g. improved content or composition of certain ingredients) and tolerance to abiotic and/or biotic stress. The above identified indicators for the health condition of a plant may be interdependent, or may result from each other.

The term “kit-of-parts” is to be understood to denote a kit comprising at least two separate parts wherein each of the parts can be independently removed from the kit. A kit includes a box, a tool, a vessel, a container, a bag or any kit-like equipment. Also a kit whose separate parts are only together in this one kit for a extremely short period of time are regarded as kit-of-parts. Kit-of-parts are useful for the combined application (of the contents) of the separate parts of the kit.

Thus, the present invention relates to a mixture or kit-of-parts comprising:
1) at least one superabsorbent polymer (S) selected from the groups (S10), (S20), (S30), (S40), (S50), (S60), (S70), (S80), and (S90):
(S10) Peptide/protein-based SAP selected from the groups (S11), (S12), and (S13):
   (S11) Naturally occurring peptide/protein-based SAP: elastin, collagen, Gelatin A, Gelatin B, silk fibroin, globular proteins, beta-lactoglobulin, bovine serum albumin, ovalbumin;
   (S12) Semi-synthetic or fully-synthetic peptide/protein-based SAP: collagen-based synthetic hydrogels, elastin-like polypeptides, silk-elastin-like polypeptides, hydrogels based on a coiled coil motif, triblock polypeptides, polyaspartic acid, polyaspartates, polyglutamic acid, polyglutamates;
   (S13) Peptide/protein-based SAP other than those listed in (S11) or (S12);
(S20) Polysaccharide selected from the groups (S21), (S22), (S23), (S24), and (S25):
   (S21) Naturally occurring polysaccharide: agar, alginate, beta-glucan, carrageenan, cellulose, micro-/nanofibrillar cellulose, chitin, dextran, galactomannan, glucomannan, guar gum, gum arabic, hyaluronan, pectin starch, starch, starch derivatives, xanthan;
   (S22) Semi-synthetic or fully-synthetic polysaccharide: carboxymethyl starch (CMS), sulfoethyl starch (SES), carboxymethyl cellulose (CMC), sulfoethyl cellulose (SEC), hydroxypropyl cellulose, hydroxyethyl cellulose, methylcellulose, chitosan;
   (S23) Cross-linked polysaccharide: CMS cross-linked with multi-functional carboxylic acids (MFC) or multi-functional epoxides (MFE), SES cross-linked with MFC or MFE, CMC cross-linked with MFC or MFE, SEC cross-linked with MFC or MFE, hydroxypropyl cellulose cross-linked with MFC or MFE, hydroxyethyl cellulose cross-linked with MFC or MFE, methylcellulose cross-linked with MFC or MFE, chitosan cross-linked with MFC or MFE;
   (S24) Polysaccharide graft copolymer: Polysaccharides obtained by graft polymerizing a monomer onto a polysaccharide, wherein the monomer is selected from acrylonitrile, acrylic acid, methacrylic acid, acrylamide, methacrylamide, 2-acrylamido-2-methyl-propanesulfonic acid (AMPS), vinyl sulfonic acid, ethyl acrylate, and potassium acrylate;
   (S25) Polysaccharide other than those listed in (S21), (S22), (S23) or (S24);
(S30) Polymer containing one or more unsaturated carboxylic acid, or its salts thereof, as monomeric units, selected from the groups (S31), (S32), (S33), (S34), and (S35):
   (S31) Polymer containing acrylic acid, or its salts thereof, as monomeric units;
   (S32) Polymer containing methacrylic acid, or its salts thereof, as monomeric units;
   (S33) Polymer containing as monomeric units at least one of the unsaturated carboxylic acids—or salts thereof—selected from: crotonic acid, isocrotonic acid, 2′-methylisocrotonic acid, maleic acid, fumaric acid, vinyl acetic acid, ethacrylic acid, alpha-chloroacrylic acid, alpha-cyanoacrylic acid, alpha-phenylacrylic acid, beta-acryloxypropionic acid, sorbinic acid, alpha-chlorosorbinic acid, cinnamic acid, p-chlorocinnamic acid, beta-stearic acid, itaconic acid, citraconic acid, mesaconic acid, glutaconic acid, aconitic acid, tricarboxy ethylene, and maleic acid anhydride;
   (S34) Polymer containing as monomeric units at least one of the unsaturated carboxylic acids—or salts thereof—selected from: terephthalic acid, dimethyl terephthalate, phthalic acid, isophthalic acid, naphthalene dicarboxylic acid, 4-hydroxybenzoic acid, 6-hydroxynaphthalene-2-carboxylic add:
   (S35) Polymer containing as monomeric units one or more unsaturated carboxylic acid—or salts thereof—which are not listed in (S31), (S32), (S33), or (S34);
(S40) Polymer containing one or more unsaturated sulfonic acid, or one or more unsaturated phosphonic acid, or its salts thereof, as monomeric units, selected from the groups (S41), (S42), and (S43):
   (S41) Polymer containing as monomeric units at least one of the unsaturated sulfonic acids—or salts thereof—selected from: 2-acrylamido-2-methyl-1-propanesulfonic acid (AMPS), methallyl sulfonic acid, allyl sulfonic acid, acrylic sulfonic acid, methacrylic sulfonic acid, vinyl sulfonic acid, 4-vinylbenzylsulfonic acid, vinyltoluenesulfonic acid, styrenesulfonic acid, sulfoethyl(meth)acrylate, sulfopropyl(meth)acrylate, and 2-hydroxy-3-methacryloxypropylsulfonic acid;
   (S42) Polymer containing as monomeric units at least one of the unsaturated phosphonic acids—or salts thereof—selected from: vinylphosphonic acid, allylphosphonic acid, vinylbenzylphosphonic acid, (meth)acrylamidoalkylphosphonic acids, acrylamidoalkyldiphosphonic acids, phosphonomethylated vinylamines and (meth)acrylphosphonic acid derivatives;
   (S43) Polymer containing as monomeric units one or more unsaturated sulfonic acids not listed in (S41) or one or more unsaturated phosphonic acids not listed in (S42);
(S50) Polymer containing one or more amines or amides as monomeric units, selected from the groups (S51), (S52), (S53), (S54) and (S55):
   (S51) Polymer containing acrylamide or methacrylamide as monomeric units;
   (S52) Polymer containing as monomeric units at least one of the unsaturated amides selected from; N-methylol(meth)acrylamide, N, N-dimethylamino(meth)acrylamide, dimethyl(meth)acrylamide, diethyl(meth)acrylamide, N-vinylamides, N-vinylformamides, N-vinylacetamides, N-vinyl-N-methylacetamide, N-vinyl-N-methylformamides, vinylpyrrolidone;
   (S53) Polymer containing as monomeric units one or more amides not listed in (S51) or (S52);
   (S54) Polymer containing as monomeric units at least one primary amine, secondary amine, tertiary amine, or quarternary ammonium salt;
   (S55) Polyamidoamines;
(S60) Polymer containing optionally cross-linked polyethers or polyols, selected from the groups (S61), (S62), (S63), (S64), and (S65):
   (S61) Polymer containing optionally cross-linked polyethylene glycol (PEG);
   (S62) Polymer containing optionally cross-linked polypropylene glycol (PPG) or poly(oxyethylene-oxypropylene) copolymer;
   (S63) Polymer containing at least one optionally cross-linked polyether selected from: polyoxymethylene, poly(tetrahydrofuran), polyphenyl ether (PPE), and poly(p-phenylene oxide) (PPO);
   (S64) Polymer containing optionally cross-linked polyvinyl alcohol;
   (S65) Polymer containing optionally cross-linked polyethers or polyols not listed in (S61), (S62), (S63) or (S64);
(S70) Polymer selected from the groups (S71), (S72), (S73), and (S74):
   (S71) Polymer containing monoethylenically unsaturated acidic group-containing monomers S70A and monoethylenically unsaturated monomers S70B which are cross-linked with at least one cross-linker S71C selected from: alkenyldi(meth)acrylates, ethyleneglycoldi(meth)acrylate, 1,3-propyleneglycoldi(meth)acrylate, 1,4-butyleneglycoldi(meth)acrylate, 1,3-butyleneglycoldi(meth)acrylate, 1,6-hexanedioldi(meth)acrylate, 1,10-decanedioldi(meth)acrylate, 1,12-dodecanedioldi(meth)acrylate, 1,18-octadecanedioldi(meth)acrylate, cyclopentanedioldi(meth)acrylate, neopentylglycoldi(meth)acrylate, methylenedi(meth)acrylate or pentaerythritoldi(meth)acrylate, alkenyldi(meth)acrylamides, N-methyldi(meth)acrylamide, N,N′-3-methylbutylidenebis(meth)acrylamide, N, N′-(1,2-dihydroxyethylene)bis(meth)acrylamide, N,N′-hexamethylenebis(meth)acrylamide or N,N′-methylenebis(meth)acrylamide, polyalkoxydi(meth)acrylates, diethyleneglycoldi(meth)acrylate, triethyleneglycoldi(meth)acrylate, tetraethyleneglycoldi(meth)acrylate, dipropyleneglycoldi(meth)acrylate, tripropyleneglycoldi(meth)acrylate or tetrapropyleneglycoldi(meth)acrylate, bisphenol-A-di(meth)acrylate, ethoxylated bisphenol-A-di(meth)acrylate, benzylidenedi(meth)acrylate, 1,3-di(meth)acryloyloxypropanol-2, hydroquinonedi(meth)acrylate, di(meth)acrylate esters of trimethylolpropane, ethoxylated di(meth)acrylate esters of trimethylolpropane, thioethyleneglycoldi(meth)acrylate, thiopropyleneglycoldi(meth)acrylate, thiopolyethyleneglycoldi(meth)acrylate, thiopolypropyleneglycoldi(meth)acrylate, divinyl ethers, 1,4-butanedioldivinylether, divinyl esters, divinyladipate, alkanedienes, butadiene or 1,6-hexadiene, divinylbenzene, di(meth)allyl compounds, di(meth)allylphthalate or di(meth)allylsuccinate, homo- and co-polymers of di(meth)allyldimethylammonium chloride and homo- and co-polymers of diethyl(meth)allylaminomethyl(meth)acrylateammonium chloride, vinyl(meth)acrylic compounds, vinyl(meth)acrylate, (meth)allyl(meth)acrylic compounds, (meth)allyl(meth)acrylate, (meth)allyl(meth)acrylate ethoxylated with 1 to 30 mol ethylene oxide per hydroxyl group, di(meth)allylesters of polycarbonic acids, di(meth)allylmaleate, di(meth)allylfumarate, di(meth)allylsuccinate or di(meth)allylterephthalate, compounds with 3 or more ethylenically unsaturated, glycerine tri(meth)acrylate, (meth)acrylate esters of glycerins which are ethoxylated, trimethylolpropanetri(meth)acrylate, tri(meth)acrylate esters of trimethylolpropane, ethoxylated tri(meth)acrylate esters of trimethylolpropane, trimethacrylamide, (meth)allylidenedi(meth)acrylate, 3-allyloxy-1,2-propanedioldi(meth)acrylate, tri(meth)allylcyanurate, tri(meth)allylisocyanurate, pentaerythritoltetra(meth)acrylate, pentaerythritoltri(meth)acrylate, (meth)acrylic acid esters of pentaerythritol which is ethoxylated, tris(2-hydroxyethyl)isocyanuratetri(meth)acrylate, trivinyltrimellitate, tri(meth)allylamine, di(meth)allylalkylamines, di(meth)allylmethylamine, tri(meth)allylphosphate, tetra(meth)allylethylenediamine, poly(meth)allyl ester, tetra(meth)allyloxyethane or tetra(meth)allylammonium halides;
   (S72) Polymer containing monoethylenically unsaturated acidic group-containing monomers S70A and monoethylenically unsaturated monomers S70B which are cross-linked with at least one cross-linker S72C selected from:
      polyols, ethyleneglycol, polyethyleneglycols, diethyleneglycol, triethyleneglycol, tetraethyleneglycol, propyleneglycol, polypropyleneglycols, dipropyleneglycol, tripropyleneglycol, tetrapropyleneglycol, 1,3-butanediol, 1,4-butanediol, 1,5-pentanediol, 2,4-pentanediol, 1,6-hexanediol, 2,5-hexanediol, glycerine, polyglycerin, trimethylolpropane, polyoxypropylene, oxyethylene-oxypropylene-block copolymer, sorbitan fatty acid esters, polyoxyethylenesorbitan fatty acid esters, pentaerythritol, polyvinylalcohol and sorbitol, aminoalcohols, ethanolamine, diethanolamine, triethanolamine or propanolamine, polyamine compounds, ethylenediamine, diethylenetriamine, triethylenetetraamine, tetraethylenepentaamine or pentaethylenehexaamine, polyglycidyl ether compounds, ethyleneglycoldiglycidyl ether, polyethyleneglycoldiglycidyl ether, glycerinediglycidyl ether, glycerinepolyglycidyl ether, pentaerithritolpolyglycidyl ether, propyleneglycoldiglycidyl ether, polypropyleneglycoldiglycidyl ether, neopentylglycoldiglycidyl ether, hexanediolglycidyl ether, trimethylolpropanepolyglycidyl ether, sorbitolpolyglycidyl ether, phthalic acid diglycidyl ester, adipinic acid diglycidyl ether, 1,4-phenylenebis(2-oxazoline), glycidol, polyisocyanates, diisocyanates, 2,4-toluenediioscyanate, hexamethylenediisocyanate, polyaziridine compounds, 2,2-bishydroxymethyl butanol-tris[3-(1-aziridinyl-)propionate], 1,6-hexamethylenediethyleneurea, di phenylmethane-bis-4,4′-N, N′-diethyleneurea, halogen epoxides, epichlorohydrin, epibromohydrin and alpha-methylepichlorohydrin, alkylenecarbonates, 1,3-dioxolane-2-one (ethylene carbonate), 4-methyl-1, 3-dioxolane-2-one(propylene carbonate), 4,5-dimethyl-1,3-dioxolane-2-one, 4,4-dimethyl-1,3-dioxolane-2-one, 4-ethyl-1, 3-dioxolane-2-one, 4-hydroxymethyl-1,3-dioxolane-2-one, 1, 3-dioxane-2-one, 4-methyl-1,3-dioxane-2-one, 4,6-dimethyl-1,3-dioxane-2-one, 1,3-dioxolane-2-one, poly-1,3-dioxolane-2-one, polyquaternary amines, condensation products from dimethylamines and epichlorohydrin, polyoxazolines, 1, 2-ethylenebisoxazoline, crosslinkers with silane groups, 7-glycidooxypropyltrimethoxysilane, 7-aminopropyltrimethoxysilane, oxazolidinones, 2-oxazolidinone, bis- and poly-2-oxazolidinone and diglycolsilicates;
   (S73) Polymer containing monoethylenically unsaturated acidic group-containing monomers S70A and monoethylenically unsaturated monomers S70B which are cross-linked with at least one cross-linker S73C selected from:
      hydroxyl or amino group-containing esters of (meth)acrylic acid, 2-hydroxyethyl(meth)acrylate, as well as hydroxyl or amino group-containing (meth)acrylamides, or mono(meth)allylic compounds of diols;
   (S74) Polymer containing monoethylenically unsaturated acidic group-containing monomers S70A and monoethylenically unsaturated monomers S70B which are cross-linked with at least one polyvalent metal cross-linker S74C selected from:
      singly charged cations,
      doubly charged cations derived from zinc, beryllium, alkaline earth metals, magnesium, calcium, strontium,
      cations with higher charge selected from cations from aluminium, iron, chromium, manganese, titanium, zirconium and other transition metals as well as double salts of such cations or mixtures of said salts;
(S80) Polymer selected from the groups (S81), (S82), (S83), (S84), (S85), (S86), and (S87):
   (S81) Polymer produced by the process disclosed in WO2013/060848;
   (S82) polymer produced by the process (S80P1);
   (S83) polymer produced by the process (S80P2);
   (S84) polymer mixed or grafted with lignocellulose material;
   (S85) polymer mixed or grafted with lignocellulose material selected from list (S80L1);
   (S86) polymer containing acrylic acid, or its salts thereof, as monomeric units, mixed or grafted with lignocellulose material selected from list (S80L1);
   (S87) polymer selected from the groups (S11), (S12), (S13), (S21), (S22), (S23), (S24), (S25), (S32), (S33), (S34), (S35), (S41), (S42), (S43), (S51), (S52), (S53), (S54), (S55), (S61), (S62), (S63), (S64), (S65), (S71), (S72), (S73), and (S74), mixed or grafted with lignocellulose material selected from list (S80L1),
   wherein (S80P1) is a process for producing polymer composites suitable for absorbing and storing aqueous liquids, comprising:
   a free-radical polymerization of a monomer composition S80M which
   a) 50 to 100% by weight, based on the total amount of monomers S80A and S80B, of at least one monomer S80A having one ethylenic double bond and at least one neutralizable acid group,
   b) 0 to 50% by weight of optionally one or more comonomers S80B which are different than the monomers S80A and have one ethylenic double bond, and
   c) 0 to 10% by weight, based on the total amount of monomers S80A and S80B, of at least one crosslinker S80C,
   in an aqueous suspension of a water-insoluble particulate substance S80S comprising cellulose or lignocellulose, the weight ratio of the monomer composition S80M to the substance S80S being in the range from 9:1 to 1:9;
   wherein the monomers S80A used for polymerization are present in the aqueous suspension in anionic form to an extent of at least 10 mol %,
   wherein (S80P2) is the process according to (S80P1), wherein the particulate substance S80S comprises a lignocellulose material and the substance S80S is selected to an extent of at least 50% by weight, based on the total amount of substance S80S, from the list (S80L1),
   wherein the list (S80L1) is: hemp dust, flax dust, sawdust, bran, ground straw, ground olive stones, ground tree bark, reject material from pulp production, sugar beet peel, sugar cane waste, rice husks, cereal husks, ground hemp fibers, ground flax fibers, ground Chinese silvergrass fibers, ground coconut fibers, ground kenaf fibers or ground wood fibers, pulp or mechanical pulp from papermaking, and wastes from biogas production,
(S90) Inorganic superabsorbent materials: phyllosilicates, phyllosilicates in form of exfoliated or semi-exfoliated clay, clay selected from the group consisting of smectites, hectorites, bentonites, montmorillonites, celites, illites and mixtures thereof;
and
2) at least one biopesticide (L) selected from the groups (L1), (L3), (L5) and (L7):
(L1) Microbial pesticides with fungicidal, bactericidal, viricidal and/or plant defense activator activity selected from:
   (L11) Ampelomyces quisqualis,
   (L12) Aspergillus flavus,
   (L13) Aureobasidium pullulans,
   (L14) Bacillus amyloliquefaciens,
   (L15) Bacillus mojavensis,
   (L16) Bacillus pumilus,
   (L17) Bacillus simplex,
   (L18) Bacillus solisalsi,
   (L19) Bacillus subtilis,
   (L20) Bacillus subtilis var. amyloliquefaciens,
   (L21) Candida oleophila, or C. saitoana,
   (L22) Clavibacter michiganensis (bacteriophages),
   (L23) Coniothyrium minitans,
   (L24) Cryphonectria parasitica,
   (L25) Cryptococcus albidus,
   (L26) Dilophosphora alopecuri,
   (L27) Fusarium oxysporum,
   (L28) Clonostachys rosea f. catenulate (also named Gliocladium catenulatum),
   (L29) Gliocladium roseum,
   (L30) Lysobacter antibioticus, or L. enzymogenes,
   (L31) Metschnikowia fructicola,
   (L32) Microdochium dimerum,
   (L33) Microsphaeropsis ochracea,
   (L34) Muscodor albus,
   (L35) Paenibacillus polymyxa,
   (L36) Pantoea vagans,
   (L37) Phlebiopsis gigantea,
   (L38) Pseudomonas sp., or Pseudomonas chloraphis,
   (L39) Pseudozyma flocculosa,
   (L40) Pichia anomala,
   (L41) Pythium oligandrum,
   (L42) Sphaerodes mycoparasitica,
   (L43) Streptomyces griseoviridis, S. lydicus, or S. violaceusniger,
   (L44) Talaromyces flavus,
   (L45) Trichoderma asperellum, T. atroviride, T. fertile, T. gamsii, T. harmatum, T. harzianum, T. stromaticum, T. virens (also named Gliocladium virens), T. viride, or mixture of T. harzianum and T. viride, or mixture of T. polysporum and T. harzianum,
   (L46) Typhula phacorrhiza,
   (L47) Ulocladium oudemansii,
   (L48) Verticillium dahlia,
   (L49) zucchini yellow mosaic virus (avirulent strain);
(L3) Microbial pesticides with insecticidal, acaricidal, molluscidal and/or nematicidal activity selected from:
   (L51) Agrobacterium radiobacter,
   (L52) Bacillus cereus,
   (L53) Bacillus firmus,
   (L54) Bacillus thuringiensis, B. t. ssp. aizawai, B. t. ssp. israelensis, B. t. ssp. galleriae, B. t. ssp. kurstaki, or B. t. ssp. tenebrionis,
   (L55) Beauveria bassiana, or B. brongniartii,
   (L56) Burkholderia sp.,
   (L57) Chromobacterium subtsugae,
   (L58) Cydia pomonella granulosis virus,
   (L59) Cryptophlebia leucotreta granulovirus (CrleGV),
   (L60) Isaria fumosorosea,
   (L61) Heterorhabditis bacteriophora,
   (L62) Lecanicillium longisporum, or L. muscarium (formerly Verticillium lecanii),
   (L63) Metarhizium anisopliae, or M. anisopliae var. acridum,
   (L64) Nomuraea rileyi,
   (L65) Paecilomyces fumosoroseus, or P. lilacinus,
   (L66) Paenibacillus popilliae,
   (L67) Pasteuria spp., P. nishizawae, P. penetrans, P. ramose, P. reneformis, P. thornea, or P. usgae,
   (L68) Pseudomonas fluorescens,
   (L69) Steinernema carpocapsae, S. feltiae, or S. kraussei;
(L5) Microbial pesticides with plant stress reducing, plant growth regulator, plant growth promoting and/or yield enhancing activity selected from:
   (L81) Azospirillum amazonense, A. brasilense, A. lipoferum, A. irakense, or A. halopraeferens,
   (L82) Bradyrhizobium sp., B. elkanii, B. japonicum, B. liaoningense, or B. lupini,
   (L83) Delftia acidovorans,
   (L84) VA mycorrhiza selected from the genera Glomus, Acaulospora, Entrophosphora, Gigaspora, Scutellospora and Sclerocytis,
   (L85) VA mycorrhiza selected from the group consisting of Glomus fasciculatum, G. caledonium, G. mosseae, G. versiforme, G. intraradices and G. etunicatum,
   (L86) Mesorhizobium sp.,
   (L87) Paenibacillus alvei,
   (L88) Penicillium bilaiae,
   (L89) Rhizobium leguminosarum bv. phaseoli, R. l. trifolii, R. l. bv. viciae, or R. tropici,
   (L90) Sinorhizobium meliloti,
   (L91) Enterobacter spp., E. ludwigii, E. aerogenes, E. amnigenus, E. agglomerans, E. arachidis, E. asburiae, E. cancerogenous, E. cloacae, E. cowanii, E. dissolvens, E. gergoviae, E. helveticus, E. hormaechei, E. intermedius, E. kobei, E. mori, E. nimipressuralis, E. oryzae, E. pulveris, E. pyrinus, E. radicincitans, E. taylorae, E. turicensis, or E. sakazakii,
   (L92) Oxalobacteraceae spp., Herbaspirillum seropedicae (DSM No.: 6445) (free-living nitrogen fixing bacterium), Janthinobacterium lividum (DSM No.: 1522) (violacein-producing bacterium), or Pseudoduganella violaceinigra (DSM No.: 15887) (violacein-producing bacterium);
(L7) Metabolites produced by the microbial pesticides selected from:
   (L93) siderophores, bacillibactin
   (L94) antibiotiics such as zwittermicin-A, kanosamine, polyoxine, bacilysin, violacein
   (L95) enzymes such as alpha-amylase, chitinases, pektinases, phosphatase (acid and alkaline) and phytase
   (L96) phytohormones and precursors thereof and volatile compounds, such as auxines, gibberellin-like substances, cytokinin-like compounds, acetoin, 2,3-butanediol, ethylene, indole acetic acid,
   (L97) lipopeptides such as iturins, plipastatins, surfactins, agrastatin, agrastatin A, bacillomycin, bacillomycin D, fengycin,
   (L98) antibacterial polyketides such as difficidin, macrolactin and bacilaene
   (L99) antifungal metabolites such as pyrones, cytosporone, 6-pentyl-2H-pyran-2-one (also termed 6-pentyl-a-pyrone), koninginins (complex pyranes), in particular those metabolites produced by Trichoderma species.
      Preferred metabolites are the above-listed lipopeptides (L105), in particular produced by B. subtilis and B. amyloliquefaciens. Further preferred metabolites are the antifungal metabolites (L107), in particular those produced by Trichoderma species, for example T. viride, T. atroviride, T. aureoviride, T. harzianum, T. koningii.
      For (S30) as well as for (S31) to (S35) as defined above, the polymers can also include other co-monomers known in the prior at. In case of salts, the preferred salts for (S30) as well as for (S31) to (S35) are alkali and/or ammonium salts.
      For (S40) as well as for (S41) to (S43) as defined above, the polymers can also include other co-monomers known in the prior at. In case of salts, the preferred salts for (S40) as well as for (S41) to (S43) are alkali and/or ammonium salts.
      The present invention also relates to the method for conducting the combined application of
   1) at least one superabsorbent polymer (S) selected from the groups (S10), (S20), (S30), (S40), (S50), (S60), (S70), (S80), and (S90) as defined above, and
   2) at least one biopesticide (L) selected from the groups (L1), (L3), (L5) and (L7) as defined above
      in agriculture, preferably for improving soil quality, enhancing plant growth, for the control of harmful fungi or insects, soil treatment or seed treatment, most preferably for improving soil quality and enhancing plant growth.
      The present invention also relates to the use of a mixture or kit-of-parts comprising
   1) at least one superabsorbent polymer (S) selected from the groups (S10), (S20), (S30), (S40), (S50), (S60), (S70), (S80), and (S90) as defined above, and
   2) at least one biopesticide (L) selected from the groups (L1), (L3), (L5) and (L7) as defined above
      in agriculture, preferably for improving soil quality, enhancing plant growth, for the control of harmful fungi or insects, soil treatment or seed treatment, most preferably for improving soil quality and enhancing plant growth.
      The term “combined application” means that the at least one SAP (S) and the at least one biopesticide (L) is applied on the same location and/or on the same locus and/or on the same plant either simultaneously or with a certain time lag (for example a day), and applied in such a way that the SAP (S) and the biopesticide (L) have interactions with each other. The term “interaction” means here that the biopesticide (L) benefits from certain effects induced by the SAP (S)—such as the enhanced water storage capacity or the improved nutrient use efficiency. The term “locus” (plant habitat) is to be understood as any type of environment, soil, area or material where the plant is growing or intended to grow. An especially preferred locus according to the invention is soil.

Moreover, we have found that simultaneous, that is joint or separate, application of a SAP (S) and a biopesticide (L) or successive application of an SAP (S) and a biopesticide (L) allows better fulfillment of the objects (i), (ii), (iii), (iv), (v), (vi), (vii), (viii), (xiii), (xv) and/or (xviii) of the present invention than it is possible with the individual components alone (synergistic mixtures).

When applying a SAP (S) and a biopesticide (L) sequentially the time between both applications may vary e.g. between 2 hours to 7 days. Also a broader range is possible ranging from 0.25 hour to 30 days, preferably from 0.5 hour to 14 days, particularly from 1 hour to 7 days or from 1.5 hours to 5 days, even more preferred from 2 hours to 1 day.

The biopesticides (L) their preparation and their pesticidal activity e. g. against harmful fungi or insects are known (e-Pesticide Manual V 5.2 (ISBN 978 1 901396 85 0) (2008-2011); http://www.epa.gov/opp00001/biopesticides/, see product lists therein; http://www.omri.org/omri-lists, see lists therein; Bio-Pesticides Database BPDB http://sitem.herts.ac.uk/aeru/bpdb/, see A to Z link therein).

The biopesticides from group (L1) may also have insecticidal, acaricidal, molluscidal, pheromone, nematicidal, plant stress reducing, plant growth regulator, plant growth promoting and/or yield enhancing activity. The biopesticides from group (L3) may also have fungicidal, bactericidal, viricidal, plant defense activator, plant stress reducing, plant growth regulator, plant growth promoting and/or yield enhancing activity. The biopesticides from group (L5) may also have fungicidal, bactericidal, viricidal, plant defense activator, insecticidal, acaricidal, molluscidal, pheromone and/or nematicidal activity.

Many of these biopesticides are registered and/or are commercially available: aluminium silicate (Screen™ Duo from Certis LLC, USA), Agrobacterium radiobacter K1026 (e. g. NoGall® from BASF Agricultural Specialties Pty Ltd, Australia), A. radiobacter K84 (Nature 280, 697-699, 1979; e. g. GallTroll® from AG Biochem, Inc., C, USA), Ampelomyces quisqualis M-10 (e. g. AQ 10® from Intrachem Bio GmbH & Co. KG, Germany), Ascophyllum nodosum (Norwegian kelp, Brown kelp) extract or filtrate (e. g. ORKA GOLD from BASF Agricultural Specialties (Ptyl) Ltd., South Africa; or Goemar® from Laboratories Goemar, France), Aspergillus flavus NRRL 21882 isolated from a peanut in Georgia in 1991 by the USDA, National Peanut Research Laboratory (e. g. in Afla-Guard® from Syngenta, CH), mixtures of Aureobasidium pullulans DSM14940 and DSM 14941 (e. g. blastospores in BlossomProtect® from bio-ferm GmbH, Germany), Azospirillum amazonense BR 11140 (SpY2^{T}) (Proc. 9^{th} Int. and 1^{st} Latin American PGPR meeting, Quimara, Medellín, Colombia 2012, p. 60, ISBN 978-958-46-0908-3), A. brasilense AZ39 (Eur. J. Soil Biol 45(1), 28-35, 2009), A. brasilense XOH (e. g. AZOS from Xtreme Gardening, USA or RTI Reforestation Technologies International; USA), A. brasilense BR 11002 (Proc. 9^{th} Int. and 1^{st} Latin American PGPR meeting, Quimara, Medellín, Colombia 2012, p. 60, ISBN 978-958-46-0908-3), A. brasilense BR 11005 (SP245; e. g. in GELFIX Gramineas from BASF Agricultural Specialties Ltd., Brazil), A. lipoferum BR 11646 (Sp31) (Proc. 9th Int. and 1^{st} Latin American PGPR meeting, Quimara, Medellín, Colombia 2012, p. 60), B. amyloliquefaciens IN937a (J. Microbiol. Biotechnol. 17(2), 280-286, 2007; e. g. in BioYield® from Gustafson LLC, TX, USA), B. amyloliquefaciens IT-45 (CNCM I-3800) (e. g. Rhizocell C from ITHEC, France), B. amyloliquefaciens ssp. plantarum MBI600 (NRRL B-50595, deposited at United States Department of Agriculture) (e. g. Integral®, Subtilex® NG from BASF Corp., RTP, NC, USA), B. cereus CNCM I-1562 (U.S. Pat. No. 6,406,690), B. firmus CNCM I-1582 (WO 2009/126473, WO 2009/124707, U.S. Pat. No. 6,406,690; Votivo® from Bayer Crop Science LLP, USA), B. pumilus GB34 (ATCC 700814; e. g. in YieldShield® from Gustafson LLC, TX, USA), and Bacillus pumilus KFP9F (NRRL B-50754) (e. g. in BAC-UP or FUSION-P from BASF Agricultural Specialties (Pty) Ltd., South Africa), B. pumilus QST 2808 (NRRL B-30087) (e. g. Sonata® and Ballad® Plus from AgraQuest Inc., USA), B. subtilis GB03 (e. g. Kodiak® or BioYield® from Gustafson, Inc., USA; or Companion® from Growth Products, Ltd., White Plains, N.Y. 10603, USA), B. subtilis GB07 (Epic® from Gustafson, Inc., USA), B. subtilis QST-713 (NRRL B-21661 in Rhapsody®, Serenade® MAX and Serenade® ASO from AgraQuest Inc., USA), B. subtilis var. amyloliquefaciens FZB24 (e. g. Taegro® from Novozyme Biologicals, Inc., USA), B. subtilis var. amyloliquefaciens D747 (e. g. Double Nickel 55 from Certis LLC, USA), B. thuringiensis ssp. aizawai ABTS-1857 (e. g. in XenTari® from BioFa AG, Münsingen, Germany), B. t. ssp. aizawai SAN 401 I, ABG-6305 and ABG-6346, Bacillus t. ssp. israelensis AM65-52 (e. g. in VectoBac® from Valent BioSciences, IL, USA), Bacillus thuringiensis ssp. kurstaki SB4 (NRRL B-50753; e. g. Beta Pro® from BASF Agricultural Specialities (Pty) Ltd., South Africa), B. t. ssp. kurstaki ABTS-351 identical to HD-1 (ATCC SD-1275; e. g. in Dipel® DF from Valent BioSciences, IL, USA), B. t. ssp. kurstaki EG 2348 (e. g. in Lepinox® or Rapax® from CBC (Europe) S.r.l., Italy), B. t. ssp. tenebrionis DSM 2803 (EP 0 585 215 B1; identical to NRRL B-15939; Mycogen Corp.), B. t. ssp. tenebrionis NB-125 (DSM 5526; EP 0 585 215 B1; also referred to as SAN 418 I or ABG-6479; former production strain of Novo-Nordisk), B. t. ssp. tenebrionis NB-176 (or NB-176-1) a gamma-irradiated, induced high-yielding mutant of strain NB-125 (DSM 5480; EP 585 215 B1; Novodor® from Valent BioSciences, Switzerland), Beauveria bassiana ATCC 74040 (e. g. in Naturalis® from CBC (Europe) S.r.l., Italy), B. bassiana DSM 12256 (US 200020031495; e. g. BioExpert® SC from Live Systems Technology S.A., Colombia), B. bassiana GHA (BotaniGard® 22WGP from Laverlam Int. Corp., USA), B. bassiana PPRI 5339 (ARSEF number 5339 in the USDA ARS collection of entomopathogenic fungal cultures; NRRL 50757) (e. g. BroadBand® from BASF Agricultural Specialities (Pty) Ltd., South Africa), B. brongniartii (e. g. in Melocont® from Agrifutur, Agrianello, Italy, for control of cockchafer; J. Appl. Microbiol. 100(5), 1063-72, 2006), Bradyrhizobium sp. (e. g. Vault® from BASF Corp., USA), B. japonicum (e. g. VAULT® from BASF Corp., USA), Candida oleophila I-182 (NRRL Y-18846; e. g. Aspire® from Ecogen Inc., USA, Phytoparasitica 23(3), 231-234, 1995), C. oleophila strain O (NRRL Y-2317; Biological Control 51, 403-408, 2009), Candida saitoana (e. g. Biocure® (in mixture with lysozyme) and BioCoat® from Micro Flo Company, USA (BASF SE) and Arysta), Chitosan (e. g. Armour-Zen® from BotriZen Ltd., NZ), Clonostachys rosea f. catenulata, also named Gliocladium catenulatum (e. g. isolate J 1446: Prestop® from Verdera Oy, Finland), Chromobacterium subtsugae PRAA4-1 isolated from soil under an eastern hemlock (Tsuga canadensis) in the Catoctin Mountain region of central Maryland (e. g. in GRANDEVO from Marrone Bio Innovations, USA), Coniothyrium minitans CON/M/91-08 (e. g. Contans® WG from Prophyta, Germany), Cryphonectria parasitica (e. g. Endothia parasitica from CNICM, France), Cryptococcus albidus (e. g. YIELD PLUS® from Anchor Bio-Technologies, South Africa), Cryptophlebia leucotreta granulovirus (CrleGV) (e. g. in CRYPTEX from Adermatt Biocontrol, Switzerland), Cydia pomonella granulovirus (CpGV) V03 (DSM GV-0006; e. g. in MADEX Max from Andermatt Biocontrol, Switzerland), CpGV V22 (DSM GV-0014; e. g. in MADEX Twin from Adermatt Biocontrol, Switzerland), Delftia acidovorans RAY209 (ATCC PTA-4249; WO 2003/57861; e. g. in BIOBOOST from Brett Young, Winnipeg, Canada), Dilophosphora alopecuri (Twist Fungus from BASF Agricultural Specialties Pty Ltd, Australia), Ecklonia maxima (kelp) extract (e. g. KELPAK SL from Kelp Products Ltd, South Africa), formononetin (e. g. in MYCONATE from Plant Health Care plc, U.K.), Fusarium oxysporum (e. g. BIOFOX® from S.I.A.P.A., Italy, FUSACLEAN® from Natural Plant Protection, France), Glomus intraradices (e. g. MYC 4000 from ITHEC, France), Glomus intraradices RTI-801 (e. g. MYKOS from Xtreme Gardening, USA or RTI Reforestation Technologies International; USA), grapefruit seeds and pulp extract (e. g. BC-1000 from Chemie S.A., Chile), harpin (alpha-beta) protein (e. g. MESSENGER or HARP-N-Tek from Plant Health Care plc, U.K.; Science 257, 1-132, 1992), Heterorhabditis bacteriophaga (e. g. Nemasys® G from BASF Agricultural Specialities Limited, UK), Isaria fumosorosea Apopka-97 (ATCC 20874) (PFR-97™ from Certis LLC, USA), cis-jasmone (U.S. Pat. No. 8,221,736), laminarin (e. g. in VACCIPLANT from Laboratories Goemar, St. Malo, France or Stähler SA, Switzerland), Lecanicillium longisporum KV42 and KV71 (e. g. VERTALEC® from Koppert BV, Netherlands), L. muscarium KV01 (formerly Verticillium lecanii) (e. g. MYCOTAL from Koppert BV, Netherlands), Lysobacter antibioticus 13-1 (Biological Control 45, 288-296, 2008), L. antibioticus HS124 (Curr. Microbiol. 59(6), 608-615, 2009), L. enzymogenes 3.1T8 (Microbiol. Res. 158, 107-115; Biological Control 31(2), 145-154, 2004), Metarhizium anisopliae var. acridum IMI 330189 (isolated from Ornithacris cavroisi in Niger; also NRRL 50758) (e. g. GREEN MUSCLE® from BASF Agricultural Specialities (Pty) Ltd., South Africa), M. a. var. acridum FI-985 (e. g. GREEN GUARD® SC from BASF Agricultural Specialties Pty Ltd, Australia), M. anisopliae FI-1045 (e. g. BIOCANE® from BASF Agricultural Specialties Pty Ltd, Australia), M. anisopliae F52 (DSM 3884, ATCC 90448; e. g. MET52® Novozymes Biologicals BioAg Group, Canada), M. anisopliae ICIPE 69 (e. g. METATHRIPOL from ICIPE, Nairobe, Kenya), Metschnikowia fructicola (NRRL Y-30752; e. g. SHEMER® from Agrogreen, Israel, now distributed by Bayer CropSciences, Germany; U.S. Pat. No. 6,994,849), Microdochium dimerum (e. g. ANTIBOT® from Agrauxine, France), Microsphaeropsis ochracea P130A (ATCC 74412 isolated from apple leaves from an abandoned orchard, St-Joseph-du-Lac, Quebec, Canada in 1993; Mycologia 94(2), 297-301, 2002), Muscodor albus QST 20799 originally isolated from the bark of a cinnamon tree in Honduras (e. g. in development products Muscudor™ or QRD300 from AgraQuest, USA), Neem oil (e. g. TRILOGY®, TRIACT® 70 EC from Certis LLC, USA), Nomuraea rileyi strains SA86101, GU87401, SR86151, CG128 and VA9101, Paecilomyces fumosoroseus FE 9901 (e. g. NO FLY™ from Natural Industries, Inc., USA), P. lilacinus 251 (e. g. in BioAct®/MeloCon® from Prophyta, Germany; Crop Protection 27, 352-361, 2008; originally isolated from infected nematode eggs in the Philippines), P. lilacinus DSM 15169 (e. g. NEMATA® SC from Live Systems Technology S.A., Colombia), P. lilacinus BCP2 (NRRL 50756; e. g. PL GOLD from BASF Agricultural Specialities (Pty) Ltd., South Africa), Paenibacillus alvei NAS6G6 (NRRL B-50755), Pantoea vagans (formerly agglomerans) C9-1 (originally isolated in 1994 from apple stem tissue; BlightBan C9-1® from NuFrams America Inc., USA, for control of fire blight in apple; J. Bacteriol. 192(24) 6486-6487, 2010), Pasteuria spp. ATCC PTA-9643 (WO 2010/085795), Pasteuria spp. ATCC SD-5832 (WO 2012/064527), P. nishizawae (WO 2010/80169), P. penetrans (U.S. Pat. No. 5,248,500), P. ramose (WO 2010/80619), P. thornea (WO 2010/80169), P. usgae (WO 2010/80169), Penicillium bilaiae (e. g. Jump Start® from Novozymes Biologicals BioAg Group, Canada, originally isolated from soil in southern Alberta; Fertilizer Res. 39, 97-103, 1994), Phlebiopsis gigantea (e. g. RotStop® from Verdera Oy, Finland), Pichia anomala WRL-076 (NRRL Y-30842; U.S. Pat. No. 8,206,972), potassium bicarbonate (e. g. Amicarb® fromm Stähler SA, Switzerland), potassium silicate (e. g. Sil-MATRIX™ from Certis LLC, USA), Pseudozyma flocculosa PF-A22 UL (e. g. Sporodex® from Plant Products Co. Ltd., Canada), Pseudomonas sp. DSM 13134 (WO 2001/40441, e. g. in PRORADIX from Sourcon Padena GmbH & Co. KG, Hechinger Str. 262, 72072 Tübingen, Germany), P. chloraphis MA 342 (e. g. in CERALL or CEDEMON from BioAgri AB, Uppsala, Sweden), P. fluorescens CL 145A (e. g. in ZEQUANOX from Marrone Biolnnovations, Davis, Calif., USA; J. Invertebr. Pathol. 113(1):104-14, 2013), Pythium oligandrum DV 74 (ATCC 38472; e. g. POLYVERSUM® from Remeslo SSRO, Biopreparaty, Czech Rep. and GOWAN, USA; US 2013/0035230), Reynoutria sachlinensis extract (e. g. REGALIA® SC from Marrone Biolnnovations, Davis, Calif., USA), Rhizobium leguminosarum bv. phaseoli (e. g. RHIZO-STICK from BASF Corp., USA), R. l. trifolii RP113-7 (e. g. DORMAL from BASF Corp., USA; Appl. Environ. Microbiol. 44(5), 1096-1101), R. l. bv. viciae P1NP3Cst (also referred to as 1435; New Phytol 179(1), 224-235, 2008; e. g. in NODULATOR PL Peat Granule from BASF Corp., USA; or in NODULATOR XL PL from BASF Agricultural Specialties Ltd., Canada), R. l. bv. viciae SU303 (e. g. NODULAID Group E from BASF Agricultural Specialties Pty Ltd, Australia), R. l. bv. viciae WSM1455 (e. g. NODULAID Group F BASF Agricultural Specialties Pty Ltd, Australia), R. tropici SEMIA 4080 (identical to PRF 81; Soil Biology & Biochemistry 39, 867-876, 2007), Sinorhizobium meliloti MSDJ0848 (INRA, France) also referred to as strain 2011 or RCR2011 (Mol Gen Genomics (2004) 272: 1-17; e. g. DORMAL ALFALFA from BASF Corp., USA; NITRAGIN® Gold from Novozymes Biologicals BioAg Group, Canada), Sphaerodes mycoparasitica IDAC 301008-01 (WO 2011/022809), Steinernema carpocapsae (e. g. MILLENIUM® from BASF Agricultural Specialities Limited, UK), S. feltiae (NEMASHIELD® from BioWorks, Inc., USA; NEMASYS® from BASF Agricultural Specialities Limited, UK), S. kraussei L137 (NEMASYS® L from BASF Agricultural Specialities Limited, UK), Streptomyces griseoviridis K61 (e. g. MYCOSTOP® from Verdera Oy, Espoo, Finland; Crop Protection 25, 468-475, 2006), S. lydicus WYEC 108 (e. g. Actinovate® from Natural Industries, Inc., USA, U.S. Pat. No. 5,403,584), S. violaceusniger YCED-9 (e. g. DT-9® from Natural Industries, Inc., USA, U.S. Pat. No. 5,968,503), Talaromyces flavus V117b (e. g. PROTUS® from Prophyta, Germany), Trichoderma asperellum SKT-1 (e. g. ECO-HOPE® from Kumiai Chemical Industry Co., Ltd., Japan), T. asperellum ICC 012 (e. g. in TENET WP, REMDIER WP, BIOTEN WP from Isagro NC, USA, BIO-TAM from AgraQuest, USA), T. atroviride LC52 (e. g. SENTINEL® from Agrimm Technologies Ltd, NZ), T. atroviride CNCM I-1237 (e. g. in Esquive WG from Agrauxine S.A., France, e. g. against pruning wound diseases on vine and plant root pathogens), T. fertile JM41R (NRRL 50759; e. g. RICHPLUS™ from BASF Agricultural Specialities (Pty) Ltd., South Africa), T. gamsii ICC 080 (e. g. in TENET WP, REMDIER WP, BIOTEN WP from Isagro NC, USA, BIO-TAM from AgraQuest, USA), T. harzianum T-22 (e. g. PLANTSHIELD® der Firma BioWorks Inc., USA), T. harzianum TH 35 (e. g. ROOT PRO® from Mycontrol Ltd., Israel), T. harzianum T-39 (e. g. TRICHODEX® and TRICHODERMA 2000® from Mycontrol Ltd., Israel and Makhteshim Ltd., Israel), T. harzianum and T. viride (e. g. TRICHOPEL from Agrimm Technologies Ltd, NZ), T. harzianum ICC012 and T. viride ICC080 (e. g. REMEDIER® WP from Isagro Ricerca, Italy), T. polysporum and T. harzianum (e. g. BINAB® from BINAB Bio-Innovation AB, Sweden), T. stromaticum (e. g. TRICOVAB® from C.E.P.L.A.C., Brazil), T. virens GL-21 (also named Gliocladium virens) (e. g. SOILGARD® from Certis LLC, USA), T. viride (e. g. TRIECO® from Ecosense Labs. (India) Pvt. Ltd., Indien, BIO-CURE® F from T. Stanes & Co. Ltd., Indien), T. viride TV1 (e. g. T. viride TV1 from Agribiotec srl, Italy) and Ulocladium oudemansii HRU3 (e. g. in BOTRY-ZEN® from Botry-Zen Ltd, NZ).

Strains can be sourced from genetic resource and deposition centers: American Type Culture Collection, 10801 University Blvd., Manassas, Va. 20110-2209, USA (strains with ATCC prefic); CABI Europe—International Mycological Institute, Bakeham Lane, Egham, Surrey, TW20 9TYNRRL, UK (strains with prefices CABI and IMI); Centraalbureau voor Schimmelcultures, Fungal Biodiversity Centre, Uppsalaan 8, PO Box 85167, 3508 AD Utrecht, Netherlands (strains with prefic CBS); Division of Plant Industry, CSIRO, Canberra, Australia (strains with prefix CC); Collection Nationale de Cultures de Microorganismes, Institut Pasteur, 25 rue du Docteur Roux, F-75724 PARIS Cedex 15 (strains with prefix CNCM); Leibniz-Institut DSMZ-Deutsche Sammlung von Mikroorganismen and Zellkulturen GmbH, Inhoffenstraβe 7 B, 38124 Braunschweig, Germany (strains with prefix DSM); International Depositary Authority of Canada Collection, Canada (strains with prefix IDAC); International Collection of Micro-organisms from Plants, Landcare Research, Private Bag 92170, Auckland Mail Centre, Auckland 1142, New Zealand (strands with prefix ICMP); IITA, PMB 5320, Ibadan, Nigeria (strains with prefix IITA); The National Collections of Industrial and Marine Bacteria Ltd., Torry Research Station, P.O. Box 31, 135 Abbey Road, Aberdeen, AB9 8DG, Scotland (strains with prefix NCIMB); ARS Culture Collection of the National Center for Agricultural Utilization Research, Agricultural Research Service, U.S. Department of Agriculture, 1815 North University Street, Peoria, Ill. 61604, USA (strains with prefix NRRL); Department of Scientific and Industrial Research Culture Collection, Applied Biochemistry Division, Palmerston North, New Zealand (strains with prefix NZP); FEPAGRO-Fundação Estadual de Pesquisa Agropecuária, Rua Gonçalves Dias, 570, Bairro Menino Deus, Porto Alegre/RS, Brazil (strains with prefix SEMIA); SARDI, Adelaide, South Australia (strains with prefix SRDI); U.S. Department of Agriculture, Agricultural Research Service, Soybean and Alfalfa Research Laboratory, BARC-West, 10300 Baltimore Boulevard, Building 011, Room 19-9, Beltsville, Md. 20705, USA (strains with prefix USDA: Beltsville Rhizobium Culture Collection Catalog March 1987 USDA-ARS ARS-30: http://pdf.usaid.gov/pdf_docs/PNAAW891.pdf); and Murdoch University, Perth, Western Australia (strains with prefix WSM). Further strains may be found at the Global catalogue of Microorganisms: http://gcm.wfcc.info/ and http://www.landcareresearch.co.nz/resources/collections/icmp and further references to strain collections and their prefixes at http://refs.wdcm.org/collections.htm.

Bacillus amyloliquefaciens ssp. plantarum MBI600 (NRRL B-50595) is deposited under accession number NRRL B-50595 with the strain designation Bacillus subtilis 1430 (and identical to NCIMB 1237). Recently, MBI 600 has been re-classified as Bacillus amyloliquefaciens ssp. plantarum based on polyphasic testing which combines classical microbiological methods relying on a mixture of traditional tools (such as culture-based methods) and molecular tools (such as genotyping and fatty acids analysis). Thus, Bacillus subtilis MBI600 (or MBI 600 or MBI-600) is identical to Bacillus amyloliquefaciens ssp. plantarum MBI600, formerly Bacillus subtilis MBI600. Bacillus amyloliquefaciens MBI600 is known as plant growth-promoting rice seed treatment from Int. J. Microbiol. Res. 3(2) (2011), 120-130 and further described e. g. in US 2012/0149571 A1. This strain MBI600 is e. g. commercially available as liquid formulation product INTEGRAL® (BASF Corp., USA).

Bacillus subtilis strain FB17 was originally isolated from red beet roots in North America (System Appl. Microbiol 27 (2004) 372-379). This B. subtilis strain promotes plant health (US 2010/0260735 A1; WO 2011/109395 A2). B. subtilis FB17 has also been deposited at ATCC under number PTA-11857 on Apr. 26, 2011. Bacillus subtilis strain FB17 may be referred elsewhere to as UD1022 or UD10-22.

Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. japonicum SEMIA 5079 (e. g. Gelfix 5 or Adhere 60 from BASF Agricultural Specialties Ltd., Brazil), B. japonicum SEMIA 5080 (e. g. GELFIX 5 or ADHERE 60 from BASF Agricultural Specialties Ltd., Brazil), B. mojavensis AP-209 (NRRL B-50616), B. solisalsi AP-217 (NRRL B-50617), B. pumilus strain INR-7 (otherwise referred to as BU-F22 (NRRL B-50153) and BU-F33 (NRRL B-50185)), B. simplex ABU 288 (NRRL B-50340) and B. amyloliquefaciens ssp. plantarum MBI600 (NRRL B-50595) have been mentioned i.a. in US patent appl. 20120149571, U.S. Pat. No. 8,445,255, WO 2012/079073. Bradyrhizobium japonicum USDA 3 is known from U.S. Pat. No. 7,262,151.

The genera Glomus, Acaulospora, Entrophosphora, Gigaspora, Scutellospora and Sclerocytis as well as the Glomus species Glomus fasciculatum, G. caledonium, G. mosseae, G. versiforme, G. intraradices and G. etunicatum are known from U.S. Pat. No. 6,271,175.

According to one embodiment of the inventive mixtures or kits-of-parts, the at least one biopesticide (L) is selected from the groups (L1), (L3), and (L5):
(L1) Microbial pesticides with fungicidal, bactericidal, viricidal and/or plant defense activator activity: Ampelomyces quisqualis M-10, Aspergillus flavus NRRL 21882, Aureobasidium pullulans DSM 14940, A. pullulans DSM 14941, Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens FZB42, B. amyloliquefaciens IN937a, B. amyloliquefaciens IT-45 (CNCM I-3800), B. amyloliquefaciens ssp. plantarum MBI600 (NRRL B-50595), B. mojavensis AP-209 (NRRL B-50616), B. pumilus INR-7 (otherwise referred to as BU-F22 (NRRL B-50153) and BU-F33 (NRRL B-50185)), B. pumilus KFP9F, B. pumilus QST 2808 (NRRL B-30087), B. pumilus GHA 181, B. simplex ABU 288 (NRRL B-50340), B. solisalsi AP-217 (NRRL B-50617), B. subtilis CX-9060, B. subtilis GB03, B. subtilis GB07, B. subtilis QST-713 (NRRL B-21661), B. subtilis var. amyloliquefaciens FZB24, B. subtilis var. amyloliquefaciens D747, Candida oleophila 1-82, C. oleophila O, C. saitoana, Clavibacter michiganensis (bacteriophages), Coniothyrium minitans CON/M/91-08, Cryphonectria parasitica, Cryptococcus albidus, Dilophosphora alopecuri, Fusarium oxysporum, Clonostachys rosea f. catenulata J1446 (also named Gliocladium catenulatum), Gliocladium roseum 321 U, Metschnikowia fructicola NRRL Y-30752, Microdochium dimerum, Microsphaeropsis ochracea P130A, Muscodor albus QST 20799, Paenibacillus polymyxa PKB1 (ATCC 202127), Pantoea vagans C9-1, Phlebiopsis gigantea, Pichia anomala WRL-76, Pseudozyma flocculosa PF-A22 UL, Pythium oligandrum DV 74, Sphaerodes mycoparasitica IDAC 301008-01, Streptomyces griseovirids K61, S. lydicus WYEC 108, S. violaceusniger XL-2, S. violaceusniger YCED-9, Talaromyces flavus V117b, Trichoderma asperellum T34, T. asperellum SKT-1, T. asperellum ICC 012, T. atroviride LC52, T. atroviride CNCM I-1237, T. fertile JM41R, T. gamsii ICC 080, T. harmatum TH 382, T. harzianum TH-35, T. harzianum T-22, T. harzianum T-39, mixture of T. harzianum ICC012 and T. viride ICC080; mixture of T. polysporum and T. harzianum; T. stromaticum, T. virens (also named Gliocladium virens) GL-21, T. virens G41, T. viride TV1, Typhula phacorrhiza 94671, Ulocladium oudemansii HRU3, Verticillium dahlia, zucchini yellow mosaic virus (avirulent strain);
(L3) Microbial pesticides with insecticidal, acaricidal, molluscidal and/or nematicidal activity: Agrobacterium radiobacter K1026, A. radiobacter K84, Bacillus firmus 1-1582, B. thuringiensis ssp. aizawai strains ABTS-1857, SAN 401 I, ABG-6305 and ABG-6346, B. t. ssp. israelensis AM65-52, B. t. ssp. israelensis SUM-6218, B. t. ssp. galleriae SDS-502, B. t. ssp. kurstaki EG 2348, B. t. ssp. kurstaki SB4, B. t. ssp. kurstaki ABTS-351 (HD-1), Beauveria bassiana ATCC 74040, B. bassiana GHA, B. bassiana H123, B. bassiana DSM 12256, B. bassiana PPRI 5339, B. brongniartii, Burkholderia sp. A396, Chromobacterium subtsugae PRAA4-1, Cydia pomonella granulosis virus V22, Cydia pomonella granulosis virus V1, Isaria fumosorosea Apopka-97, Lecanicillium longisporum KV42, L. longisporum KV71, L. muscarium (formerly Verticillium lecanii) KV01, Metarhizium anisopliae FI-985, M. anisopliae FI-1045, M. anisopliae F52, M. anisopliae ICIPE 69, M. anisopliae var. acridum IMI 330189, Nomuraea rileyi strains SA86101, GU87401, SR86151, CG128 and VA9101, Paecilomyces fumosoroseus FE 9901, P. lilacinus 251, P. lilacinus DSM 15169, P. lilacinus BCP2, Paenibacillus popilliae Dutky-1940 (NRRL B-2309=ATCC 14706), P. popilliae KLN 3, P. popilliae Dutky 1, Pasteuria spp. Ph3, Pasteuria spp. ATCC PTA-9643, Pasteuria spp. ATCC SD-5832, P. nishizawae PN-1, P. penetrans, P. ramose, P. reneformis Pr-3, P. thornea, P. usgae, Pseudomonas fluorescens CL 145A, Steinernema carpocapsae, S. feltiae, S. kraussei L137;
(L5) Microbial pesticides with plant stress reducing, plant growth regulator, plant growth promoting and/or yield enhancing activity: Azospirillum amazonense BR 11140 (SpY2T), A. brasilense AZ39, A. brasilense XOH, A. brasilense BR 11005 (Sp245), A. brasilense BR 11002, A. lipoferum BR 11646 (Sp31), A. irakense, A. halopraeferens, Bradyrhizobium sp. PNL01, B. sp. (Arachis) CB1015, B. sp. (Arachis) USDA 3446, B. sp. (Arachis) SEMIA 6144, B. sp. (Arachis) SEMIA 6462, B. sp. (Arachis) SEMIA 6464, B. sp. (Vigna), B. elkanii SEMIA 587, B. elkanii SEMIA 5019, B. elkanii U-1301, B. elkanii U-1302, B. elkanii USDA 74, B. elkanii USDA 76, B. elkanii USDA 94, B. elkanii USDA 3254, B. japonicum 532c, B. japonicum CPAC 15, B. japonicum E-109, B. japonicum G49, B. japonicum TA-11, B. japonicum USDA 3, B. japonicum USDA 31, B. japonicum USDA 76, B. japonicum USDA 110, B. japonicum USDA 121, B. japonicum USDA 123, B. japonicum USDA 136, B. japonicum SEMIA 566, B. japonicum SEMIA 5079, B. japonicum SEMIA 5080, B. japonicum WB74, B. liaoningense, B. lupini LL13, B. lupini WU425, B. lupini WSM471, B. lupini WSM4024, Glomus intraradices RTI-801, Mesorhizobium sp. WSM1271, M. sp. WSM1497, M. ciceri CC1192, M. huakii, M. loti CC829, M. loti SU343, Paenibacillus alvei NAS6G6, Penicillium bilaiae, Rhizobium leguminosarum bv. phaseoli RG-B10, R. l. bv. trifolii RP113-7, R. l. bv. trifolii 095, R. l. bv. trifolii TA1, R. l. bv. trifolii CC283b, R. l. bv. trifolii CC275e, R. l. bv. trifolii CB782, R. l. bv. trifolii CC1099, R. l. bv. trifolii WSM1325, R. l. bv. viciae SU303, R. l. bv. viciae WSM1455, R. l. bv. viciae P1NP3Cst, R. l. bv. viciae RG-P2, R. tropici SEMIA 4080, R. tropici SEMIA 4077, R. tropici CC511, Sinorhizobium meliloti MSDJ0848, S. meliloti NRG185 and S. meliloti RRI128.
   According to one embodiment of the inventive mixtures or kits-of-parts, the at least one biopesticide (L) is preferably
   (L14) Bacillus amyloliquefaciens,
   (L15) Bacillus mojavensis,
   (L16) Bacillus pumilus,
   (L17) Bacillus simplex,
   (L18) Bacillus solisalsi,
   (L19) Bacillus subtilis,
   (L20) Bacillus subtilis var. amyloliquefaciens,
   (L45) Trichoderma asperellum, T. atroviride, T. fertile, T. gamsii, T. harmatum, T. harzianum, T. stromaticum, T. virens (also named Gliocladium virens), T. viride, or mixture of T. harzianum and T. viride, or mixture of T. polysporum and T. harzianum,
   (L51) Agrobacterium radiobacter,
   (L65) Paecilomyces fumosoroseus, or P. lilacinus,
   (L81) Azospirillum amazonense, A. brasilense, A. lipoferum, A. irakense, A. halopraeferens,
   (L82) Bradyrhizobium sp., B. elkanii, B. japonicum, B. liaoningense, or B. lupini,
   (L84) VA mycorrhiza selected from the genera Glomus, Acaulospora, Entrophosphora, Gigaspora, Scutellospora and Sclerocytis,
   (L85) VA mycorrhiza selected from the group consisting of Glomus fasciculatum, G. caledonium, G. mosseae, G. versiforme, G. intraradices and G. etunicatum,
   (L87) Paenibacillus alvei, or
   (L89) Rhizobium leguminosarum bv. phaseoli, R. l. trifolii, R. l. bv. viciae, or R. tropici, or
   (L91) Enterobacter spp., E. ludwigii, E. aerogenes, E. amnigenus, E. agglomerans, E. arachidis, E. asburiae, E. cancerogenous, E. cloacae, E. cowanii, E. dissolvens, E. gergoviae, E. helveticus, E. hormaechei, E. intermedius, E. kobei, E. mori, E. nimipressuralis, E. oryzae, E. pulveris, E. pyrinus, E. radicincitans, E. taylorae, E. turicensis, or E. sakazakii, most preferably E. ludwigii.
      According to another embodiment of the inventive mixtures or kits-of-parts, the at least one biopesticide (L) is most preferably (L16), (L51), (L81), (L82), (L85), (L87), (L89) or (L91) as defined above.
      According to another embodiment of the inventive mixtures or kits-of-parts, the at least one biopesticide (L) is preferably a biopesticide selected from Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens IT-45 (CNCM I-3800), B. mojavensis AP-209 (NRRL B-50616), B. pumilus INR-7 (otherwise referred to as BU-F22 (NRRL B-50153) and BU-F33 (NRRL B-50185)), B. pumilus QST 2808 (NRRL B-30087), B. simplex ABU 288 (NRRL B-50340), B. subtilis QST-713 (NRRL B-21661), B. subtilis MBI600 (NRRL B-50595), Paenibacillus alvei NAS6G6, Sphaerodes mycoparasitica IDAC 301008-01 and Trichoderma fertile JM41R.
      According to another embodiment of the inventive mixtures or kits-of-parts, the at least one biopesticide (L) is preferably a biopesticide selected from Bacillus amyloliquefaciens AP-136, B. amyloliquefaciens AP-188, B. amyloliquefaciens AP-218, B. amyloliquefaciens AP-219, B. amyloliquefaciens AP-295, B. amyloliquefaciens FZB42, B. amyloliquefaciens IN937a, B. amyloliquefaciens IT-45, B. amyloliquefaciens ssp. plantarum MBI600, B. mojavensis AP-209, B. pumilus GB34, B. pumilus INR-7, B. pumilus KFP9F, B. pumilus QST 2808, B. pumilus GHA 181, B. simplex ABU 288, B. solisalsi AP-217, B. subtilis CX-9060, B. subtilis GB03, B. subtilis GB07, B. subtilis QST-713, B. subtilis var. amyloliquefaciens FZB24 and B. subtilis var. amyloliquefaciens D747. These mixtures are particularly suitable in soybean and corn, in particular for seed treatment.
      According to another embodiment of the inventive mixtures or kits-of-parts, the at least one biopesticide (L) is preferably a biopesticide selected from the fungal genus Trichoderma, most preferably from the strains Trichoderma asperellum T34, T. asperellum SKT-1, T. asperellum ICC 012, T. atroviride LC52, T. atroviride CNCM I-1237, T. fertile JM41R, T. gamsii ICC 080, T. harmatum TH 382, T. harzianum TH-35, T. harzianum T-22, T. harzianum T-39, mixture of T. harzianum ICC012 and T. viride ICC080; mixture of T. polysporum and T. harzianum; T. stromaticum, T. virens GL-21, T. virens G41 and T. viride TV1; in particular T. fertile JM41R.
      According to another embodiment of the inventive mixtures or kits-of-parts, the at least one biopesticide (L) is preferably Agrobacterium radiobacter, and is most preferably Agrobacterium radiobacter K1026, or A. radiobacter K84.
      According to another embodiment of the inventive mixtures or kits-of-parts, the at least one biopesticide (L) is preferably Paecilomyces lilacinus, and is most preferably Paecilomyces lilacinus 251, P. lilacinus DSM 15169, or P. lilacinus BCP2.
      According to another embodiment of the inventive mixtures or kits-of-parts, the at least one biopesticide (L) is preferably Azospirillum amazonense, A. brasilense, A. lipoferum, A. irakense, A. halopraeferens, and is most preferably Azospirillum amazonense BR 11140 (SpY2T), A. brasilense AZ39, A. brasilense XOH, A. brasilense BR 11005 (Sp245), A. brasilense BR 11002, A. lipoferum BR 11646 (Sp31), A. irakense, or A. halopraeferens.
      According to another embodiment of the inventive mixtures or kits-of-parts, the at least one biopesticide (L) is preferably Bradyrhizobium sp., B. elkanii, B. japonicum, B. liaoningense, or B. lupini, and is most preferably Bradyrhizobium sp. PNL01, B. sp. (Arachis) CB1015, B. sp. (Arachis) USDA 3446, B. sp. (Arachis) SEMIA 6144, B. sp. (Arachis) SEMIA 6462, B. sp. (Arachis) SEMIA 6464, B. sp. (Vigna), B. elkanii SEMIA 587, B. elkanii SEMIA 5019, B. elkanii U-1301, B. elkanii U-1302, B. elkanii USDA 74, B. elkanii USDA 76, B. elkanii USDA 94, B. elkanii USDA 3254, B. japonicum 532c, B. japonicum CPAC 15, B. japonicum E-109, B. japonicum G49, B. japonicum TA-11, B. japonicum USDA 3, B. japonicum USDA 31, B. japonicum USDA 76, B. japonicum USDA 110, B. japonicum USDA 121, B. japonicum USDA 123, B. japonicum USDA 136, B. japonicum SEMIA 566, B. japonicum SEMIA 5079, B. japonicum SEMIA 5080, B. japonicum WB74, B. liaoningense, B. lupini LL13, B. lupini WU425, B. lupini WSM471, or B. lupini WSM4024.
      According to another embodiment of the inventive mixtures or kits-of-parts, the at least one biopesticide (L) is preferably VA mycorrhiza selected from the group consisting of Glomus fasciculatum, G. caledonium, G. mosseae, G. versiforme, G. intraradices and G. etunicatum, and is most preferably Glomus intraradices, and is particularly Glomus intraradices RTI-801.
      According to another embodiment of the inventive mixtures or kits-of-parts, the at least one biopesticide (L) is preferably Paenibacillus alvei, most preferably Paenibacillus alvei NAS6G6.
      According to another embodiment of the inventive mixtures or kits-of-parts, the at least one biopesticide (L) is preferably Rhizobium leguminosarum bv. phaseoli, R. l. trifolii, R. l. bv. viciae, or R. tropici, and is most preferably Rhizobium leguminosarum bv. phaseoli RG-B10, R. l. bv. trifolii RP113-7, R. l. bv. trifolii 095, R. l. bv. trifolii TA1, R. l. bv. trifolii CC283b, R. l. bv. trifolii CC275e, R. l. bv. trifolii CB782, R. l. bv. trifolii CC1099, R. l. bv. trifolii WSM1325, R. l. bv. viciae SU303, R. l. bv. viciae WSM1455, R. l. bv. viciae P1NP3Cst, R. l. bv. viciae RG-P2, R. tropici SEMIA 4080, R. tropici SEMIA 4077, or R. tropici CC511.
      According to another embodiment of the inventive mixtures or kits-of-parts, the at least one biopesticide (L) is preferably Enterobacter spp., E. ludwigii, E. aerogenes, E. amnigenus, E. agglomerans, E. arachidis, E. asburiae, E. cancerogenous, E. cloacae, E. cowanii, E. dissolvens, E. gergoviae, E. helveticus, E. hormaechei, E. intermedius, E. kobei, E. mori, E. nimipressuralis, E. oryzae, E. pulveris, E. pyrinus, E. radicincitans, E. taylorae, E. turicensis, or E. sakazakii, most preferably E. ludwigii.
      According to another embodiment of the inventive mixtures or kits-of-parts, the at least one biopesticide (L) is preferably
(L7) Metabolites produced by the microbial pesticides selected from:
   (L101) siderophores, bacillibactin
   (L102) antibiotiics such as zwittermicin-A, kanosamine, polyoxine, bacilysin, violacein
   (L103) enzymes such as alpha-amylase, chitinases, pektinases, phosphatase (acid and alkaline) and phytase
   (L104) phytohormones and precursors thereof and volatile compounds, such as auxines, gibberellin-like substances, cytokinin-like compounds, acetoin, 2,3-butanediol, ethylene, indole acetic acid,
   (L105) lipopeptides such as iturins, plipastatins, surfactins, agrastatin, agrastatin A, bacillomycin, bacillomycin D, fengycin,
   (L106) antibacterial polyketides such as difficidin, macrolactin and bacilaene
   (L107) antifungal metabolites such as pyrones, cytosporone, 6-pentyl-2H-pyran-2-one (also termed 6-pentyl-a-pyrone), koninginins (complex pyranes), in particular those metabolites produced by Trichoderma species.
      According to another embodiment of the inventive mixtures or kits-of-parts, the at least one SAP (S) is preferably a SAP (S80), i.e. a polymer selected from the groups (S81), (S82), (S83), (S84), (S85), (S86) and (S87):
   (S81) Polymer produced by the process disclosed in WO2013/060848,
   (S82) polymer produced by the process (S80P1) as defined above,
   (S83) polymer produced by the process (S80P2) as defined above,
   (S84) polymer mixed or grafted with lignocellulose material,
   (S85) polymer mixed or grafted with lignocellulose material selected from list (S80L1) as defined above,
   (S86) polymer containing acrylic acid, or its salts thereof, as monomeric units, mixed or grafted with lignocellulose material selected from list (S80L1) as defined above;
   (S87) polymer selected from the groups (S11), (S12), (S13), (S21), (S22), (S23), (S24), (S25), (S32), (S33), (S34), (S35), (S41), (S42), (S43), (S51), (S52), (S53), (S54), (S55), (S61), (S62), (S63), (S64), (S65), (S71), (S72), (S73), and (S74), mixed or grafted with lignocellulose material selected from list (S80L1) as defined above.
      The processes (S80P1) and (S80P2) and the list (S80L1) are specified above. Furthermore, the processes (S80P1) and (S80P2) are also described in WO 2014/177488 A1 and in the EP application no. 13165864.3.
      According to another embodiment of the inventive mixtures or kits-of-parts, the at least one SAP (S) is most preferably
      (S86) polymer containing acrylic acid, or its salts thereof, as monomeric units, mixed or grafted with lignocellulose material selected from list (S80L1) as defined above.
      According to another embodiment of the inventive mixtures or kits-of-parts, the at least one SAP (S) is most preferably
      (S83) polymer produced by the process (S80P2) as defined above.
      Among the lignocellulose material selected from list (S80L1) as defined above, flax dust is most preferred.
      According to another preferred embodiment of the inventive mixtures or kits-of-parts, the at least one SAP (S) is a SAP (S80), i.e. a polymer selected from the groups (S81), (S82), (S83), (S84), (S85), (S86) and (S87) as defined above—and is most preferably (S86) as defined above—, and the at least one biopesticide (L) is
   (L14) Bacillus amyloliquefaciens,
   (L15) Bacillus mojavensis,
   (L16) Bacillus pumilus,
   (L17) Bacillus simplex,
   (L18) Bacillus solisalsi,
   (L19) Bacillus subtilis,
   (L20) Bacillus subtilis var. amyloliquefaciens,
   (L45) Trichoderma asperellum, T. atroviride, T. fertile, T. gamsii, T. harmatum, T. harzianum, T. stromaticum, T. virens (also named Gliocladium virens), T. viride, or mixture of T. harzianum and T. viride, or mixture of T. polysporum and T. harzianum,
   (L51) Agrobacterium radiobacter,
   (L65) Paecilomyces fumosoroseus, or P. lilacinus,
   (L81) Azospirillum amazonense, A. brasilense, A. lipoferum, A. irakense, A. halopraeferens,
   (L82) Bradyrhizobium sp., B. elkanii, B. japonicum, B. liaoningense, or B. lupini,
   (L84) VA mycorrhiza selected from the genera Glomus, Acaulospora, Entrophosphora, Gigaspora, Scutellospora and Sclerocytis,
   (L85) VA mycorrhiza selected from the group consisting of Glomus fasciculatum, G. caledonium, G. mosseae, G. versiforme, G. intraradices and G. etunicatum,
   (L87) Paenibacillus alvei, or
   (L89) Rhizobium leguminosarum bv. phaseoli, R. l. trifolii, R. l. bv. viciae, or R. tropici, or
   (L91) Enterobacter spp., E. ludwigii, E. aerogenes, E. amnigenus, E. agglomerans, E. arachidis, E. asburiae, E. cancerogenous, E. cloacae, E. cowanii, E. dissolvens, E. gergoviae, E. helveticus, E. hormaechei, E. intermedius, E. kobei, E. mori, E. nimipressuralis, E. oryzae, E. pulveris, E. pyrinus, E. radicincitans, E. taylorae, E. turicensis, or E. sakazakii, most preferably E. ludwigii.
      According to another preferred embodiment of the inventive mixtures or kits-of-parts, the at least one SAP (S) is a
      (S86) polymer containing acrylic acid, or its salts thereof, as monomeric units, mixed or grafted with lignocellulose material selected from list (S80L1) as defined above, and
      the at least one biopesticide (L) is Bacillus pumilus, Bacillus amyloliquefaciens, Bacillus subtilis, Bacillus subtilis var. amyloliquefaciens, Bacillus simplex, Trichoderma fertile, Agrobacterium radiobacter, Paecilomyces lilacinus, Azospirillum amazonense, A. brasilense, A. lipoferum, A. irakense, A. halopraeferens, Glomus intraradices, Bradyrhizobium sp., B. elkanii, B. japonicum, B. liaoningense, B. lupini, Paenibacillus alvei, Rhizobium leguminosarum bv. phaseoli, R. l. trifolii, R. l. bv. viciae, R. tropici, or Enterobacter ludwigii.
      All above embodiments also apply—instead of the mixture of kit-of-parts—in the same way to the method for conducting the combined application of the at least one SAP (S) and the at least one biopesticide (L).

According to another embodiment of the inventive mixtures or kits-of-parts, Bradyrhizobium sp. (meaning any Bradyrhizobium species and/or strain) as biopesticide (L) is Bradyrhizobium japonicum (B. japonicum). These mixtures are particularly suitable in soybean. B. japonicum strains were cultivated using media and fermentation techniques known in the art, e. g. in yeast extract-mannitol broth (YEM) at 27° C. for about 5 days.

The present invention also relates to mixtures or kits-of-parts, wherein the at least one biopesticide (L) is selected from Bradyrhizobium japonicum (B. japonicum) and further comprises a compound IV, wherein compound IV is selected from jasmonic acid or salts or derivatives thereof including cis-jasmone, preferably methyl-jasmonate or cis-jasmone.

References for various B. japonicum strains are given e. g. in U.S. Pat. No. 7,262,151 (B. japonicum strains USDA 110 (=IITA 2121, SEMIA 5032, RCR 3427, ARS 1-110, Nitragin 61A89; isolated from Glycine max in Florida in 1959, Serogroup 110; Appl. Environ. Microbiol. 60, 940-94, 1994), USDA 31 (=Nitragin 61A164; isolated from Glycine max in Wisconsin in 1941, USA, Serogroup 31), USDA 76 (plant passage of strain USDA 74 which has been isolated from Glycine max in California, USA, in 1956, Serogroup 76), USDA 121 (isolated from Glycine max in Ohio, USA, in 1965), USDA 3 (isolated from Glycine max in Virginia, USA, in 1914, Serogroup 6), USDA 121 (Crop Science 26(5), 911-916, 1986) and USDA 136 (=CB 1809, SEMIA 586, Nitragin 61A136, RCR 3407; isolated from Glycine max in Beltsville, Md. in 1961; Appl. Environ. Microbiol. 60, 940-94, 1994). Further suitable B. japonicum strain G49 (INRA, Angers, France) is described in Fernandez-Flouret, D. & Cleyet-Marel, J. C. (1987) C. R. Acad. Agric. Fr. 73, 163-171), especially for soybean grown in Europe, in particular in France. Further suitable B. japonicum strain TA-11 (TA11 NOD⁺) (NRRL B-18466) is i. a. described in U.S. Pat. No. 5,021,076; Appl. Environ. Microbiol. (1990) 56, 2399-2403 and commercially available as liquid inoculant for soybean (VAULT® NP, BASF Corp., USA). Further B. japonicum strains as example for biopesticide (L) are described in US2012/0252672A. Further suitable and especially in Canada commercially available strain 532c (The Nitragin Company, Milwaukee, Wis., USA, field isolate from Wisconsin; Nitragin strain collection No. 61A152; Can J Plant Sci 70 (1990), 661-666) (e. g. in RHIZOFLO, HISTICK, HICOAT Super from BASF Agricultural Specialties Ltd., Canada). Preferably, B. japonicum is selected from strains TA-11 and 532c, more preferably a mixture of B. japonicum strains TA-11 and 532c.

Other suitable and commercially available B. japonicum strains (see e. g. Appl Environ Microbiol 2007, 73(8), 2635) are SEMIA 566 (isolated from North American inoculant in 1966 and used in Brazilian commercial inoculants from 1966 to 1978), SEMIA 586 (=CB 1809; originally isolated in Maryland, USA but received from Australia in 1966 and used in Brazilian inoculants in 1977), CPAC 15 (=SEMIA 5079; a natural variant of SEMIA 566 used in commercial inoculants since 1992) and CPAC 7 (=SEMIA 5080; a natural variant of SEMIA 586 used in commercial inoculants since 1992). These strains are especially suitable for soybean grown in Australia or South America, in particular in Brazil. In particular, mixtures of B. japonicum SEMIA 5079 and SEMIA 5080 are suitable. Some of the abovementioned strains have been re-classified as a novel species Bradyrhizobium elkanii, e. g. strain USDA 76 (Can. J. Microbiol., 1992, 38, 501-505).

Another suitable and commercially available B. japonicum strain is E-109 (variant of strain USDA 138, see e. g. Eur. J. Soil Biol. 45 (2009) 28-35; Biol Fertil Soils (2011) 47:81-89, deposited at Agriculture Collection Laboratory of the Instituto de Microbiologia y Zoologia Agricola (IMYZA), Instituto Nacional de Tecnologra Agropecuaria (INTA), Castelar, Argentina). This strain is especially suitable for soybean grown in South America, in particular in Argentina.

Another suitable and commercially available B. japonicum strain are WB74 or WB74-1 (e. g. from Stimuplant CC, South Africa or from SoyGro Bio-Fertilizer Ltd, South Africa). These strains are especially suitable for soybean grown in South America and Africa, in particular in South Africa.

The present invention also relates to mixtures or kits-of-parts, wherein the at least one biopesticide (L) is selected from Bradyrhizobium elkanii and Bradyrhizobium liaoningense (B. elkanii and B. liaoningense), more preferably from B. elkanii. These mixtures are particularly suitable in soybean. B. elkanii and liaoningense were cultivated using media and fermentation techniques known in the art, e. g. in yeast extract-mannitol broth (YEM) at 27° C. for about 5 days.

The present invention also relates to mixtures or kits-of-parts wherein the at least one biopesticide (L) is selected from selected from B. elkanii and B. liaoningense and further comprises a compound IV, wherein compound IV is selected from jasmonic acid or salts or derivatives thereof including cis-jasmone, preferably methyl-jasmonate or cis-jasmone.

Suitable and commercially available B. elkanii strains are SEMIA 587 and SEMIA 5019 (=29W) (see e. g. Appl Environ Microbiol 2007, 73(8), 2635) and USDA 3254 and USDA 76 and USDA 94. Preferably, mixtures of B. elkanii strains SEMIA 587 and SEMIA 5019 are useful (e. g. in Gelfix 5 from BASF Agricultural Specialties Ltd., Brazil). Further commercially available B. elkanii strains are U-1301 and U-1302 (e. g. product Nitroagin® Optimize from Novozymes Bio As S.A., Brazil or NITRASEC for soybean from LAGE y Cia, Brazil). These strains are especially suitable for soybean grown in Australia or South America, in particular in Brazil.

The present invention also relates to mixtures or kits-of-parts, wherein biopesticide (L) is selected from Bradyrhizobium sp. (Arachis) (B. sp. Arachis) which shall describe the cowpea miscellany cross-inoculation group which includes inter alia indigenous cowpea bradyrhizobia on cowpea (Vigna unguiculata), siratro (Macroptilium atropurpureum), lima bean (Phaseolus lunatus), and peanut (Arachis hypogaea). This mixture comprising as biopesticide (L) B. sp. Arachis is especially suitable for use in peanut, Cowpea, Mung bean, Moth bean, Dune bean, Rice bean, Snake bean and Creeping vigna, in particular peanut.

The present invention also relates to mixtures or kits-of-parts wherein the at least one biopesticide (L) is selected from B. sp. (Arachis) and further comprises a compound IV, wherein compound IV is selected from jasmonic acid or salts or derivatives thereof including cis-jasmone, preferably methyl-jasmonate or cis-jasmone.

Suitable and commercially available B. sp. (Arachis) strain is CB1015 (=IITA 1006, USDA 3446 presumably originally collected in India; from Australian Inoculants Research Group; see e. g. http://www.qaseeds.com.au/inoculant_applic.php). These strains are especially suitable for peanut grown in Australia, North America or South America, in particular in Brazil. Further suitable strain is Bradyrhizobium sp. PNL01 (BASF Corp., USA; Bisson and Mason, Apr. 29, 2010, Project report, Worcester Polytechnic Institute, Worcester, Mass., USA: http://www.wpi.edu/Pubs/E-project/Available/E-project-042810-163614/).

Suitable and commercially available Bradyrhizobium sp. (Arachis) strains especially for cowpea and peanut but also for soybean are Bradyrhizobium SEMIA 6144, SEMIA 6462 (=BR 3267) and SEMIA 6464 (=BR 3262; see e. g. FEMS Microbiology Letters (2010) 303(2), 123-131; Revista Brasileira de Ciencia do Solo (2011) 35(3); 739-742, ISSN 0100-0683).

The present invention also relates to mixtures or kits-of-parts, wherein the at least one biopesticide (L) is selected from Bradyrhizobium sp. (Lupine) (also called B. lupini, B. lupines or Rhizobium lupini). This mixture is especially suitable for use in dry beans and lupins.

The present invention also relates to mixtures or kits-of-parts wherein the at least one biopesticide (L) is selected from Bradyrhizobium sp. (Lupine) (B. lupini) and further comprises a compound IV, wherein compound IV is selected from jasmonic acid or salts or derivatives thereof including cis-jasmone, preferably methyl-jasmonate or cis-jasmone.

Suitable and commercially available B. lupini strain is LL13 (isolated from Lupinus iuteus nodules from French soils; deposited at INRA, Dijon and Angers, France; http://agriculture.gouv.fr/IMG/pdf/ch20060216.pdf). This strain is especially suitable for lupins grown in Australia, North America or Europe, in particular in Europe.

Further suitable and commercially available B. lupini strains WU425 (isolated in Esperance, Western Australia from a non-Australian legume Ornithopus compressus), WSM4024 (isolated from lupins in Australia by CRS during a 2005 survey) and WSM471 (isolated from O. pinnatus in Oyster Harbour, Western Australia) are described e. g. in Palta J. A. and Berger J. B. (eds), 2008, Proceedings 12^{th} International Lupin Conference, 14-18 September 2008, Fremantle, Western Australia. International Lupin Association, Canterbury, NZ, 47-50, ISBN 0-86476-153-8: http://www.lupins.org/pdf/conference/2008/Agronomy %20and%20Production/John %20Howieso n%20and%20G%20OHarapdf; Appl. Environ. Microbiol. 71, 7041-7052, 2005; Australian J. Exp. Agricult. 36(1), 63-70, 1996.

The present invention also relates to mixtures or kits-of-parts, wherein the at least one biopesticide (L) is selected from Mesorhizobium sp. (meaning any Mesorhizobium species and/or strain), more preferably Mesorhizobium ciceri. These mixtures are particularly suitable in cowpea.

The present invention also relates to mixtures or kits-of-parts wherein the at least one biopesticide (L) is selected from Mesorhizobium sp. and further comprises a compound IV, wherein compound IV is selected from jasmonic acid or salts or derivatives thereof including cis-jasmone, preferably methyl-jasmonate or cis-jasmone.

Suitable and commercially available Mesorhizobium sp. strains are e. g. M. ciceri CC1192 (UPM 848, CECT 5549; from Horticultural Research Station, Gosford, Australia; collected in Israel from Cicer arietinum nodules; Can J Microbial (2002) 48, 279-284) and Mesorhizobium sp. strains WSM1271 (collected in Sardinia, Italy, from plant host Biserrula pelecinus), WSM 1497 (collected in Mykonos, Greece, from plant host Biserrula pelecinus), M. loti strains CC829 (commerical inoculant for Lotus pedunculatus and L. ulginosus in Australia, isolated from L. ulginosus nodules in USA; NZP 2012), M. loti SU343 (a commercial inoculant for Lotus corniculatus in Australia; isolated from host nodules in USA). For references see e. g. Soil Biol Biochem (2004) 36(8), 1309-1317; Plant and Soil (2011) 348(1-2), 231-243).

Suitable and commercially available M. loti strains are e. g. M. loti CC829 for Lotus pedunculatus.

The present invention also relates to mixtures or kits-of-parts wherein the at least one biopesticide (L) is selected from Mesorhizobium huakuii, also referred to as Rhizobium huakuii (see e. g. Appl. Environ. Microbiol. 2011, 77(15), 5513-5516). These mixtures are particularly suitable in Astralagus, e. g. Astalagus sinicus (Chinese milkwetch), Thermopsis, e. g. Thermopsis luinoides (Goldenbanner) and alike.

The present invention also relates to mixtures or kits-of-parts wherein the at least one biopesticide (L) is selected from Mesorhizobium huakuii and further comprises a compound IV, wherein compound IV is selected from jasmonic acid or salts or derivatives thereof including cis-jasmone, preferably methyl-jasmonate or cis-jasmone.

Suitable and commercially available M. huakuii strain is HN3015 which was isolated from Astralagus sinicus in a rice-growing field of Southern China (see e. g. World J. Microbiol. Biotechn. (2007) 23(6), 845-851, ISSN 0959-3993).

The present invention also relates to mixtures or kits-of-parts, wherein the at least one biopesticide (L) is selected from Azospirillum amazonense, A. brasilense, A. lipoferum, A. irakense and A. halopraeferens, more preferably from A. brasilense, in particular selected from A. brasilense strains BR 11005 (Sp245) and AZ39 which are both commercially used in Brazil and are obtainable from EMBRAPA-Agribiologia, Brazil. These mixtures are particularly suitable in soybean.

The present invention also relates to a mixture or kit-of-parts wherein the at least one biopesticide (L) is selected from A. amazonense, A. brasilense, A. lipoferum, A. irakense and A. halopraeferens, more preferably A. brasilense, and further comprises a compound IV, wherein compound IV is selected from jasmonic acid or salts or derivatives thereof including cis-jasmone, preferably methyl-jasmonate or cis-jasmone.

The present invention also relates to a mixture or kit-of-parts wherein the at least one biopesticide (L) is selected from Rhizobium leguminosarum bv. phaseoli, especially strain RG-B10 thereof; R. l. trifolii, especially strain RP113-7 thereof, R. l. bv. viciae, in particular strains SU303, WSM1455 and P1NP3Cst thereof; R. tropici, especially strains CC511, SEMIA 4077 and SEMIA 4080 thereof; and Sinorhizobium meliloti, especially strain MSDJ0848 thereof.

According to a further embodiment, in the inventive mixtures or kits-of-parts, biopesticide (L) is selected from Sinorhizobium meliloti MSDJ0848, S. meliloti NRG185, S. meliloti RRI128, S. meliloti SU277, Rhizobium leguminosarum bv. phaseoli RG-B10, R. leguminosarum bv. viciae P1 NP3Cst, R. leguminosarum bv. viciae RG-P2, R. leguminosarum bv. viciae SU303, R. leguminosarum bv. viciae WSM1455, R. leguminosarum bv. trifolii RP113-7, R. leguminosarum bv. trifolii 095, R. leguminosarum bv. trifolii TA1, R. leguminosarum bv. trifolii CC283b, R. leguminosarum bv. trifolii CB782, R. leguminosarum bv. trifolii CC1099, R. leguminosarum bv. trifolii CC275e, R. leguminosarum bv. trifolii WSM 1325, R. tropici CC511, R. tropici SEMIA 4077 and R. tropici SEMIA 4080.

Sinorhizobium meliloti is commercially available from BASF Corp., USA as product Dormal® Alfalfa & Luzerne. Rhizobium leguminosarum bv. phaseoli is commercially available from BASF Corp., USA, as product Rhizo Stick. These strains are particularly suitable as inoculants for various legumes such as alfalfa, clover, peas, beans, lentils, soybeans, peanuts and others.

Rhizobium leguminosarum bv. phaseoli, also called R. phaseoli and recently the type I isolates being re-classified as R. etli, is commercially available from BASF Corp., USA, as product Rhizo-Stick for dry beans. Particularly suitable strains especially for the legume common bean (Phaseolus vulgaris), but also for other crops such as corn and lettuce, are as follows: R. leguminosarum bv. phaseoli RG-B10 (identical to strain USDA 9041) is commercially available as NODULATOR Dry Bean in Africa, HiStick NT Dry bean in US, and NOUDLATOR Dry Bean in Canada from BASF Agricultural Specialties Ltd., Canada, and is known from Int. J. Syst. Bacteriol. 46(1), 240-244, 1996; Int. J. Syst. Evol. Microbiol. 50, 159-170, 2000. Further R. I. bv. phaseoli or R. etli strains are e. g. known from the abovementioned references and Appl. Environ. Microbiol. 45(3), 737-742, 1983; ibida 54(5), 1280-1283, 1988.

R. legominosarum bv. viciae P1NP3Cst (also referred to as 1435) is known from New Phytol. 179(1), 224-235, 2008; and e. g. in NODULATOR PL Peat Granule or in NODULATOR XL PL from BASF Agricultural Specialties Ltd., Canada). R. leguminosarum bv. viciae RG-P2 (also called P2) is commercially available as inoculant for pean and lentils as RhizUP peat in Canada from BASF Agricultural Specialties Ltd., Canada. R. leguminosarum bv. viciae WSM1455 is commercially available NODULAID for faba beans peat from BASF Agricultural Specialties Pty Ltd, Australia. R. leguminosarum bv. viciae SU303 is commercially available as NODULAID Group E, NODULAID NT peat or NODULATOR granules for peas from BASF Agricultural Specialties Pty Ltd, Australia. R. leguminosarum bv. viciae WSM1455 is commercially available as NODULAID Group F peat, NODULAID NT and NODULATOR granules for faba bean from BASF Agricultural Specialties Pty Ltd, Australia, and is also as inoculant for faba beans as NODULATOR SA faba bean in Canada or as Faba Sterile Peat in Europe or as NODULATOR faba bean granules in Canada from BASF Agricultural Specialties Ltd., Canada.

Rhizobium leguminosarum bv. trifolii is commercially available from BASF Corp., USA, as product Nodulator or DORMAL true clover. Suitable strains are especially useful for all kind of clovers, are as follows: R. legominosarum bv. trifolii strains RP113-7 (also called 113-7) and 095 are commercially available from BASF Corp., USA; see also Appl. Environ. Microbiol. 44(5), 1096-1101. Suitable strain R. legominosarum bv. trifolii TA1 obtained from Australia is known from Appl. Environ. Microbiol. 49(1), 127-131, 1985 and commercially available as NODULAID peat for white clover from BASF Agricultural Specialties Pty Ltd, Australia. R. leguminosarum bv. trifolii CC283b is commercially available as NODULAID peat for Caucasian clover from BASF Agricultural Specialties Pty Ltd, Australia. R. leguminosarum bv. trifolli CC1099 is commercially available as NODULAID peat for sainfoin from BASF Agricultural Specialties Pty Ltd, Australia. R. leguminosarum bv. trifolii CC275e is commercially available as NODULAID peat for NZ white clover from BASF Agricultural Specialties Pty Ltd, Australia. R. leguminosarum bv. trifolii CB782 is commercially available as NODULAID peat for Kenya white clover from BASF Agricultural Specialties Pty Ltd, Australia. R. legominosarum bv. trifolii strain WSM 1325 has been collected in 1993 from the Greek Island of Serifos, is commercially available in NODULAID peat for sub clover and NODULATOR granules for sub clover both from BASF Agricultural Specialties Pty Ltd, Australia for a broad range of annual clovers of Mediterranean origin, and is known from Stand. Genomic Sci. 2(3), 347-356, 2010. R. legominosarum bv. trifolii strain WSM2304 has been isolated from Trifolium polymorphum in Uruguay in 1998 and is known from Stand. Genomic Sci. 2(1), 66-76, 2010, and is particularly suitable to nodulate its clover host in Uruguay.

R. tropici is useful for a range of legume crops especially in tropical regions such as Brazil. Suitable strains are especially useful for all kind of clovers, are as follows: R. tropici strain SEMIA 4080 (identical to PRF 81; known from Soil Biology & Biochemistry 39, 867-876, 2007; BMC Microbiol. 12:84, 2012) is commercially available in NITRAFIX FEIJÃO peat for beans from BASF Agricultural Specialties, Brazil and has been used as commercial inoculant for applications to common bean crops in Brazil since 1998, and is deposited with FEPAGRO-Fundação Estadual de Pesquisa Agropecuária, Rua Gonçalves Dias, 570, Bairro Menino Deus, Porto Alegre/RS, Brazil. R. tropici is useful for a range of legume crops especially in tropical regions such as Brazil. Suitable strains are especially useful for all kind of clovers, are as follows: R. tropici strain SEMIA 4077 (identical to CIAT899; Rev. Ciênc. Agron. 44(4) Fortaleza October/December 2013) is commercially available in NITRAFIX FEIJAO peat for beans from BASF Agricultural Specialties, Brazil. R. tropici strain CC511 is commercially available as NODULAID peat for common bean from BASF Agricultural Specialties Pty Ltd, Australia, and is known from Agronomy, N.Z. 36, 4-35, 2006.

The mixtures and kits-of-parts according to the present invention are particularly important for improving the delivery of the biopesticide to various cultivated plants, and/or for improving the plant defense, plant health, or plant growth (e.g. biomass, yield, root branching and length; compact growth in case of ornamental plants) of various cultivated plants, such as cereals, e. g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e. g. conifers; and on the plant propagation material, such as seeds, and the crop material of these plants.

Preferably, the inventive mixtures or kits-of-parts are used for improving the delivery of the biopesticide to or for improving the plant defense, plant health, or plant growth of field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

Preferably, treatment of plant propagation materials with the inventive mixtures or kits-of-parts of SAP (S) and biopesticide (L) thereof, respectively, is used for improving the delivery of the biopesticide to or for improving the plant defense, plant health, or plant growth of cereals, such as wheat, rye, barley and oats; rice, corn, cotton and soybeans.

The term “cultivated plants” is to be understood as including plants which have been modified by breeding, mutagenesis or genetic engineering including but not limiting to agricultural biotech products on the market or in development (cf. http://cera-gmc.org/, see GM crop database therein). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or farnesylated moieties or PEG moieties.

Plants that have been modified by breeding, mutagenesis or genetic engineering, e. g. have been rendered tolerant to applications of specific classes of herbicides, such as hydroxyphenyl-pyruvate dioxygenase (HPPD) inhibitors; acetolactate synthase (ALS) inhibitors, such as sulfo-nyl ureas (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e. g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e. g. WO 92/00377); glutamine synthetase (GS) inhibitors, such as glufosinate (see e. g. EP-A 242 236, EP-A 242 246) or oxynil herbicides (see e. g. U.S. Pat. No. 5,559,024) as a result of conventional methods of breeding or genetic engineering. Several cultivated plants have been rendered tolerant to herbicides by conventional methods of breeding (mutagenesis), e. g. Clearfield® summer rape (Canola, BASF SE, Germany) being tolerant to imidazolinones, e. g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydro-xysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stil-bene synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are disclosed, e. g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of arthropods, especially to beetles (Coeloptera), two-winged insects (Diptera), and moths (Lepidoptera) and to nematodes (Nematoda). Genetically modified plants capable to synthesize one or more insecticidal proteins are, e. g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Cor-poration, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e. g. EP-A 392 225), plant disease resistance genes (e. g. potato cultivars, which express resistance genes acting against Phytophthora infestans derived from the mexican wild potato Solanum bulbocastanum) or T4-lysozym (e. g. potato cultivars capable of synthesizing these proteins with increased resistance against bacteria such as Erwinia amylvora). The methods for producing such genetically modified plants are generally known to the person skilled in the art and are described, e. g. in the publications mentioned above.

Furthermore, plants are also covered that are by the use of recombinant DNA techniques capable to synthesize one or more proteins to increase the productivity (e. g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e. g. oil crops that produce health-promoting long-chain omega-3 fatty acids or unsaturated omega-9 fatty acids (e. g. Nexera® rape, DOW Agro Sciences, Canada).

Furthermore, plants are also covered that contain by the use of recombinant DNA techniques a modified amount of substances of content or new substances of content, specifically to improve raw material production, e. g. potatoes that produce increased amounts of amylopectin (e. g. Amflora® potato, BASF SE, Germany).

The at least one SAP (S) and at least one biopesticide (L), and their salts can be converted into customary types of agrochemical compositions, e. g. solutions, emulsions, suspensions, dusts, powders, pastes, granules, pressings, capsules, and mixtures thereof. Examples for composition types are suspensions (e. g. SC, OD, FS), emulsifiable concentrates (e. g. EC), emulsions (e. g. EW, EO, ES, ME), capsules (e. g. CS, ZC), pastes, pastilles, wettable powders or dusts (e. g. WP, SP, WS, DP, DS), pressings (e. g. BR, TB, DT), granules (e. g. WG, SG, GR, FG, GG, MG), insecticidal articles (e. g. LN), as well as gel formulations for the treatment of plant propagation materials such as seeds (e. g. GF). These and further compositions types are defined in the “Catalogue of pesticide formulation types and international coding system”, Technical Monograph No. 2, 6^{th} Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Regarding the biopesticide (L), the microorganisms as used according to the invention can be cultivated continuously or discontinuously in the batch process or in the fed batch or repeated fed batch process. A review of known methods of cultivation will be found in the textbook by Chmiel (Bioprozesstechnik 1. Einführung in die Bioverfahrenstechnik (Gustav Fischer Verlag, Stuttgart, 1991)) or in the textbook by Storhas (Bioreaktoren and periphere Einrichtungen (Vieweg Verlag, Braunschweig/Wiesbaden, 1994)).

According to one embodiment, individual components of the composition according to the invention such as parts of a kit or parts of a binary or ternary mixture may be mixed by the user himself in a vessel used for applications (e. g. seed treater drums, seed pelleting machinery, knapsack sprayer) and further auxiliaries may be added, if appropriate. When living microorganisms, such as a biopesticide (L), form part of such kit, it must be taken care that choice and amounts of the other parts of the kit and of the further auxiliaries should not influence the viability of the microbial pesticides in the composition mixed by the user. Especially for bactericides and solvents, compatibility with the respective microbial pesticide has to be taken into account.

Consequently, one embodiment of the invention is a kit-of-parts for preparing a ready-to-use composition or a kit-of-parts for a combined application, the kit-of-parts comprising
a) a composition comprising at least SAP (S) as defined above and at least one auxiliary; and
b) a composition comprising at least one biopesticide (L) as defined above and at least one auxiliary; and
optionally c) a composition comprising at least one auxiliary and optionally a further active compound IV as defined above.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e. g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e. g. ethanol, propanol, butanol, benzyl alcohol, cyclohexanol; glycols; DMSO; ketones, e. g. cyclohexanone; esters, e. g. lactates, carbonates, fatty acid esters, gamma-butyrolactone; fatty acids; phosphonates; amines; amides, e. g. N-methylpyrrolidone, fatty acid dimethylamides; and mixtures thereof.

Suitable solid carriers or fillers are mineral earths, e. g. silicates, silica gels, talc, kaolins, limestone, lime, chalk, clays, dolomite, diatomaceous earth, bentonite, calcium sulfate, magnesium sulfate, magnesium oxide; polysaccharides, e. g. cellulose, starch; fertilizers, e. g. ammonium sulfate, ammonium phosphate, ammonium nitrate, ureas; products of vegetable origin, e. g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinyl amines or polyethylene amines.

Suitable adjuvants are compounds, which have a negligible or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e. g. xanthan gum, carboxymethyl cellulose), inorganic clays (organically modified or unmodified), polycarboxylates, and silicates.

Suitable bactericides are bronopol and isothiazolinone derivatives such as alkyliso-thiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e. g. in red, blue, or green) are pigments of low water solubility and water-soluble dyes. Examples are inorganic colorants (e. g. iron oxide, titan oxide, iron hexacyanoferrate) and organic colorants (e. g. alizarin-, azo- and phthalocyanine colorants).

Suitable tackifiers or binders are polyvinyl pyrrolidones, polyvinyl acetates, polyvinyl alcohols, polyacrylates, biological or synthetic waxes, and cellulose ethers.

The agrochemical compositions generally comprise between 0.01 and 95%, preferably between 0.1 and 90%, and in particular between 0.5 and 75%, by weight of active substances. The active substances are employed in a purity of from 90% to 100%, preferably from 95% to 100% (according to NMR spectrum). In case of the present invention, the SAP (S), the biopesticide (L) and the further active compound IV are regarded as active substances.

For the purposes of treatment of plant propagation materials, particularly seeds, solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC), and gels (GF) are usually employed. The compositions in question give, after two-to-tenfold dilution, active substance concentrations of from 0.01 to 60% by weight, preferably from 0.1 to 40%, in the ready-to-use preparations. Application can be carried out before or during sowing. Methods for applying or treating the at least one SAP (S) and the at least one biopesticide (L), and compositions thereof, respectively, onto plant propagation material, especially seeds include dressing, coating, pelleting, dusting, and soaking as well as in-furrow application methods. Preferably, the at least one SAP (S) and the at least one biopesticide (L), the mixtures or kits-of-parts of the present invention or the compositions thereof, respectively, are applied on to the plant propagation material by a method such that germination is not induced, e. g. by seed dressing, pelleting, coating and dusting.

The mixtures or kits-of-parts of the invention can be applied to the soil at planting, and/or in-furrow and/or as side-dress and/or as broadcast. The combined application of the invention as described can occur via application at planting, and/or in-furrow and/or as side-dress and/or as broadcast.

The mixtures or kits-of-parts of the invention comprising cell-free extracts and/or metabolites of biopesticides (L) can be prepared as compositions comprising besides the active ingredients at least one inert ingredient by usual means.

The mixtures or kits-of-parts of the invention comprising at least one SAP (S) and cells, spores and/or whole broth culture of at least one biopesticide (L) can be prepared as compositions comprising besides the active ingredients at least one inert ingredient (auxiliary) by usual means (see e. g. H. D. Burges: Formulation of Microbial Biopesticides, Springer, 1998). Suitable customary types of such compositions are suspensions, dusts, powders, pastes, granules, pressings, capsules, and mixtures thereof. Examples for composition types are suspensions (e. g. SC, OD, FS), capsules (e. g. CS, ZC), pastes, pastilles, wettable powders or dusts (e. g. WP, SP, WS, DP, DS), pressings (e. g. BR, TB, DT), granules (e. g. WG, SG, GR, FG, GG, MG), insecticidal articles (e. g. LN), as well as gel formulations for the treatment of plant propagation materials such as seeds (e. g. GF).

Examples for suitable auxiliaries are those mentioned earlier herein, wherein it must be taken care that choice and amounts of such auxiliaries should not influence the viability of the microbial pesticides in the composition. Especially for bactericides and solvents, compatibility with the respective microbial pesticide has to be taken into account. In addition, compositions with microbial pesticides may further contain stabilizers or nutrients and UV protectants. Suitable stabilizers or nutrients are e. g. alpha-tocopherol, trehalose, glutamate, potassium sorbate, various sugars like glucose, sucrose, lactose and maltodextrin (H. D. Burges: Formulation of Micobial Biopestcides, Springer, 1998). Suitable UV protectants are e. g. inorganic compounds like titan dioxide, zinc oxide and iron oxide pigments or organic compounds like benzophenones, benzotriazoles and phenyltriazines.

When employed in agriculture, the amount of SAP (S) applied is, depending on the kind of effect desired, preferably not more than 100 kg per hectare (ha), more preferably not more than 50 kg per ha, most preferably not more than 20 kg per ha, particularly preferably not more than 8 kg per ha, in particular not more than 2 kg per ha, for example not more than 0.9 kg per ha, and the amount of SAP (S) applied, depending on the kind of effect desired, is preferably at least 0.001 kg per hectare (ha), more preferably at least 0.05 kg per ha, most preferably at least 0.1 kg per ha, particularly preferably at least 0.75 kg per ha, in particular at least 1.5 kg per ha, for example at least 7 kg per ha0.001 to 2 kg per ha, preferably from 0.005 to 2 kg per ha, more preferably from 0.05 to 0.9 kg per ha, in particular from 0.1 to 0.75 kg per ha. In the case of biopesticides (L), the application rates preferably range from about 1×10⁶ to 5×10¹⁵ (or more) CFU/ha. Preferably, the spore concentration is from about 1×10⁷ to about 1×10¹¹ CFU/ha. In the case of (entomopathogenic) nematodes as microbial pesticides (e. g. Steinernema feltiae), the application rates preferably range inform about 1×10⁵ to 1×10¹² (or more), more preferably from 1×10⁸ to 1×10¹¹, even more preferably from 5×10⁸ to 1×10¹⁰ individuals (e. g. in the form of eggs, juvenile or any other live stages, preferably in an infective juvenile stage) per ha.

In treatment of plant propagation materials such as seeds, e. g. by dusting, coating or drenching seed, amounts of SAP (S) range from 0.1 to 1000 g, preferably from 1 to 1000 g, more preferably from 1 to 100 g and most preferably from 5 to 100 g, per 100 kilogram of plant propagation material (preferably seed) are generally required. In the case of biopesticides (L), the application rates with respect to plant propagation material preferably range from about 1×10⁶ to 1×10¹² (or more) CFU/seed. Preferably, the concentration is about 1×10⁶ to about 1×10¹¹ CFU/seed. In the case of microbial pesticides III selected from groups L1), L3) and L5), the application rates with respect to plant propagation material also preferably range from about 1×10⁷ to 1×10¹⁴ (or more) CFU per 100 kg of seed, preferably from 1×10⁹ to about 1×10¹¹ CFU per 100 kg of seed.

Various types of oils, wetters, adjuvants, fertilizer, or micronutrients, and further pesticides (e. g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user can apply the composition according to the invention from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to the invention, the solid material (dry matter) of the biopesticides (L) are considered as active components (e. g. to be obtained after drying or evaporation of the extraction medium or the suspension medium in case of liquid formulations of the microbial pesticides).

The total weight ratios of compositions comprising at least one biopesticide (L) in the form of viable microbial cells including dormant forms, can be determined using the amount of CFU of the respective microorganism to calculate the total weight of the respective active component with the following equation that 1×10⁹ CFU equals one gram of total weight of the respective active component. Colony forming unit is measure of viable microbial cells, in particular fungal and bacterial cells. In addition, here “CFU” may also be understood as the number of (juvenile) individual nematodes in case of (entomopathogenic) nematode biopesticides, such as Steinernema feltiae.

In the binary mixtures and compositions according to the invention, the weight ratio of SAP (S) and biopesticide (L) generally depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1, even more preferably in the range of from 1:4 to 4:1 and in particular in the range of from 1:2 to 2:1.

According to further embodiments of the binary mixtures and compositions according to the invention, the weight ratio of SAP (S) versus biopesticide (L) usually is in the range of from 1000:1 to 1:1, often in the range of from 100:1 to 1:1, regularly in the range of from 50:1 to 1:1, preferably in the range of from 20:1 to 1:1, more preferably in the range of from 10:1 to 1:1, even more preferably in the range of from 4:1 to 1:1 and in particular in the range of from 2:1 to 1:1.

According to further embodiments of the binary mixtures and compositions according to the invention, the weight ratio of SAP (S) versus biopesticide (L) usually is in the range of from 1:1 to 1000, often in the range of from 1:1 to 1:100, regularly in the range of from 1:1 to 1:50, preferably in the range of from 1:1 to 1:20, more preferably in the range of from 1:1 to 1:10, even more preferably in the range of from 1:1 to 1:4 and in particular in the range of from 1:1 to 1:2.

In the ternary mixtures, i.e. compositions according to the invention comprising one SAP (S) (component 1) and a biopesticide (L) (component 2) and a further compound (component 3), the weight ratio of component 1) and component 2) depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1, and the weight ratio of component 1) and component 3) usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1.

Any further active components are, if desired, added in a ratio of from 20:1 to 1:20 to the SAP (S).

Furthermore, the present invention also relates to the inventive mixtures or kits-of-parts “x1” to “x3634” as defined in Table 1, wherein the at least one SAP (S) is specified in the same row next to (and on the right side of) the corresponding x number of Table 1, and the at least one biopesticide (L) is specified in the same row next to (and on the right side of) the corresponding SAP (S).

Furthermore, the present invention also relates to the inventive methods for conducting the combined application of the at least one SAP (S) and at least one biopesticide (L) in agriculture—preferably for improving soil quality, enhancing plant growth, for the control of harmful fungi or insects, soil treatment or seed treatment, most preferably for improving soil quality and enhancing plant growth—according to “x1” to “x3634” as defined in Table 2, wherein the at least one SAP (S) is specified in the same row next to (and on the right side of) the corresponding x number of Table 2, and the at least one biopesticide (L) is specified in the same row next to (and on the right side of) the corresponding SAP (S).

### Description of the Methods

In the following method descriptions,
Luquasorb 1280 provided by BASF SE (a polyacrylic acid, potassium salt) is referred to as “Gen0” or “Gen0 hydrogel” or “HG gen0” or “G0”, and
a polymer containing acrylic acid, or its salts thereof, as monomeric units, mixed or grafted with lignocellulose material and produced by the process (S80P2) as described in WO 2014/177488 A1, and containing potassium counter-ions, wherein the weight ratio of acrylic acid to lignocellulose material is 60:40 and wherein the lignocellulose material is flax dust as described in WO 2014/177488 A1, is referred to as “Gen1” or “Gen1 hydrogel” or “HG gen1” or “G1”,
a polymer containing acrylic acid, or its salts thereof, as monomeric units, mixed or grafted with lignocellulose material and produced by the process (S80P2) as described in WO 2014/177488 A1, and containing potassium counter-ions and urea, wherein the weight ratio of acrylic acid to lignocellulose material is 50:50 and wherein the lignocellulose material is flax dust as described in WO 2014/177488 A1, is referred to as “Gen2” or “Gen2 hydrogel” or “HG gen2” or “G2”,
hydrogel is referred to as “HG”,
arbuscular mycorrhiza is referred to as “AM”,
arbuscular mycorrhiza forming fungi is referred to as “AMF”.
   A) Pot Trial with Wheat (CSIRO)

To test the effect of the bacterium, Bacillus amyloliquefaciens (in sand and when loaded on the hydrogels, Gen0 and Gen1) on early growth of wheat, and to test whether the hydrogels enhance the effect of Bacillus amyloliquefaciens on early growth of wheat. Experiments carried out under sterilised or non-sterilized conditions.

Treatments

1. B. amyloliquefaciens inoculum in sand

2. B. amyloliquefaciens inoculum coated onto wheat seed

3. Gen0 in sand

4. Gen0 (loaded with B. amyloliquefaciens) in sand

5. Gen1 in sand

6. Gen1 (loaded with B. amyloliquefaciens) in sand

7. Control

Mode of Application of Hydrogel and the Bacterial Inoculum

Hydrogels—117 mg, Added Locally Underneath the Plants

B. amyloliquefaciens Inoculum—

Concentration of the spore suspension provided was determined by dilution plating on LB. It was 2.39×10¹⁰ CFU/mL. The number of CFUs contained in 117 mg of coated gels was calculated based on the QC values given for gels. A dilution of the original suspension was prepared and the volume needed to supply an equivalent amount of CFUs was determined and added similarly (locally underneath the plant).

Procedure:

Weigh 4.5 kg of silica sand (adequate for five pots) in a bucket, mix with 75 mL of deionized water and mix by drilling for 30 s. Prepare the pots with the filter paper at the bottom, place on the balance and tare the balance. Fill the space between the cylinder and the pot with 880 g of this wet sand, place two (four day old) seedlings in the middle of the cylinder by holding them with the shoot and fill the cylinder with dry silica sand until full. (Wheat seeds, var. Janz, were in the dry state preselected within the range of ±5 mg of the average weight and germinated in sterile water in Petri dishes at room temperature.) Pull the cylinder gently by rotating vertically, letting the seedlings to stay in the middle of the pot. Fill the pot with dry silica sand to a total weight of 1150 g on the balance, cover the sand surface with plastic bead (˜70 g/pot) and the bottom of the pot with two folds of aluminum foil. Water the inner part of the pot with the wheat seedlings with 50 mL of sterile distilled water.

For the pots with polymer treatment, prepare wet sand similarly and weigh 880 g to a bucket, add 117 mg of hydrogel Gen1 and mix for 30 s by stirring. Use this mixture to fill the space between the cylinder and the pot and set the pot following the above procedure.

Prepare pots for the non-sterile set up similarly as above.

After setting up all the pots, add 100 mL of 1/10 strength stock nutrient solution to each pot (the inner part with the seedlings). Use sterilized fertilizer solution for the pots of sterile set ups.

Arrange the pots in the growth cabinet (temperature −22° C. day and night, 600 μM m⁻² s⁻¹, (≈=40 Klux, 12 hour day) in random order.

Watering and Fertilizer Application

Water the pots with distilled water and fertilize with 1/10 dilution of the stock nutrient solution (stock nutrient solution: 0.5 g of complete mineral salt mixture for plants per L water). Watering and fertilization schedule is as follows:

| Day | Nutrient solution (mL) | Water (mL) |
|---|---|---|
| Trial set up | 100 | 50 |
| 1 | — | — |
| 2 | — | 75 |
| 3 | — | — |
| 4 | — | 75 |
| 5 | — | — |
| 6 | — | 75 |
| 7 | — | — |
| 8 | 50 | — |
| 9 | — | — |
| 10 | — | 75 |
| 11 | — | — |
| 12 | — | 75 |
| 13 | — | — |
| 14 | — | 75 |
| 15 | — | — |
| 16 | 50 | — |
| 17 | — | — |
| 18 | — | 75 |
| 19 | — | — |
| 20 | — | 75 |
| 21 | — | — |
| 22 | — | 75 |
| 23 | — | — |

| | |
|---|---|
| 24 | Harvest |

Harvesting

Harvest the plants on the 24th day after setting up the experiment. Remove plants from each pot carefully by emptying the sand and wash the roots to remove sand. Arrange plants of each treatment on a piece of black cloth with pot labels and take photos. Separate shoots from roots, weigh shoots for fresh weight and place in labeled paper envelopes. Pat dry roots on paper towel and place in pre-weighted labeled 50 mL Falcon tubes and weight for fresh weights. Dry shoots and roots in an oven at 65° C. for 4 days and weigh for dry weights.

B) Pot Trial with Wheat (UWA)

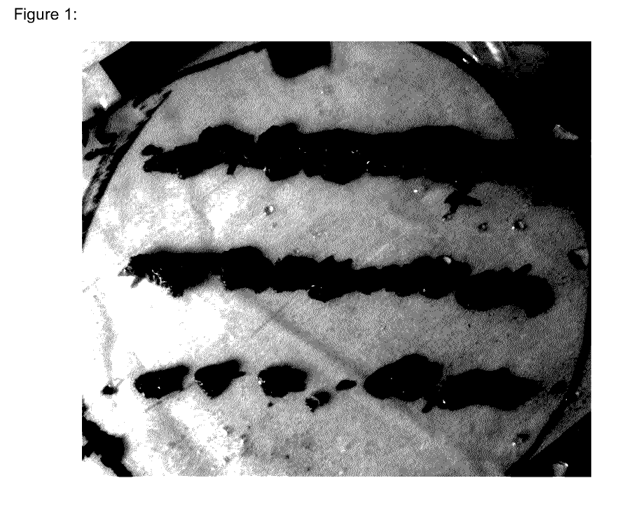

FIG. 1 shows the different application rates of HG gen 2 as per the dimensions of pots used in this trial. Top is 30 kg/ha, middle 20 kg/ha and bottom 10 kg/ha of pre swollen HG. In this trial we opted for 20 kg/ha; double the usual application rate suggested by BASF.

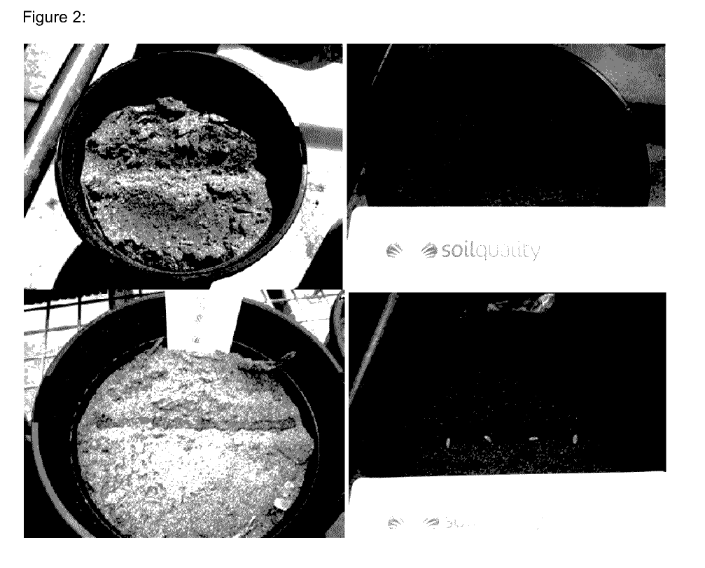

FIG. 2 shows the Setup of microcosm trial. Top left—soil added to pots prior to addition of bacterial inoculum. Top right—pre-swelled HG gen2 coated with B. amyloliquefaciens spores added at rate of 20 kg/ha. Bottom left—addition of liquid culture of B. amyloliquefaciens spores to pots. Bottom right—addition of wheat seeds to pots, 2 cm above microbial addition depth.

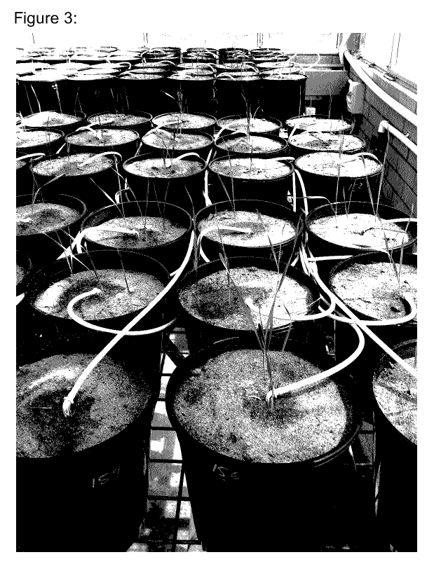

FIG. 3 shows the pot trial setup in glasshouses at University of Western Australia.

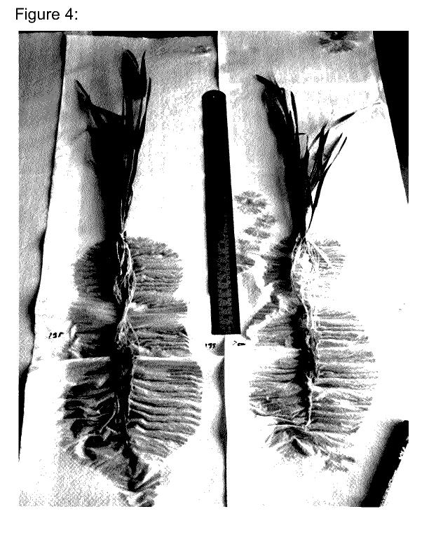

FIG. 4 shows wheat plants freshly harvested.

The following experiments consist of two parts;

B.1) Interaction of Common Bacterial Cultures, Basic Nutrient Additions and Hydrogels for the Benefit of Crop Productivity

Bacillus amyloliquefaciens FZB45 is currently being used as a commercial “microbial fertiliser” (http://www.abitep.de/en/fzb24.html). The plant-growth promoting effect of this strain has been attributed to extracellular phytase activity (Idriss et al., 2002) providing phosphate to plants (maize seedlings in a sterile system) under phosphate limitation in the presence of phytate (myo-inositol hexakisphosphate). The experiment should show that i) there is a positive effect on plant growth when a biopesticide is combined with a hydrogel, and ii) that this positive effect is larger when the two are combined compared to the effects of the individual components (i.e. only biopesticide and only gel). In addition, strain WSIII (a Enterobacter ludwigii strain) is added as a parallel treatment. This strain was isolated from hydrogel Gen 1 and showed the ability to use both organic (phytate) and inorganic phosphate (tri-calcium phosphate).

B.2) Interaction of AM Fungi, Phosphorus and Hydrogels for the Benefit of Crop Productivity

This trial is based on the rationale that much phosphate added to soil quickly becomes recalcitrant. The hypothesis here is that if phosphate can be ‘encapsulated’ in hydrogels, plants may have access to that P source. Similarly, AM fungi may also have increased access to hydrogel encapsulated phosphate. If plants do have improved access to added P, this should be reflected in biomass accumulation of wheat plants.

Experimental Design

4 microbes×6 treatments×10 reps (3 plants in each)=240 pots

Microbes

1) No microbial addition, negative control

2) AM inoculum—Arbuscular mycorrhiza forming fungi was obtained from MAI Australia (Nick@Treetec consulting—nick@maiaustralia.com.au). Inoculum was 1 gram containing ˜55000 propagules of Glomus intradices, G. aggregatum, G. etunicatum and G. mossae divided amongst 60 applications. Briefly, dry propagules suspended in 300 mL di water (+drop of tween) and 5 mL applied to each relevant pot/treatment.

3) Bacillus amyloliquefaciens (liquid)—2.34 mL of spore suspension added; total number of spores added to pot: 1.1×10⁶ spores

Bacillus amyloliquefaciens+Gen 2-75 mg of hydrogel Gen 2 coated with spores was swelled in 2.34 mL water; total number of spores added to pot: 2.56×10⁵ spores

4) Strain WSIII (liquid)—2.34 mL of bacterial suspension added; total number of cells added to pot: 2.89×10⁵ cells

Strain WSIII+Gen 2-75 mg hydrogel Gen 2 was swelled in 2.34 mL bacterial suspension; total number of cells added to pot: 2.89×10⁵ cells

Treatments
1) Nutrient solution only (No P)***
2) Hydrogel Gen 2 only (pre swollen in milliQ water or microbial suspension—Q=˜31)*+nutrient solution (No P)***
3) Nutrient solution***+Phosphorus solution**
4) Hydrogel Gen 2 only (pre swollen in milliQ water or microbial suspension—Q=˜31)*+nutrient solution***+P solution**
5) -ve control**
6) Hydrogel Gen 2 only (pre swollen in milliQ water or microbial suspension—Q=˜31)*

*Hydrogel—BASF hydrogel Gen2 applied at field relevant depth. Suggested application rate is 10 kg/ha (of furrows), however, we doubled this rate to compensate for the low swelling potential of HG gen2 (see FIG. 1). Therefore, add 0.5 g hydrogel per m of furrow—75 mg for 15 cm furrow (one pot). For B. amyloliquefaciens and WSIII microbe replicates, HG containing treatments used HG either spore coated (B. amyloliquefaciens) or swelled with live culture (WSIII). The no microbe added replicates used uninoculated HG gen2 for those treatments (2, 4 and 6)

**P addition to hydrogels. Hydrogels will be swelled in a solution of KH2PO4 with the aim of adding approx. 40 mgP per kg soil. Therefore, need to add 160 mg P to each pot (therefore 704 mg KH2PO4). Swelling potential of hydrogels is 31 (FALKO CALCULATED), therefore swell 75 mg hydrogel in ˜3 mL H₂O containing 704 mg KH2PO4. Hydrogels will be added to pots pre-swelled.

***Nutrient solution was a general basal nutrient solution as described by Yu and Rengal (1999; annals of Botany 83:175). Solution was applied to top of pot at day 2 of experiment.

Microcosm Setup

The experiment (both bacterial and AMF inoculation components) was set-up on the 22st September (SH-spring). Individual pots were 175 mm plastic and held ˜4 kg of soil. Soil used was collected from Dandaragan, 0-10 cm depth from a field being actively cultivated with wheat (bulk density=1.4 g/cm3). Soil was homogenised on site and unsieved (large debris removed during setup of microcosms). Bottom of each pot was lined with paper to prevent loss of soil.

Pots were filled to 6 cm below top with air dried soil. HG or liquid microbial cultures were added to relevant treatment pots in a single line and covered by a further 2 cm of soil (FIG. 2). Four seeds were then placed evenly spaced along the same line and covered with a further 3 cm of soil. Pots were watered manually 5 times over the following 24 hours so as to evenly wet-up soil with no water runoff. From then on, individual pots were watered with a dripper system set to apply ˜20 mL per day. Pots were grown in a glasshouse but subject to ambient light. When extreme conditions occurred (>35 C days), pots were manually watered to avoid plant stress. As plants germinated, only 3 of the 4 plants in each pot were allowed to continue (FIG. 3).

Microcosm Harvest

Individual pots were destructively harvested on 10th November (7 weeks growth). Soil was carefully washed away from plant roots (FIG. 4) and foliage and roots separated. Foliage for individual plants was immediately weighed (fresh weight) and combined roots for each pot were also weighed (fresh weight; roots were ‘tangled’ and separation of individual plant roots was deemed inappropriate). Plant foliage was immediately dried (60 C for 4 days) and weighed again for dry weight. For root samples, 0.5 g subsamples were removed from AMF and no microbe treatments for analysis of mycorrhizal colonisation. Mycorrhizal colonisation of rots was determined using the line intercept method described by Brundrett et al. (1994). Remaining root samples were dried at 60 C for 4 days to determine dry weight (accounting for removal of sub-sample). Dried foliage samples for each pot were combined and analysed by XX (UNE) for nutrient uptake, particularly Phosphorus.

Biomass of both plant foliage and roots (fresh and dry weight) was compared across treatments using one-way analysis of variance and post hoc comparisons with Tukey's honestly significant difference using the multcomp package (Hothorn, Bretz &Westfall 2008). Correlations among biomass of treatments were tested using linear models fitted in R version 3.1.1 (R Core Team (2014). R: A language and environment for statistical computing. R Foundation for Statistical Computing, Vienna, Austria. URL http://www.R-project.org/). In all instances, data were normalised by log transformation.

Results

1) Interaction of Common Bacterial Cultures, Basic Nutrient Additions and Hydrogels for the Benefit of Crop Productivity

For each treatment, a number of relevant comparisons can be made. From this data set, we can compare the effect of addition of microbes as coating on HG verse application of a liquid culture verse application of no microbes. The aforementioned comparisons can then also be assessed in the presence on nutrient solution minus P, nutrient solution +P and/or no nutrient solution. All of these comparisons can be made for the two bacterial cultures used in this study.

### Shoot Biomass (Fresh and Dry Weight) of Wheat

| | mean g shoot | Stan- | mean g shoot | Stan- |
|---|---|---|---|---|
| | fresh | dard | dry | dard |
| | weight/plant | error | weight/plant | error |
| Untreated control: | 0.78 | 0.30 | 0.12 | 0.05 |
| +Enterobacter ludwigii | 0.67 | 0.19 | 0.10 | 0.03 |
| +Gen2 | 0.45 | 0.11 | 0.07 | 0.02 |
| +Gen2 + Enterobacter | 1.43 | 0.25 | 0.25 | 0.04 |
| ludwigii | | | | |

n = 30

Gen2 and Enterobacter ludwigii shows a synergistic growth effect according to the Colby formula.
C) Study on Bacterial Ingress into Hydrogels and Bacterial Attachment to Lignocellulose (SUT)

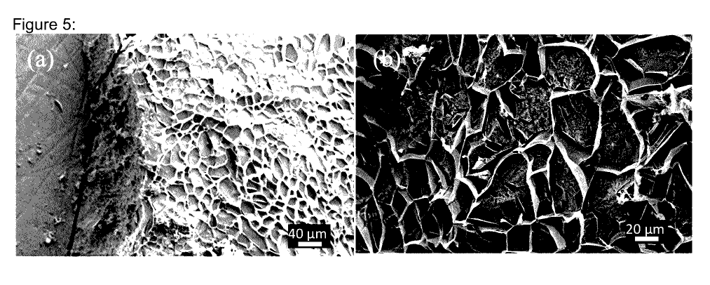

FIG. 5 shows the inner structures of hydrated Gen0 and Gen1 hydrogel visualised by cryo-SEM (UWA).

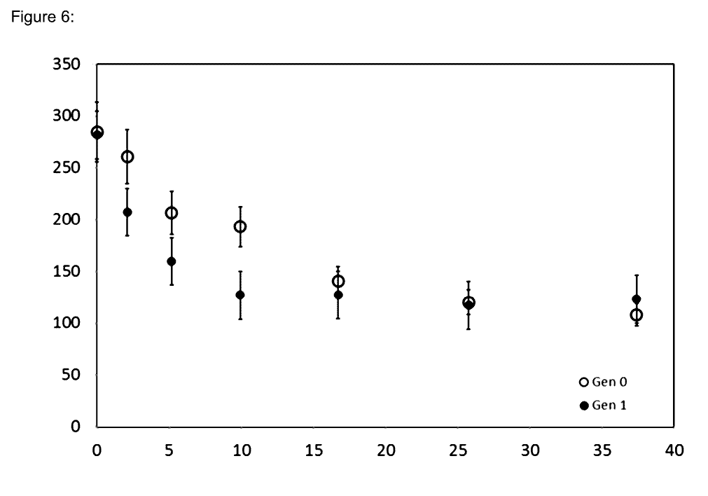

FIG. 6 shows the relative water holding capacities under drying stress conditions.

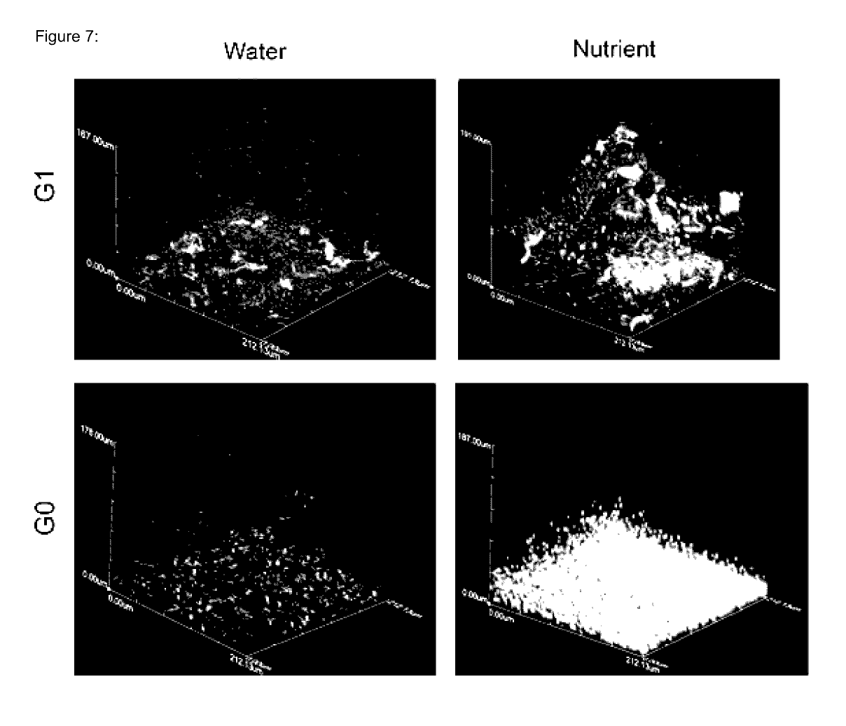

FIG. 7 shows the ingress of B. subtilis into hydrogel Gen1 (G1) and Gen0 (G0) containing water or nutrient after 18 hour incubation (Study 1 and 2).

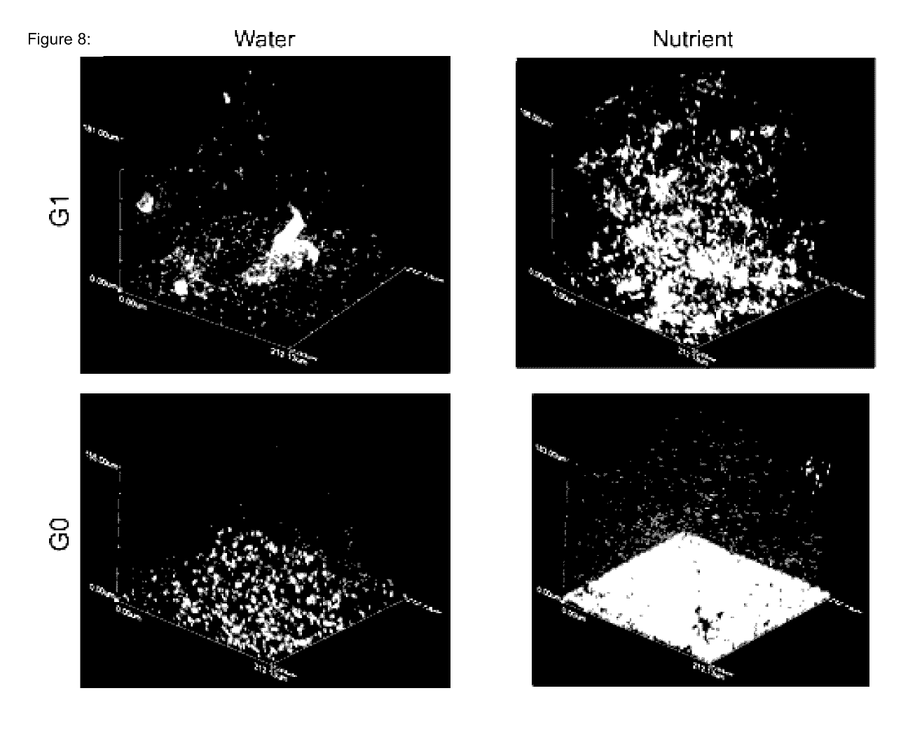

FIG. 8 shows the ingress of P. fluorescens into hydrogel G1 and G0 containing water or nutrient after 18 hour incubation (Study 1 and 2).

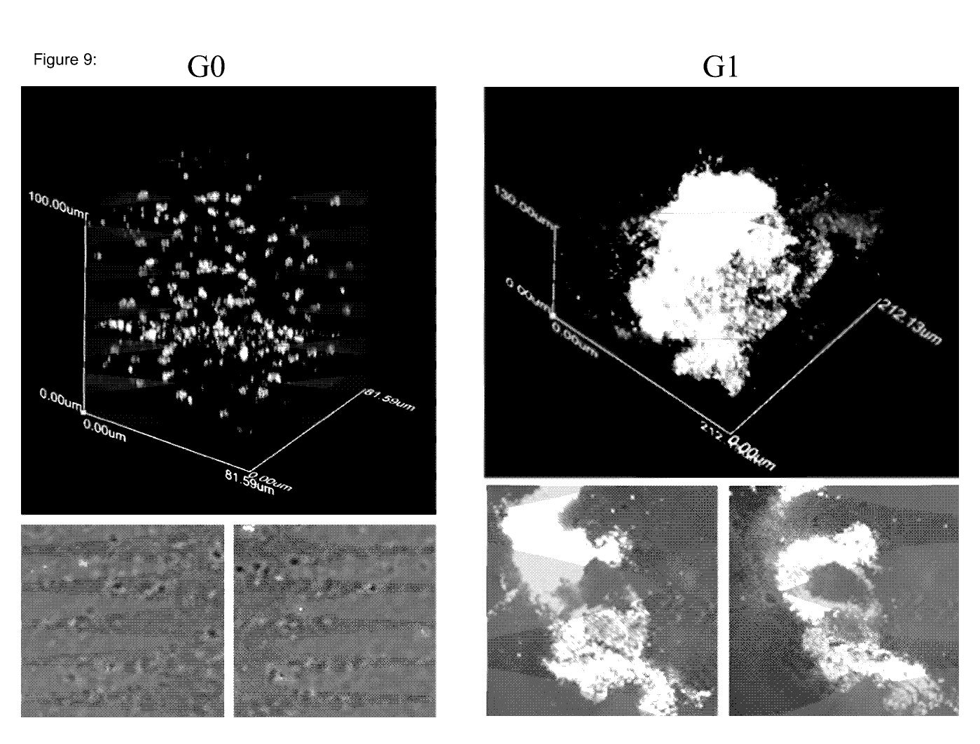

FIG. 9 shows the ingress of B. subtilis into hydrogel G0 and G1 under poor-nutrient environment after five day incubation (study 3).

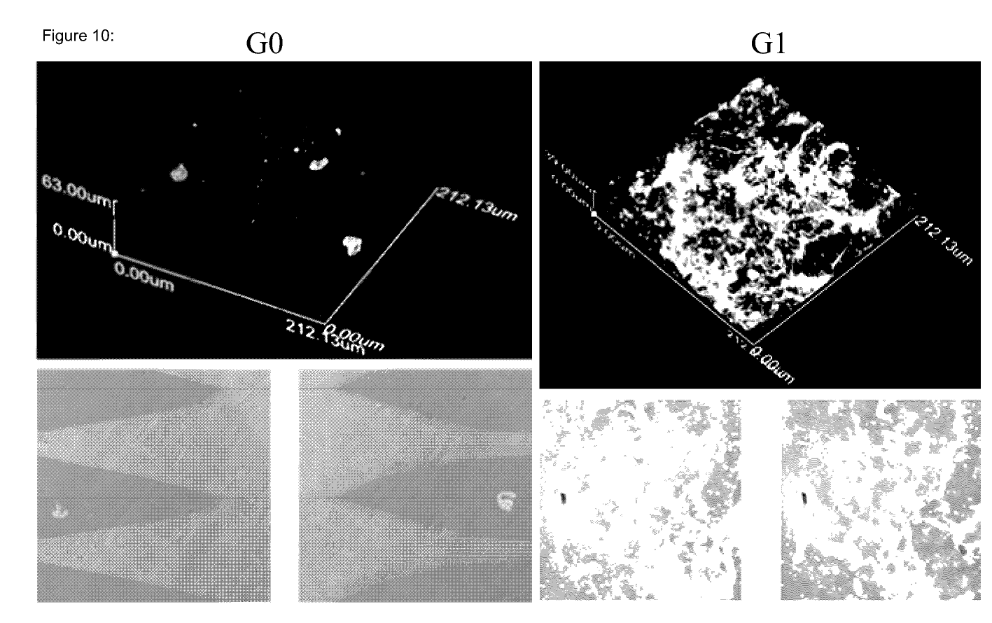

FIG. 10 shows the ingress of P. fluorescens into hydrogel G0 and G1 under poor-nutrient environment after five day incubation (Study 3).

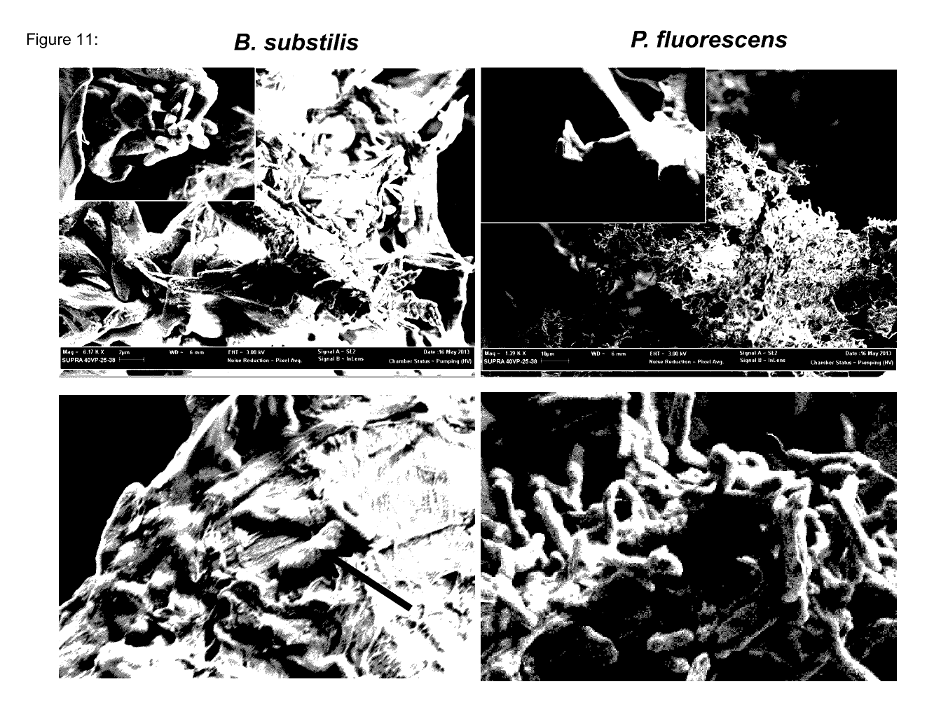

FIG. 11 shows the B. subtilis and P. fluorescens attachment on lignocellulose within Gen1 (arrow indicating bacteria).

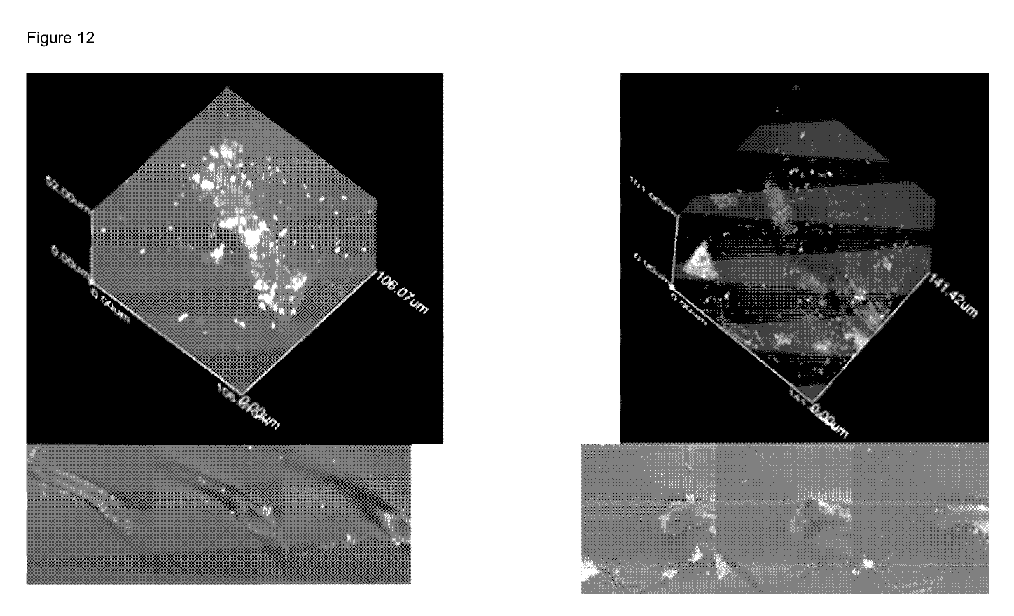

FIG. 12 shows the attachment of B. subtilis on a single lignocellulose fibre.

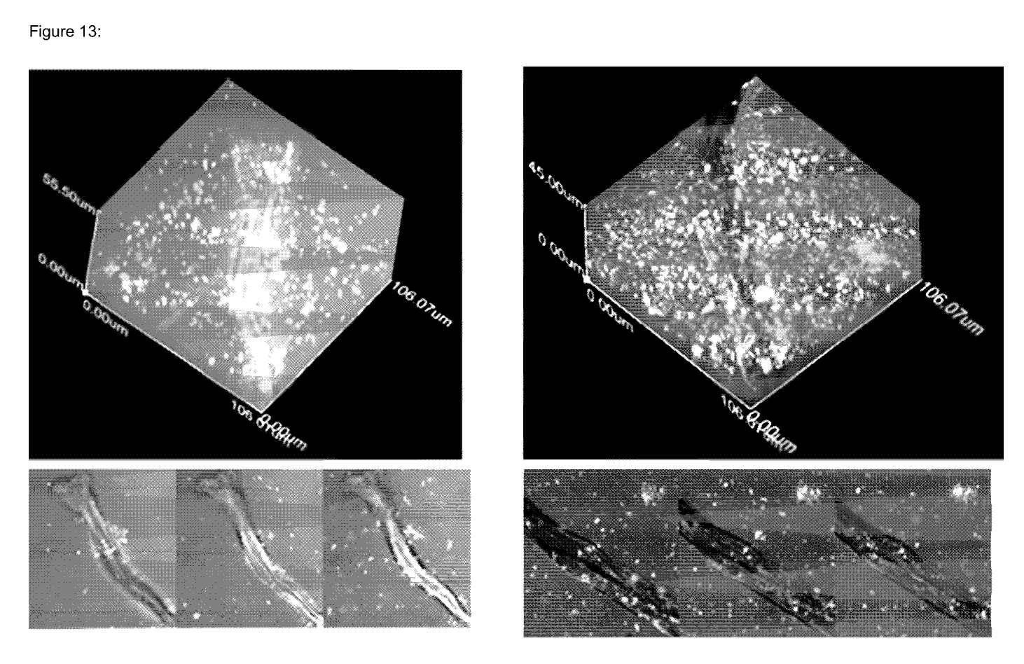

FIG. 13 shows the attachment of P. fluorescens on single lignocellulose fibres.

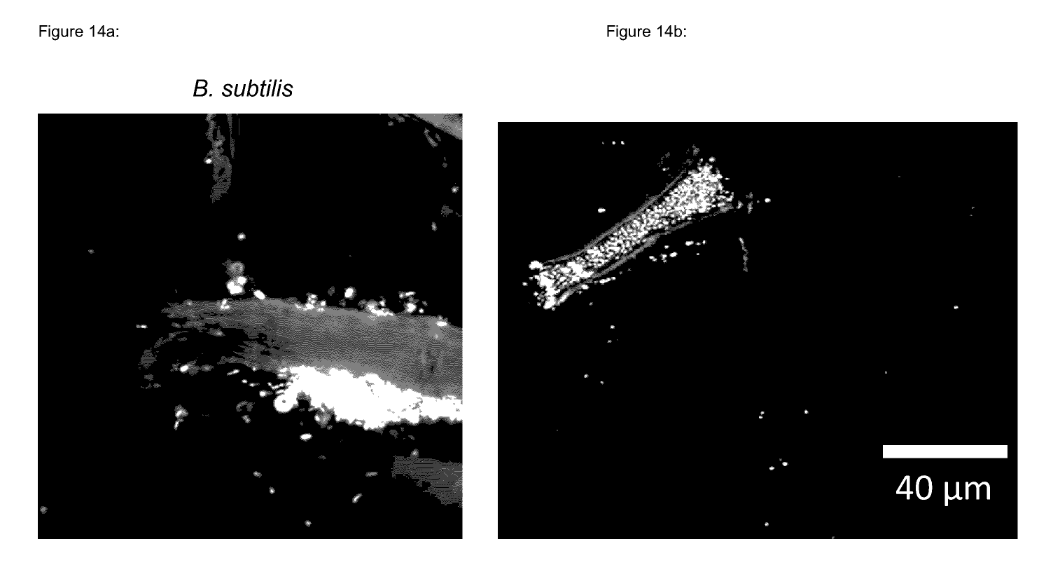

FIG. 14a shows the colonisation of B. subtilis on lignocellulose fibres.

FIG. 14b shows the attachment of B. amyloliquefacien spores on microtube of lignocellulose.

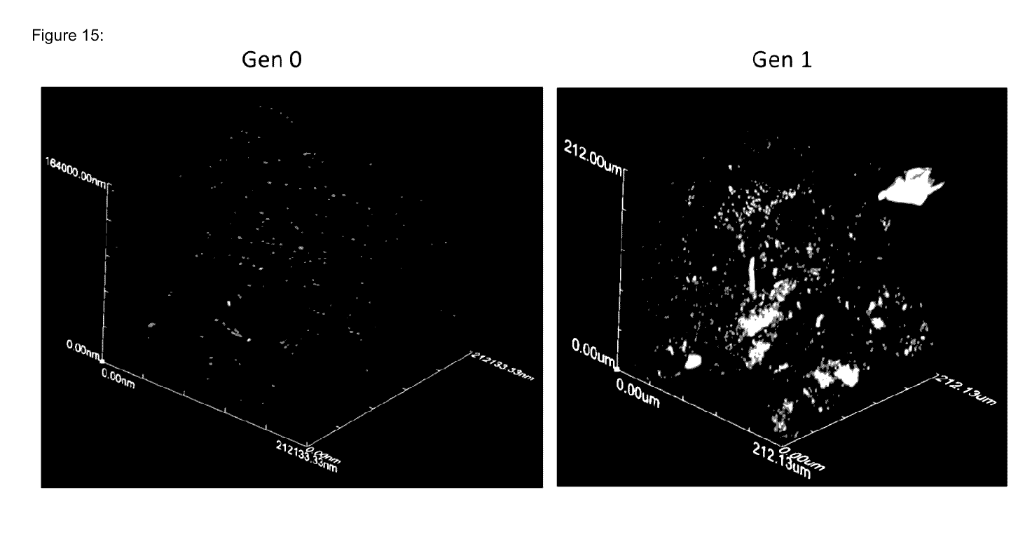

FIG. 15 shows the distribution of B. amyloliquefacien spores in Gen0 and Gen1 (conventional inoculation).

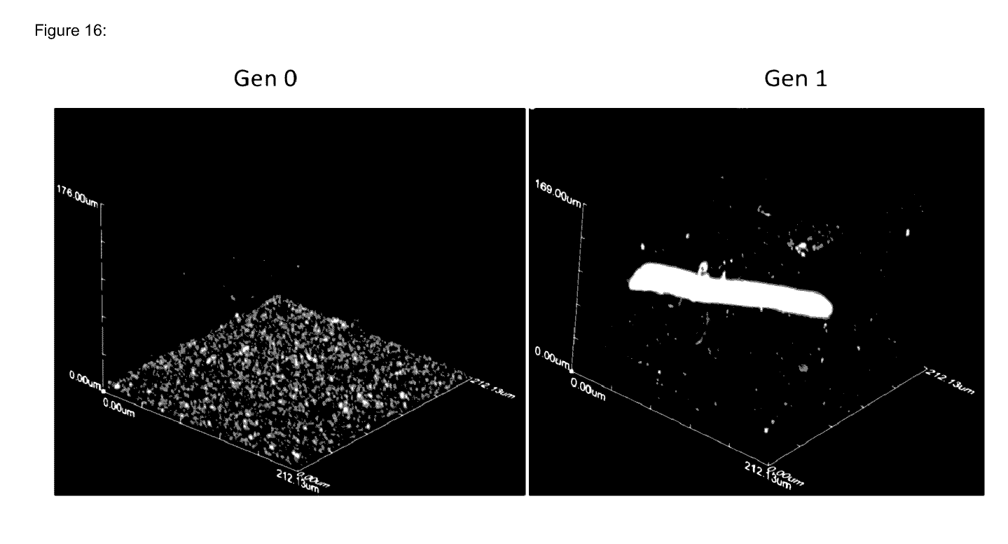

FIG. 16 shows the distribution of B. amyloliquefacien spores in Gen0 and Gen1 (SUT).

Rationale: Superabsorbent polymer (SAP) materials are hydrophilic networks that can absorb and retain a large amount of water or aqueous solutions. The usage of SAP in agriculture has attracted attention in order to manage the moisture content in soils. SAPs have been successfully used as soil amendments in the horticultural industry to improve the physical properties of soil by increasing the water-holding capacity and/or nutrient retention of sandy type soils, making them closer to silt clay or loam. Additionally the influence of SAP hydrogels on soil permeability, density, structure, texture, evaporation, and infiltration rate of water has been demonstrated in published work.

The most widely used and commercially available superabsorbent hydrogel is crosslinked potassium polyacrylate (PAA), which is synthesized by the copolymerization of acrylic acid with various monomers. Non-biodegradability represents a major drawback of PAA. Because many of the applications of PAA fall within the category of disposable goods, widespread use of this polymer may lead to environmental pollution. The development of increased biodegradability of superabsorbent polymers is therefore a necessary practical challenge for agricultural SAP products.

This report exemplifies the performance advantages of a new composition derivative of PAA in the form of a composite lignocellulose—PAA hydrogel Gen1, having the properties as indicated in below Table 3.

TABLE 3
Chemical composition of the hydrogels (HG) used in this research.

| | Luquasorb 1280/Gen0 | Gen1 |
|---|---|---|
| % (w/w) Acrylic acid | 100 | 60 |
| % (w/w) Lignocellulose | 0 | 40 |
| Counter ion | K⁺ | K⁺ |
| % (w/w) Soluble N | 0 | 0 |

Selected background literature and comment: The presence of polyacrylamide (PAM) helps bind soil particles at the soil-water interface minimizing detachment and transport of sediments during runoff, which also minimizes removal of the microorganisms. Also it was shown that PAM interactions were specific to certain types of organisms: (R. E. Sojka et al., Environmental Pollution, 2000, 108, 405-12).

PAM hydrogels can be used as chemically and physically defined substrates for bacterial cell culture where surface colonization occurs: (H. H. Tuson et al., Chemical Communications, 2012, 48, 1595).

The number of surface bridging sites diminishes as divalent cations impregnate into and collapse the gel. Resulting in P. aeruginosa association with the hydrogel surface falling. Low eventual binding of P. aeruginosa to an anionic hydrogel was ascribed to increased surface hydrophilicity compared to a counterpart nonionic p-HEMA hydrogel: (V. B. Tran et al., Journal of Colloid and Interface Science, 2011, 362, 58).

A nitrifying microorganism immobilization method involving preparation and gelation of waterborne polyurethane (WPU) has been suggested: (Y. Dong et al., Advanced Materials Research, 2011, 152-153, 1533).

The addition of polyacrylamide to soil did not appear to affect bacteria movement in the columns, however, it slightly increased the mobility of bacterial phage: (T. P. Wong et al., Environmental and Water Resources 2001 Bridging the Gap, 2001, 1-9).

No measurable difference in the movement of E. coli in either PAM polymer-treated or control soil columns was observed. The impact of polyacrymide on the mobility of E. coli in the chosen structured soil types was not significant: (T. P. Wong et al., Journal of Water and Health, 2008, 6, 131).

A biomedical study demonstrated the adsorption of bacteria and the reduction of bacterial viability on SAP hydrogels consisting of PAA: (C. Wiegand et al., Journal of Materials Science: Materials in Medicine, 2011, 22, 2583).

### Results and Discussion

### C1. Impact of Lignocellulose on: Structure and Water Capacity of the Hydrogels

Inclusion of 40 wt % lignocellulose in PAA composite hydrogel (Gen1) does not change the macroscopic structure when compared to conventional potassium PAA (Gen0) synthetic polymer hydrogels (FIG. 5).

Inclusion of 40 wt % lignocellose in the potassium PAA composite Gen1 only reduces the water holding, and swelling capacity by only about 10% (FIG. 6).

### Methods

Cryo-SEM (UWA):

Hydrogel samples were prepared in-situ on a Cryo-SEM slit sample holder which was frozen with liquid nitrogen and transferred to the Gatan Alto 2500 pre-chamber (cooled to −170° C.). The surface of the sample was then fractured in various locations using a scalpel to produce free-break surfaces before sublimation ˜20 min at −85° C. Pt sputter coating followed for 2 min prior to transfer to the microscope cryo stage (−130° C.) for imaging. Samples were imaged with a FEI NOVA nanoSEM field emission (FEI Company, Hillsboro, Oreg.) using the through-the-lens (TLD) or Everhart-Thornley (ET) detector at 5 kV accelerating voltage and a working distance (WD) of 5 mm at different magnifications.

Water Swelling and Deswelling Properties:

Two BASF hydrogels Gen0 and Gen1 (Table 3) were examined for their water capacities under the influence of imposed osmotic suction pressures which parallels components of soil moisture matric potentials.

The fully swollen gels were subjected to osmotic suction pressures by immersing them in aqueous solutions of polyethylene glycol of MWt 35,000 in contact with a semi-permeable dialysis membrane of cut-off 12,000 MWt. Suction pressures employed ranged from 10 to 40 kPa, such that they lay within the typical range existing in the broad acre soil environment.

C2. Impact of Lignocellulose on: Bacterial Ingress into Hydrogels

Inclusion of 40 wt % lignocellulose in PAA composite hydrogel (Gen1) significantly enhances the ingress, population and viability of microbes in the PAA Gen1 hydrogel under all nutrient conditions but especially under poor nutrient environments compared to conventional PAA (Gen0) (FIGS. 7-10).

These enhancements represent specific advantages and objects of the composite hydrogel invention whether it is in the soil environment (added as a hydrogel and populated by the soil microbial community) or whether it is introduced as a microbe loaded to an inoculant to be added to the soil.

Studies carried out on two bacteria relevant to soil populations (FIGS. 7, 8). When no nutrient inside hydrogels (water case) significantly higher live microbial population (green) within Gen1 hydrogel, showing migration from nutrient solution into the respective hydrogels.

With both water and nutrient conditions within both microbes remain at the hydrogel interface surface with Gen0 PAA whereas with composite hydrogel Gen1 significant population throughout hydrogel material. Microbial populations appear to be associated with Gen1 lignocellulose component, some of which appear as yellow fluorescence due to the wide emission spectrum of lignocellulose (FIGS. 7, 8).

Over five day period (FIGS. 9, 10), bacteria within the hydrogels survive and grow considerable more in Gen1 hydrogel compared to conventional PAA Gen0. Additionally, bacteria form small isolated colonies inside PAA whereas in Gen1 the bacterial population form a continuous biomass.

### Bacterial Attachment on Lignocellulose Fibres

Inclusion of lignocellulose fibres provides a substrate increasing the effectiveness of microbial colonization and in-effect a conduit to more complete population of the hydrogel medium compared to conventional PAA Gen0 (FIGS. 11, 12, 13, 14a).

Scanning microscopy of BASF composite Gen1 hydrogel indicates both B. subtilis and P. fluorescens attachment to lignocellulose fibres (FIG. 11), detailing the microbial association seen in the fluorescence imaging

Bacterial attachment to lignocellulose in the fully hydrated environment is shown by the high resolution confocal scanning microscopy images of FIGS. 12, 13, and 14a. These Figures clearly show that lignocellulose fibres in Gen1 act a highly preferential colonization substrates for the proliferation of microbial species not achieved in conventional PAA.

### Methods

### Preparation of Bacterial Culture

Bacillus subtilis ATCC 6051^{T} and Pseudomonas fluorescens ATCC 49642 as abundant species in the soil environment were obtained from the American Type Culture Collection (ATCC, USA) and shown to be facultative aerobic and strictly aerobic respectively. Bacterial stocks were stored, refreshed and prepared to common cell densities among the different strains used by adjusting them to OD₆₀₀=0.3 prior to each study according to the methods in (V. K. Truong, Biomaterials, 2010, 31, 3674-3683).

TABLE 4
Incubation conditions for bacterial
ingress into hydrogel environments

| | | | | Internal |
|---|---|---|---|---|
| | | Incubation | | environment |
| | Bacterial | time and | External | (inside |
| Hydrogel | strain | temperature | environment | hydrogel) |
| Gen 0 and | B. subtilis | 18 h; | Nutrient | water |
| Gen 1 | P. fluorescens | 25° C. | broth | |
| (Study 1) | | | (NB) * | |
| Gen 0 and | B. subtilis | 18 h; | NB | NB |
| Gen 1 | P. fluorescens | 25° C. | | |
| (Study 2) | | | | |
| Gen 0 and | B. subtilis | 5 days; | Low nutrient | Low nutrient |
| Gen 1 | P. fluorescens | 25 ° C. | solution (1 | solution |
| (Study 3) | | | part of NB | |
| | | | and 9 part of | |
| | | | MilliQ water) | |

* Nutrient broth (Oxoid, Basingstoke, Hampshire, UK)

Incubation of the bacterial cultures was carried out in three types of studies (Table 4). Three independent experiments were carried out in each study to confirm the results. After incubation, the samples were gently removed without any washing step to avoid the disruption on bacterial colonisation in hydrogels.

### Scanning Electron Microscopy

Samples with bacterial ingress was removed from suspension then fixed with glutaraldehyde (2.5% w/v) for an hour. Samples were immersed under liquid nitrogen. Samples were lyophilized under freeze-drying. Dried samples were coated with 20 nm thickness of Au before SEM imaging.

### Confocal Imaging

To identify and quantify the degree of colonised bacteria inside hydrogel at hydrated states, confocal laser scanning microscopy (CLSM) was used to visualise the proportions of live cells and dead cells using LIVE/DEAD BacLight Bacterial Viability Kit, L7012 as previously reported (Ivanova et al., Nature Communication, 2013, 4, 2838). SYTO® 9 permeated both intact and damaged membranes of the cells, binding to nucleic acids and fluorescing green when excited by a 488 nm wavelength laser. On the other hand, propidium iodide alone entered only cells with significant membrane damage, which are considered to be non-viable, and binds with higher affinity to nucleic acids than SYTO® 9. Bacterial suspensions were stained according to the manufacturer's protocol, and imaged using a Fluoview FV10i inverted microscope (Olympus, Tokyo, Japan).

### C3. Hydrogel Used as Carrier of Microbial Inoculants

Inclusion of 40 wt % lignocellulose in PAA composite hydrogel (Gen1) significantly enhances the ingress, population and viability of microbes in the production of microbial inoculants compared to conventional PAA (Gen0). This enhancement is found with both methods of inoculant production: (1) disc/drum coating with spore suspension and drying, and (2) hydrogel swelling by a spore suspension imbibing spores and drying.

Disc/drum coating (method 1 above) indicates Gen1 shows considerably greater spatial loading when lignocellulose is present. Suggesting that during surface wetting and gel swelling, Gen1 lignocellulose fibres provides additional infiltration of spores perhaps by additional suction at the hydrogel—fibre interface (FIG. 15).

Hydrogel Gen0 and Gen1 were also swollen with spore suspensions. FIG. 16 below demonstrated that B. amyloliquefacien spores seems to accumulate at the surface of Gen 0; however, B. amyloliquefacien spores distribute throughout the whole gel of Gen 1.

Hydrogel swelling (method 2) shows that conventional PAA Gen0 largely confines bacterial populations to surface deposition while the composite Gen1 hydrogel contains a significant internal population of bacteria predominately associated with lignocellulose fibres (FIGS. 16, 14b).

### Methods

Hydrogels Gen0 and Gen1 were inoculated with Bacillus amyloliquefaciens spores (BASF) by conventional industrial methods. Each hydrogel was swollen with water to reach the equilibrium swelling ratio. Each hydrogel was evaluated with Live/Dead® Kit (Invitrogen) to stain spore coatings as above and according to (Ivanova et al., Nature Communication, 2013, 4, 2838). Stained spores were then imaged under confocal system Olympus FV10i as above.

Hydrogels Gen0 and Gen1 were swollen according to method 2 above with spore suspensions imbibing spores followed by drying. These were then treated and imaged in the same way as method 1 above.
C4. Future Studies: Influence of Lignocellulose Fibres on Electrostatic Effects with Hydrogel

Electrostatic interactions influence both the extent and longevity of hydrogel water absorbance under soil moisture conditions, as well as its capacity to harbour and promote microbial communities. These effects arise from the overall influence of neutralization and cation exchange on crosslinking density and polymer chain-chain (hydrophobic) association since they modify network mesh sizes and the electrical double layer field through with microbes must travel and colonize. Some of the data obtained to date suggests that the inclusion of lignocellulose mitigates these negative impacts. This will be verified and if the case, exemplified by examining the composite hydrogels Gen1 physical, atability and microbial population characteristics under various: soil water constituents (incl. Al³⁺) nutrient additives (P, N. urea) compared to conventional PAA (Gen0) by the techniques above.

The examples in part C clearly show that the storage or survivability of the biopesticide such as Bacillus subtilis, Bacillus amyloliquefaciens, Pseudomonas fluorescens is improved by providing hydrogels such as Gen1 hydrogel as the corresponding carrier or host matrix.

### D. Soil/Plant Analysis Methods (Including Microscopy Methods) (UWA)

Soil pH was determined in distilled water using the method described by Thomas (1996). Phosphorus analysis was done using methods described by Kuo (1996). Soil organic C was determined using methods described by Nelson and Sommers (1996). Microbial biomass C was measured using fumigation methods described by Vance et al. (1987). Labile N (NO3 and NH4) were measured by methods described by Rayment and Lyons (2010).

Fungal biomass measures used the standard ergosterol analysis method as outlined by Ruzicka et al. 1995. Analysis of mycorrhizal colonisation of plant roots was determined using the line intercept method described in Brundrett et al. (1994).

Isotope ratio mass spectrometry was used to measure total C, total N, C isotope abundances and N isotope abundances using methods outlined at http://www.wabc.uwa.edu.au. Oxygen and hydrogen isotope abundances were also determined using methods described at http://www.wabc.uwa.edu.au.

Imaging of samples was done at the Centre for Microscopy, Characterisation and Analysis at the University of Western Australia. Depending on the sample type and magnification/resolution required, different instrumentation was used. These include; Nikon A1Si confocal microscope, Nikon A1RMP confocal and multiphoton microscope, Zeiss 1555 VP-FESEM (with Leica cryoSEM attachments), JEOL 2100 TEM, Cameca NanoSIMS 50L, Cameca IMS1280. Sample preparation includes the use of chemical or cryo based methods as described at http://www.cmca.uwa.edu.au and http://mcdb.colorado.edu/facilities/ems/. Fluorescence in situ hybridization (FISH) was done using methods described by Watt et al. (2006).

Inductively Coupled Plasma-Optical Emission Spectrometer (ICP-OES) analysis of plant tissue and soil samples was done at University of New England (UNE). Briefly, plant tissue samples were dried at 80 C until stable weight. The plant tops were then ground to a particle size less than 2 mm using a mortar and pestle, homogenized and 0.2 g was subsampled into a Teflon tube and the weight was recorded (to the nearest 0.0001 g). 1.5 ml of 70% nitric acid was added to the tubes and pre-digested for 1 hr in a fume hood. Samples were placed in Milestone UltraWAVE with internal temperature and pressure control in all vessels, 640 terminal with easyCONTROL software. The UltraWAVE was programmed to approach 230 □C in 20 mins, maintain temperature for a further 10 mins and then return the samples to room temperature with a load pressure of 40 bar. Tubes were then diluted to a volume of 22 ml recording weights for calculation of concentration and analysed using Inductively Coupled Plasma—Optical Emission Spectrometer (Agilent Australia Model—725 radial viewed ICPOES with mass flow controller).

### REFERENCES

### For Soil/Plant Analysis Methods

Brundrett M, Bougher N, Dell B, Grave T, Malajczuk N (1996) ‘Working with mycorrhizas in forestry and agriculture’. (ACIAR: Canberra)
Kuo S (1996) Phosphorus. In ‘Soil Analysis, Part 3: Chemical Methods’. (Eds DL Sparks et al.) pp. 869-919. (Soil Science Society of America: Madison)
Nelson D W and Sommers L E (1996) Organic Carbon. In ‘Soil Analysis, Part 3: Chemical Methods’. (Eds DL Sparks et al.) pp. 869-919. (Soil Science Society of America: Madison)
Rayment G E and Lyons D Y (2010) Soil chemical Methods—Australia, CSIRO Publishing, Melbourne.
Ruzicka S, Norman M D P, Harris J A (1995) Rapid ultrasonication method to determine ergosterol concentration in soil. Soil Biology and Biochemistry 27, 1215-1217
Thomas G W (1996) Soil pH and acidity. In ‘Soil Analysis, Part 3: Chemical Methods’. (Eds DL Sparks et al.) pp. 869-919. (Soil Science Society of America: Madison)
Vance E D, Brookes P C, Jenkinson D S (1987) an extraction method for measuring soil microbial biomass C, Soil Biology and Biogeochemistry, 19, 703-707.
Watt M, Hugenholtz P, White R, Vinall K (2006) Numbers and locations of native bacteria on field-grown wheat roots quantified by fluorescence in situ hybridisation (FISH) Environmental Microbiology, 8, 871-884.

### E. Microbiological Methods (UWA)

DNA Extraction and Quantification

DNA was extracted using the MO BIO PowerSoil™ DNA isolation kit (MO BIO Laboratories, Inc., Carlsbad, USA) following the manufacturer's protocol (http://www.mobio.com/images/custom/file/protocol/12888.pdf). Following extraction, DNA concentrations were determined using the Qubit® 2.0 Fluorometer (Life Technologies Australia Pty Ltd., Mulgrave, Australia) using both broad range (https://tools.lifetechnologies.com/content/sfs/manuals/mp32850.pdf) and high sensitivity assays (https://tools.lifetechnologies.com/content/sfs/manuals/mp32851.pdf) following the manufactures instructions.

RNA Extraction and Quantification

RNA was extracted using the MO BIO RNA PowerSoil™ Total RNA Isolation Kit (MO BIO Laboratories, Inc., Carlsbad, USA) following the manufacturer's protocol (http://www.mobio.com/images/custom/file/protocol/12866-25.pdf). After extraction, RNA concentrations were determined using the Qubit® 2.0 Fluorometer (Life Technologies Australia Pty Ltd., Mulgrave, Australia) using the RNA assay kit (https://tools.lifetechnologies.com/content/sfs/manuals/mp32852.pdf). RNA was then transcribed to cDNA according to Lane et al. (1985).

Polymerase Chain Reaction (PCR)

Following DNA extraction and reverse transcription of RNA, PCR (Mullis and Faloona 1987) was used to amplify bacterial and archaeal genes for the 16S ribosomal RNA, and genes of for fungal internal transcribed spacer region (ITS) according to Whiteley et al. (2012). In addition to primers used in their study, we used bacterial primers F515 and 806R (Caporaso et al. 2011) and fungal primers ITS1 (White et al. 1990) and ITS2 (Gardes and Bruns 1993). All primers were synthesized by Geneworks Pty Ltd (Hindmarsh, Australia). Successful amplification was confirmed by quantification with Qbit (see above). Samples were pooled and cleaned using AGENCOURT® AM PURE® XP (Beckman Coulter Australia Pty Ltd, Lane Cove, Australia) prior to sequencing.

Quantitative PCR

Quantitative PCR was conducted using an Applied Biosystems 7500FAST qPCR machine. Primers used for quantifying the bacterial 16S rRNA genes were published by Muyzer et al (1993, 1998) and (Klein et al. 2013). Primers targeting archaea were described by (Biddle et al. 2006). The GoTaq qPCR Master Mix (Promega Australia, Alexandria, Australia) was used for quantification of target genes.

Sequencing

Sequencing was conducted using the Ion Torrent Personal Genome Machine (Life Technologies Australia Pty Ltd., Mulgrave, Australia) as described by Whiteley et al. (2012) using both the 200 base pair chemistry and the recently available 400 base pair chemistry (https://tools.lifetechnologies.com/content/sfs/brochures/Small-Genome-Ecoli-De-Novo-App-Note.pdf). Obtained sequences were analysed using the software QIIME (Quantitative Insights Into Microbial Ecology, Caporaso et al. 2010). Statistical analysis was performed using the software packages R (http://www.r-project.org/) and PRIMER (Clarke 1993).

Metagenomics

After DNA extraction, metagenomic libraries were prepared using the Directional RNA Library Prep Kit (New England Biosciences, Ipswich, Mass.). Template preparation was performed using the Ion PI™ IC 200 Kit and the Ion Chef™ Instrument (Life Technologies Australia Pty Ltd., Mulgrave, Australia). Libraries were then sequenced on an Ion Proton™ (Life Technologies Australia Pty Ltd., Mulgrave, Australia). Sequence analysis was performed using MG-RAST (Glass et al. 2010).

Stable and Radioactive Isotope Probing

Stable and radioactive isotope probing (SIP and RIP) were performed according to Radajewski et al. (2000) and Murrell and Whiteley (2011). For phylogenetic microarray SIP (CHIP-SIP), we followed the protocol by (Mayali et al. 2012).

Cultivation of Bacteria

Bacteria were cultivated using techniques and media suggested by the Leibniz Institute DSMZ—German Collection of Microorganisms and Cell Cultures (http://www.dsmz.de).

Phenotypical Tests of Bacterial Strains

Bacterial strains were tested for a variety of phenotypical traits according to Gerhardt et al. (1994) including but not limited to production of indole acetic acid, phosphatase, and urease.

### REFERENCES

### For Microbiological Methods

Biddle, J. F., J. S. Lipp, M. A. Lever, K. G. Lloyd, K. B. Sorensen, R. Anderson, H. F. Fredricks, M. Elvert, T. J. Kelly, D. P. Schrag, M. L. Sogin, J. E. Brenchley, A. Teske, C. H. House, and K.-U. Hinrichs. 2006. Heterotrophic Archaea dominate sedimentary subsurface ecosystems off Peru. PNAS 103:3846-3851.
Caporaso, J. G., J. Kuczynski, J. Stombaugh, K. Bittinger, F. D. Bushman, E. K. Costello, N. Fierer, A. G. Pena, J. K. Goodrich, J. I. Gordon, G. A. Huttley, S. T. Kelley, D. Knights, J. E. Koenig, R. E. Ley, C. A. Lozupone, D. McDonald, B. D. Muegge, M. Pirrung, J. Reeder, J. R. Sevinsky, P. J. Tumbaugh, W. A. Walters, J. Widmann, T. Yatsunenko, J. Zaneveld, and R. Knight. 2010. QIIME allows analysis of high-throughput community sequencing data. Nature Methods 7:335-336.
Caporaso, J. G., C. L. Lauber, W. A. Walters, D. Berg-Lyons, C. A. Lozupone, P. J. Turnbaugh, N. Fierer, and R. Knight. 2011. Global patterns of 16S rRNA diversity at a depth of millions of sequences per sample. Proceedings of the National Academy of Sciences of the United States of America 108:4516-4522.
Clarke, K. R. 1993. Non Parametric Multivariate Analysis Of Changes in Community Structure. Australian Journal of Ecology 18:117-143.
Gardes, M., and T. D. Bruns. 1993. ITS Primers With Enhanced Specificity For Basidiomycetes—Application To The Identification of Mycorrhizae and Rusts. Molecular Ecology 2:113-118.
Gerhardt, P., R. G. E. Murray, W. A. Wood, and N. R. Krieg. 1994. Methods for General and Molecular Bacteriology. ASM, Washington D.C.
Glass, E. M., J. Wilkening, A. Wilke, D. Antonopoulos, and F. Meyer. 2010. Using the metagenomics RAST server (MG-RAST) for analyzing shotgun metagenomes. Cold Spring Harbor protocols 2010:pdb.prot5368.
Klein, E., M. Ofek, J. Katan, D. Minz, and A. Gamliel. 2013. Soil Suppressiveness to Fusarium Disease: Shifts in Root Microbiome Associated with Reduction of Pathogen Root Colonization. Phytopathology 103:23-33.
Lane, D. J., B. Pace, G. J. Olsen, D. A. Stahl, M. L. Sogin, and N. R. Pace. 1985. Rapid Determination of 16S Ribosomal RNA Sequences for Phylogenetic Analyses. PNAS 82:6955-6959.
Mayali, X., P. K. Weber, E. L. Brodie, S. Mabery, P. D. Hoeprich, and J. Pett-Ridge. 2012. High-throughput isotopic analysis of RNA microarrays to quantify microbial resource use. ISME J 6:1210-1221.
Mullis, K. B., and F. A. Faloona. 1987. Specific synthesis of DNA in vitro via a polymerase-catalyzed chain reaction. Methods in Enzymology 155:335-350.
Murrell, J. C., and A. S. Whiteley. 2011. Stable Isotope Probing and Related Technologies. American Society for Microbiology (ASM).
Muyzer, G., T. Brinkhoff, U. Nübel, C. M. Santegoeds, H. Schafer, and C. Wawer. 1998. Denaturing gradient gel electrophoresis (DGGE) in microbial ecology. Pages 1-27 in A. D. L. Akkermans, J. D. Van Elsas, and F. J. De Bruijn, editors. Molecular Microbial Ecology Manual. Kluwer Academic Publishers, Dodrecht.
Muyzer, G., E. C. de Waal, and A. G. Uitterlinden. 1993. Profiling of complex microbial populations by denaturing gradient gel electrophoresis analysis of polymerase chain reaction-amplified genes coding for 16S rRNA. Appl. Environ. Microbiol. 59:695-700.
Radajewski, S., P. Ineson, N. R. Parekh, and J. C. Murrell. 2000. Stable-isotope probing as a tool in microbial ecology. Nature 403:646-649.
White, T., T. Bruns, S. Lee, and J. Taylor. 1990. Amplification and direct sequencing of fungal ribosomal RNA genes for phylogenetics. Pages 315-322 in M. Innis, D. Gelfand, J. Shinsky, and T. White, editors. PCR Protocols: a Guide to Methods and Applications. Academic Press, San Diego.
Whiteley, A. S., S. Jenkins, I. Waite, N. Kresoje, H. Payne, B. Mullan, R. Allcock, and A. O'Donnell. 2012. Microbial 16S rRNA Ion Tag and community metagenome sequencing using the Ion Torrent (PGM) Platform. Journal of Microbiological Methods 91:80-88.

### F. Assays for Disease Suppressiveness

Pot Trials Using Pathogen Infested Field Soils

Field soils collected from various locations in Western Australia were sent to the South Australian Research and Development Institute (SARDI) and analysed for soilborne pathogens using the Predicta B test (http://www.sardi.sa.gov.au/diagnostic_services/predicta_b). Soils with high-risk ratings for one or more of the pathogens were used for pot trials of wheat.

Soil (4 kg) was placed into pots (175 mm diameter) and packed to bulk density. Treatments were 1) control (no additions), 2) polymers without a biopesticide, 3) polymers with a biopesticide, and 4) liquid solution of the biopesticide with corresponding colony forming unit count as in treatment 3). This layer was covered with a layer of soil on which four wheat seeds were placed and which again covered with soil. Plants were grown and watered daily. After 6 weeks, plants were harvested and the fresh and dry weight of shoot and root biomass was determined.

Antifungal Properties of Novel Bacterial Isolates

Assays determining antibacterial, antifungal, and nematicidal activity were conducted according to Krebs et al. (1998), Ma et al. (2013), and Wang et al. (2013).

### REFERENCES

### For Assays for Disease Suppressiveness

Krebs, B., B. Hoding, S. Kubart, M. A. Workie, H. Junge, G. Schmiede-Knecht, R. Grosch, H. Bochow, and M. Hevesi. 1998. Use of Bacillus subtilis as biocontrol agent. I. Activities and characterization of Bacillus subtilis strains. Zeitschrift Fur Pflanzenkrankheiten Und Pflanzenschutz-Journal of Plant Diseases and Protection 105:181-197.
Ma, L., Y. H. Cao, M. H. Cheng, Y. Huang, M. H. Mo, Y. Wang, J. Z. Yang, and F. X. Yang. 2013. Phylogenetic diversity of bacterial endophytes of Panax notoginseng with antagonistic characteristics towards pathogens of root-rot disease complex. Antonie Van Leeuwenhoek International Journal of General and Molecular Microbiology 103:299-312.
Wang, K., P.-s. Yan, Q.-I. Ding, Q.-x. Wu, Z.-b. Wang, and J. Peng. 2013. Diversity of culturable root-associated/endophytic bacteria and their chitinolytic and aflatoxin inhibition activity of peanut plant in China. World Journal of Microbiology and Biotechnology 29:1-10.

TABLE 1
Mixtures or kits-of-parts “x1” to “x3634”
The following abbreviations are used for Table 1:

“x#” stands for the serial number of the mixture or kit-of-parts.
“S10” stands for SAP (S10) as defined above. “S11” stands for SAP (S11) as defined above.
“S12” stands for SAP (S12) as defined above. “S13” stands for SAP (S13) as defined above.
“S20” stands for SAP (S20) as defined above. “S21” stands for SAP (S21) as defined above.
“S22” stands for SAP (S22) as defined above. “S23” stands for SAP (S23) as defined above.
“S24” stands for SAP (S24) as defined above. “S25” stands for SAP (S25) as defined above.
“S30” stands for SAP (S30) as defined above. “S31” stands for SAP (S31) as defined above.
“S32” stands for SAP (S32) as defined above. “S33” stands for SAP (S33) as defined above.
“S34” stands for SAP (S34) as defined above. “S35” stands for SAP (S35) as defined above.
“S40” stands for SAP (S40) as defined above. “S41” stands for SAP (S41) as defined above.
“S42” stands for SAP (S42) as defined above. “S43” stands for SAP (S43) as defined above.
“S50” stands for SAP (S50) as defined above. “S51” stands for SAP (S51) as defined above.
“S52” stands for SAP (S52) as defined above. “S53” stands for SAP (S53) as defined above.
“S54” stands for SAP (S54) as defined above. “S55” stands for SAP (S55) as defined above.
“S60” stands for SAP (S60) as defined above. “S61” stands for SAP (S61) as defined above.
“S62” stands for SAP (S62) as defined above. “S63” stands for SAP (S63) as defined above.
“S64” stands for SAP (S64) as defined above. “S65” stands for SAP (S65) as defined above.
“S70” stands for SAP (S70) as defined above. “S71” stands for SAP (S71) as defined above.
“S72” stands for SAP (S72) as defined above. “S73” stands for SAP (S73) as defined above.
“S74” stands for SAP (S74) as defined above. “S80” stands for SAP (S80) as defined above.
“S81” stands for SAP (S81) as defined above. “S82” stands for SAP (S82) as defined above.
“S83” stands for SAP (S83) as defined above. “S84” stands for SAP (S84) as defined above.
“S85” stands for SAP (S85) as defined above. “S86” stands for SAP (S86) as defined above.
“S87” stands for SAP (S87) as defined above. “S90” stands for SAP (S90) as defined above.
“L11” stands for biopesticide (L11) as defined above. “L12” stands for biopesticide (L12) as
defined above. “L13” stands for biopesticide (L13) as defined above. “L14” stands for
biopesticide (L14) as defined above. “L15” stands for biopesticide (L15) as defined above. “L16”
stands for biopesticide (L16) as defined above. “L17” stands for biopesticide (L17) as defined
above. “L18” stands for biopesticide (L18) as defined above. “L19” stands for biopesticide (L19)
as defined above. “L20” stands for biopesticide (L20) as defined above. “L21” stands for
biopesticide (L21) as defined above. “L22” stands for biopesticide (L22) as defined above. “L23”
stands for biopesticide (L23) as defined above. “L24” stands for biopesticide (L24) as defined
above. “L25” stands for biopesticide (L25) as defined above. “L26” stands for biopesticide (L26)
as defined above. “L27” stands for biopesticide (L27) as defined above. “L28” stands for
biopesticide (L28) as defined above. “L29” stands for biopesticide (L29) as defined above. “L30”
stands for biopesticide (L30) as defined above. “L31” stands for biopesticide (L31) as defined
above. “L32” stands for biopesticide (L32) as defined above. “L33” stands for biopesticide (L33)
as defined above. “L34” stands for biopesticide (L34) as defined above. “L35” stands for
biopesticide (L35) as defined above. “L36” stands for biopesticide (L36) as defined above. “L37”
stands for biopesticide (L37) as defined above. “L38” stands for biopesticide (L38) as defined
above. “L39” stands for biopesticide (L39) as defined above. “L40” stands for biopesticide (L40)
as defined above. “L41” stands for biopesticide (L41) as defined above. “L42” stands for
biopesticide (L42) as defined above. “L43” stands for biopesticide (L43) as defined above. “L44”
stands for biopesticide (L44) as defined above. “L45” stands for biopesticide (L45) as defined
above. “L46” stands for biopesticide (L46) as defined above. “L47” stands for biopesticide (L47)
as defined above. “L48” stands for biopesticide (L48) as defined above. “L49” stands for
biopesticide (L49) as defined above. “L51” stands for biopesticide (L51) as defined above. “L52”
stands for biopesticide (L52) as defined above. “L53” stands for biopesticide (L53) as defined
above. “L54” stands for biopesticide (L54) as defined above. “L55” stands for biopesticide (L55)
as defined above. “L56” stands for biopesticide (L56) as defined above. “L57” stands for
biopesticide (L57) as defined above. “L58” stands for biopesticide (L58) as defined above. “L59”
stands for biopesticide (L59) as defined above. “L60” stands for biopesticide (L60) as defined
above. “L61” stands for biopesticide (L61) as defined above. “L62” stands for biopesticide (L62)
as defined above. “L63” stands for biopesticide (L63) as defined above. “L64” stands for
biopesticide (L64) as defined above. “L65” stands for biopesticide (L65) as defined above. “L66”
stands for biopesticide (L66) as defined above. “L67” stands for biopesticide (L67) as defined
above. “L68” stands for biopesticide (L68) as defined above. “L69” stands for biopesticide (L69)
as defined above. “L81” stands for biopesticide (L81) as defined above. “L82” stands for
biopesticide (L82) as defined above. “L83” stands for biopesticide (L83) as defined above. “L84”
stands for biopesticide (L84) as defined above. “L85” stands for biopesticide (L85) as defined
above. “L86” stands for biopesticide (L86) as defined above. “L87” stands for biopesticide (L87)
as defined above. “L88” stands for biopesticide (L88) as defined above. “L89” stands for
biopesticide (L89) as defined above. “L90” stands for biopesticide (L90) as defined above. “L91”
stands for biopesticide (L91) as defined above. “L92” stands for biopesticide (L92) as defined
above. “L93” stands for biopesticide (L93) as defined above. “L94” stands for biopesticide (L94)
as defined above. “L95” stands for biopesticide (L95) as defined above. “L96” stands for
biopesticide (L96) as defined above. “L97” stands for biopesticide (L97) as defined above. “L98”
stands for biopesticide (L98) as defined above. “L99” stands for biopesticide (L99) as defined
above. “L71” stands for Enterobacter ludwigii.

TABLE 2
Method for conducting the combined application “x1” to “x3634”

| x# | (S) | (L) | x# | (S) | (L) | x# | (S) | (L) | x# | (S) | (L) |
|---|---|---|---|---|---|---|---|---|---|---|---|
| x1 | S10 | L11 | x35 | S10 | L45 | x69 | S11 | L11 | x103 | S11 | L45 |
| x2 | S10 | L12 | x36 | S10 | L46 | x70 | S11 | L12 | x104 | S11 | L46 |
| x3 | S10 | L13 | x37 | S10 | L47 | x71 | S11 | L13 | x105 | S11 | L47 |
| x4 | S10 | L14 | x38 | S10 | L48 | x72 | S11 | L14 | x106 | S11 | L48 |
| x5 | S10 | L15 | x39 | S10 | L49 | x73 | S11 | L15 | x107 | S11 | L49 |
| x6 | S10 | L16 | x40 | S10 | L51 | x74 | S11 | L16 | x108 | S11 | L51 |
| x7 | S10 | L17 | x41 | S10 | L52 | x75 | S11 | L17 | x109 | S11 | L52 |
| x8 | S10 | L18 | x42 | S10 | L53 | x76 | S11 | L18 | x110 | S11 | L53 |
| x9 | S10 | L19 | x43 | S10 | L54 | x77 | S11 | L19 | x111 | S11 | L54 |
| x10 | S10 | L20 | x44 | S10 | L55 | x78 | S11 | L20 | x112 | S11 | L55 |
| x11 | S10 | L21 | x45 | S10 | L56 | x79 | S11 | L21 | x113 | S11 | L56 |
| x12 | S10 | L22 | x46 | S10 | L57 | x80 | S11 | L22 | x114 | S11 | L57 |
| x13 | S10 | L23 | x47 | S10 | L58 | x81 | S11 | L23 | x115 | S11 | L58 |
| x14 | S10 | L24 | x48 | S10 | L59 | x82 | S11 | L24 | x116 | S11 | L59 |
| x15 | S10 | L25 | x49 | S10 | L60 | x83 | S11 | L25 | x117 | S11 | L60 |
| x16 | S10 | L26 | x50 | S10 | L61 | x84 | S11 | L26 | x118 | S11 | L61 |
| x17 | S10 | L27 | x51 | S10 | L62 | x85 | S11 | L27 | x119 | S11 | L62 |
| x18 | S10 | L28 | x52 | S10 | L63 | x86 | S11 | L28 | x120 | S11 | L63 |
| x19 | S10 | L29 | x53 | S10 | L64 | x87 | S11 | L29 | x121 | S11 | L64 |
| x20 | S10 | L30 | x54 | S10 | L65 | x88 | S11 | L30 | x122 | S11 | L65 |
| x21 | S10 | L31 | x55 | S10 | L66 | x89 | S11 | L31 | x123 | S11 | L66 |
| x22 | S10 | L32 | x56 | S10 | L67 | x90 | S11 | L32 | x124 | S11 | L67 |
| x23 | S10 | L33 | x57 | S10 | L68 | x91 | S11 | L33 | x125 | S11 | L68 |
| x24 | S10 | L34 | x58 | S10 | L69 | x92 | S11 | L34 | x126 | S11 | L69 |
| x25 | S10 | L35 | x59 | S10 | L81 | x93 | S11 | L35 | x127 | S11 | L81 |
| x26 | S10 | L36 | x60 | S10 | L82 | x94 | S11 | L36 | x128 | S11 | L82 |
| x27 | S10 | L37 | x61 | S10 | L83 | x95 | S11 | L37 | x129 | S11 | L83 |
| x28 | S10 | L38 | x62 | S10 | L84 | x96 | S11 | L38 | x130 | S11 | L84 |
| x29 | S10 | L39 | x63 | S10 | L85 | x97 | S11 | L39 | x131 | S11 | L85 |
| x30 | S10 | L40 | x64 | S10 | L86 | x98 | S11 | L40 | x132 | S11 | L86 |
| x31 | S10 | L41 | x65 | S10 | L87 | x99 | S11 | L41 | x133 | S11 | L87 |
| x32 | S10 | L42 | x66 | S10 | L88 | x100 | S11 | L42 | x134 | S11 | L88 |
| x33 | S10 | L43 | x67 | S10 | L89 | x101 | S11 | L43 | x135 | S11 | L89 |
| x34 | S10 | L44 | x68 | S10 | L90 | x102 | S11 | L44 | x136 | S11 | L90 |
| x137 | S12 | L11 | x171 | S12 | L45 | x205 | S13 | L11 | x239 | S13 | L45 |
| x138 | S12 | L12 | x172 | S12 | L46 | x206 | S13 | L12 | x240 | S13 | L46 |
| x139 | S12 | L13 | x173 | S12 | L47 | x207 | S13 | L13 | x241 | S13 | L47 |
| x140 | S12 | L14 | x174 | S12 | L48 | x208 | S13 | L14 | x242 | S13 | L48 |
| x141 | S12 | L15 | x175 | S12 | L49 | x209 | S13 | L15 | x243 | S13 | L49 |
| x142 | S12 | L16 | x176 | S12 | L51 | x210 | S13 | L16 | x244 | S13 | L51 |
| x143 | S12 | L17 | x177 | S12 | L52 | x211 | S13 | L17 | x245 | S13 | L52 |
| x144 | S12 | L18 | x178 | S12 | L53 | x212 | S13 | L18 | x246 | S13 | L53 |
| x145 | S12 | L19 | x179 | S12 | L54 | x213 | S13 | L19 | x247 | S13 | L54 |
| x146 | S12 | L20 | x180 | S12 | L55 | x214 | S13 | L20 | x248 | S13 | L55 |
| x147 | S12 | L21 | x181 | S12 | L56 | x215 | S13 | L21 | x249 | S13 | L56 |
| x148 | S12 | L22 | x182 | S12 | L57 | x216 | S13 | L22 | x250 | S13 | L57 |
| x149 | S12 | L23 | x183 | S12 | L58 | x217 | S13 | L23 | x251 | S13 | L58 |
| x150 | S12 | L24 | x184 | S12 | L59 | x218 | S13 | L24 | x252 | S13 | L59 |
| x151 | S12 | L25 | x185 | S12 | L60 | x219 | S13 | L25 | x253 | S13 | L60 |
| x152 | S12 | L26 | x186 | S12 | L61 | x220 | S13 | L26 | x254 | S13 | L61 |
| x153 | S12 | L27 | x187 | S12 | L62 | x221 | S13 | L27 | x255 | S13 | L62 |
| x154 | S12 | L28 | x188 | S12 | L63 | x222 | S13 | L28 | x256 | S13 | L63 |
| x155 | S12 | L29 | x189 | S12 | L64 | x223 | S13 | L29 | x257 | S13 | L64 |
| x156 | S12 | L30 | x190 | S12 | L65 | x224 | S13 | L30 | x258 | S13 | L65 |
| x157 | S12 | L31 | x191 | S12 | L66 | x225 | S13 | L31 | x259 | S13 | L66 |
| x158 | S12 | L32 | x192 | S12 | L67 | x226 | S13 | L32 | x260 | S13 | L67 |
| x159 | S12 | L33 | x193 | S12 | L68 | x227 | S13 | L33 | x261 | S13 | L68 |
| x160 | S12 | L34 | x194 | S12 | L69 | x228 | S13 | L34 | x262 | S13 | L69 |
| x161 | S12 | L35 | x195 | S12 | L81 | x229 | S13 | L35 | x263 | S13 | L81 |
| x162 | S12 | L36 | x196 | S12 | L82 | x230 | S13 | L36 | x264 | S13 | L82 |
| x163 | S12 | L37 | x197 | S12 | L83 | x231 | S13 | L37 | x265 | S13 | L83 |
| x164 | S12 | L38 | x198 | S12 | L84 | x232 | S13 | L38 | x266 | S13 | L84 |
| x165 | S12 | L39 | x199 | S12 | L85 | x233 | S13 | L39 | x267 | S13 | L85 |
| x166 | S12 | L40 | x200 | S12 | L86 | x234 | S13 | L40 | x268 | S13 | L86 |
| x167 | S12 | L41 | x201 | S12 | L87 | x235 | S13 | L41 | x269 | S13 | L87 |
| x168 | S12 | L42 | x202 | S12 | L88 | x236 | S13 | L42 | x270 | S13 | L88 |
| x169 | S12 | L43 | x203 | S12 | L89 | x237 | S13 | L43 | x271 | S13 | L89 |
| x170 | S12 | L44 | x204 | S12 | L90 | x238 | S13 | L44 | x272 | S13 | L90 |
| x273 | S20 | L11 | x307 | S20 | L45 | x341 | S21 | L11 | x375 | S21 | L45 |
| x274 | S20 | L12 | x308 | S20 | L46 | x342 | S21 | L12 | x376 | S21 | L46 |
| x275 | S20 | L13 | x309 | S20 | L47 | x343 | S21 | L13 | x377 | S21 | L47 |
| x276 | S20 | L14 | x310 | S20 | L48 | x344 | S21 | L14 | x378 | S21 | L48 |
| x277 | S20 | L15 | x311 | S20 | L49 | x345 | S21 | L15 | x379 | S21 | L49 |
| x278 | S20 | L16 | x312 | S20 | L51 | x346 | S21 | L16 | x380 | S21 | L51 |
| x279 | S20 | L17 | x313 | S20 | L52 | x347 | S21 | L17 | x381 | S21 | L52 |
| x280 | S20 | L18 | x314 | S20 | L53 | x348 | S21 | L18 | x382 | S21 | L53 |
| x281 | S20 | L19 | x315 | S20 | L54 | x349 | S21 | L19 | x383 | S21 | L54 |
| x282 | S20 | L20 | x316 | S20 | L55 | x350 | S21 | L20 | x384 | S21 | L55 |
| x283 | S20 | L21 | x317 | S20 | L56 | x351 | S21 | L21 | x385 | S21 | L56 |
| x284 | S20 | L22 | x318 | S20 | L57 | x352 | S21 | L22 | x386 | S21 | L57 |
| x285 | S20 | L23 | x319 | S20 | L58 | x353 | S21 | L23 | x387 | S21 | L58 |
| x286 | S20 | L24 | x320 | S20 | L59 | x354 | S21 | L24 | x388 | S21 | L59 |
| x287 | S20 | L25 | x321 | S20 | L60 | x355 | S21 | L25 | x389 | S21 | L60 |
| x288 | S20 | L26 | x322 | S20 | L61 | x356 | S21 | L26 | x390 | S21 | L61 |
| x289 | S20 | L27 | x323 | S20 | L62 | x357 | S21 | L27 | x391 | S21 | L62 |
| x290 | S20 | L28 | x324 | S20 | L63 | x358 | S21 | L28 | x392 | S21 | L63 |
| x291 | S20 | L29 | x325 | S20 | L64 | x359 | S21 | L29 | x393 | S21 | L64 |
| x292 | S20 | L30 | x326 | S20 | L65 | x360 | S21 | L30 | x394 | S21 | L65 |
| x293 | S20 | L31 | x327 | S20 | L66 | x361 | S21 | L31 | x395 | S21 | L66 |
| x294 | S20 | L32 | x328 | S20 | L67 | x362 | S21 | L32 | x396 | S21 | L67 |
| x295 | S20 | L33 | x329 | S20 | L68 | x363 | S21 | L33 | x397 | S21 | L68 |
| x296 | S20 | L34 | x330 | S20 | L69 | x364 | S21 | L34 | x398 | S21 | L69 |
| x297 | S20 | L35 | x331 | S20 | L81 | x365 | S21 | L35 | x399 | S21 | L81 |
| x298 | S20 | L36 | x332 | S20 | L82 | x366 | S21 | L36 | x400 | S21 | L82 |
| x299 | S20 | L37 | x333 | S20 | L83 | x367 | S21 | L37 | x401 | S21 | L83 |
| x300 | S20 | L38 | x334 | S20 | L84 | x368 | S21 | L38 | x402 | S21 | L84 |
| x301 | S20 | L39 | x335 | S20 | L85 | x369 | S21 | L39 | x403 | S21 | L85 |
| x302 | S20 | L40 | x336 | S20 | L86 | x370 | S21 | L40 | x404 | S21 | L86 |
| x303 | S20 | L41 | x337 | S20 | L87 | x371 | S21 | L41 | x405 | S21 | L87 |
| x304 | S20 | L42 | x338 | S20 | L88 | x372 | S21 | L42 | x406 | S21 | L88 |
| x305 | S20 | L43 | x339 | S20 | L89 | x373 | S21 | L43 | x407 | S21 | L89 |
| x306 | S20 | L44 | x340 | S20 | L90 | x374 | S21 | L44 | x408 | S21 | L90 |
| x409 | S22 | L11 | x443 | S22 | L45 | x477 | S23 | L11 | x511 | S23 | L45 |
| x410 | S22 | L12 | x444 | S22 | L46 | x478 | S23 | L12 | x512 | S23 | L46 |
| x411 | S22 | L13 | x445 | S22 | L47 | x479 | S23 | L13 | x513 | S23 | L47 |
| x412 | S22 | L14 | x446 | S22 | L48 | x480 | S23 | L14 | x514 | S23 | L48 |
| x413 | S22 | L15 | x447 | S22 | L49 | x481 | S23 | L15 | x515 | S23 | L49 |
| x414 | S22 | L16 | x448 | S22 | L51 | x482 | S23 | L16 | x516 | S23 | L51 |
| x415 | S22 | L17 | x449 | S22 | L52 | x483 | S23 | L17 | x517 | S23 | L52 |
| x416 | S22 | L18 | x450 | S22 | L53 | x484 | S23 | L18 | x518 | S23 | L53 |
| x417 | S22 | L19 | x451 | S22 | L54 | x485 | S23 | L19 | x519 | S23 | L54 |
| x418 | S22 | L20 | x452 | S22 | L55 | x486 | S23 | L20 | x520 | S23 | L55 |
| x419 | S22 | L21 | x453 | S22 | L56 | x487 | S23 | L21 | x521 | S23 | L56 |
| x420 | S22 | L22 | x454 | S22 | L57 | x488 | S23 | L22 | x522 | S23 | L57 |
| x421 | S22 | L23 | x455 | S22 | L58 | x489 | S23 | L23 | x523 | S23 | L58 |
| x422 | S22 | L24 | x456 | S22 | L59 | x490 | S23 | L24 | x524 | S23 | L59 |
| x423 | S22 | L25 | x457 | S22 | L60 | x491 | S23 | L25 | x525 | S23 | L60 |
| x424 | S22 | L26 | x458 | S22 | L61 | x492 | S23 | L26 | x526 | S23 | L61 |
| x425 | S22 | L27 | x459 | S22 | L62 | x493 | S23 | L27 | x527 | S23 | L62 |
| x426 | S22 | L28 | x460 | S22 | L63 | x494 | S23 | L28 | x528 | S23 | L63 |
| x427 | S22 | L29 | x461 | S22 | L64 | x495 | S23 | L29 | x529 | S23 | L64 |
| x428 | S22 | L30 | x462 | S22 | L65 | x496 | S23 | L30 | x530 | S23 | L65 |
| x429 | S22 | L31 | x463 | S22 | L66 | x497 | S23 | L31 | x531 | S23 | L66 |
| x430 | S22 | L32 | x464 | S22 | L67 | x498 | S23 | L32 | x532 | S23 | L67 |
| x431 | S22 | L33 | x465 | S22 | L68 | x499 | S23 | L33 | x533 | S23 | L68 |
| x432 | S22 | L34 | x466 | S22 | L69 | x500 | S23 | L34 | x534 | S23 | L69 |
| x433 | S22 | L35 | x467 | S22 | L81 | x501 | S23 | L35 | x535 | S23 | L81 |
| x434 | S22 | L36 | x468 | S22 | L82 | x502 | S23 | L36 | x536 | S23 | L82 |
| x435 | S22 | L37 | x469 | S22 | L83 | x503 | S23 | L37 | x537 | S23 | L83 |
| x436 | S22 | L38 | x470 | S22 | L84 | x504 | S23 | L38 | x538 | S23 | L84 |
| x437 | S22 | L39 | x471 | S22 | L85 | x505 | S23 | L39 | x539 | S23 | L85 |
| x438 | S22 | L40 | x472 | S22 | L86 | x506 | S23 | L40 | x540 | S23 | L86 |
| x439 | S22 | L41 | x473 | S22 | L87 | x507 | S23 | L41 | x541 | S23 | L87 |
| x440 | S22 | L42 | x474 | S22 | L88 | x508 | S23 | L42 | x542 | S23 | L88 |
| x441 | S22 | L43 | x475 | S22 | L89 | x509 | S23 | L43 | x543 | S23 | L89 |
| x442 | S22 | L44 | x476 | S22 | L90 | x510 | S23 | L44 | x544 | S23 | L90 |
| x545 | S24 | L11 | x579 | S24 | L45 | x613 | S25 | L11 | x647 | S25 | L45 |
| x546 | S24 | L12 | x580 | S24 | L46 | x614 | S25 | L12 | x648 | S25 | L46 |
| x547 | S24 | L13 | x581 | S24 | L47 | x615 | S25 | L13 | x649 | S25 | L47 |
| x548 | S24 | L14 | x582 | S24 | L48 | x616 | S25 | L14 | x650 | S25 | L48 |
| x549 | S24 | L15 | x583 | S24 | L49 | x617 | S25 | L15 | x651 | S25 | L49 |
| x550 | S24 | L16 | x584 | S24 | L51 | x618 | S25 | L16 | x652 | S25 | L51 |
| x551 | S24 | L17 | x585 | S24 | L52 | x619 | S25 | L17 | x653 | S25 | L52 |
| x552 | S24 | L18 | x586 | S24 | L53 | x620 | S25 | L18 | x654 | S25 | L53 |
| x553 | S24 | L19 | x587 | S24 | L54 | x621 | S25 | L19 | x655 | S25 | L54 |
| x554 | S24 | L20 | x588 | S24 | L55 | x622 | S25 | L20 | x656 | S25 | L55 |
| x555 | S24 | L21 | x589 | S24 | L56 | x623 | S25 | L21 | x657 | S25 | L56 |
| x556 | S24 | L22 | x590 | S24 | L57 | x624 | S25 | L22 | x658 | S25 | L57 |
| x557 | S24 | L23 | x591 | S24 | L58 | x625 | S25 | L23 | x659 | S25 | L58 |
| x558 | S24 | L24 | x592 | S24 | L59 | x626 | S25 | L24 | x660 | S25 | L59 |
| x559 | S24 | L25 | x593 | S24 | L60 | x627 | S25 | L25 | x661 | S25 | L60 |
| x560 | S24 | L26 | x594 | S24 | L61 | x628 | S25 | L26 | x662 | S25 | L61 |
| x561 | S24 | L27 | x595 | S24 | L62 | x629 | S25 | L27 | x663 | S25 | L62 |
| x562 | S24 | L28 | x596 | S24 | L63 | x630 | S25 | L28 | x664 | S25 | L63 |
| x563 | S24 | L29 | x597 | S24 | L64 | x631 | S25 | L29 | x665 | S25 | L64 |
| x564 | S24 | L30 | x598 | S24 | L65 | x632 | S25 | L30 | x666 | S25 | L65 |
| x565 | S24 | L31 | x599 | S24 | L66 | x633 | S25 | L31 | x667 | S25 | L66 |
| x566 | S24 | L32 | x600 | S24 | L67 | x634 | S25 | L32 | x668 | S25 | L67 |
| x567 | S24 | L33 | x601 | S24 | L68 | x635 | S25 | L33 | x669 | S25 | L68 |
| x568 | S24 | L34 | x602 | S24 | L69 | x636 | S25 | L34 | x670 | S25 | L69 |
| x569 | S24 | L35 | x603 | S24 | L81 | x637 | S25 | L35 | x671 | S25 | L81 |
| x570 | S24 | L36 | x604 | S24 | L82 | x638 | S25 | L36 | x672 | S25 | L82 |
| x571 | S24 | L37 | x605 | S24 | L83 | x639 | S25 | L37 | x673 | S25 | L83 |
| x572 | S24 | L38 | x606 | S24 | L84 | x640 | S25 | L38 | x674 | S25 | L84 |
| x573 | S24 | L39 | x607 | S24 | L85 | x641 | S25 | L39 | x675 | S25 | L85 |
| x574 | S24 | L40 | x608 | S24 | L86 | x642 | S25 | L40 | x676 | S25 | L86 |
| x575 | S24 | L41 | x609 | S24 | L87 | x643 | S25 | L41 | x677 | S25 | L87 |
| x576 | S24 | L42 | x610 | S24 | L88 | x644 | S25 | L42 | x678 | S25 | L88 |
| x577 | S24 | L43 | x611 | S24 | L89 | x645 | S25 | L43 | x679 | S25 | L89 |
| x578 | S24 | L44 | x612 | S24 | L90 | x646 | S25 | L44 | x680 | S25 | L90 |
| x681 | S30 | L11 | x715 | S30 | L45 | x749 | S31 | L11 | x783 | S31 | L45 |
| x682 | S30 | L12 | x716 | S30 | L46 | x750 | S31 | L12 | x784 | S31 | L46 |
| x683 | S30 | L13 | x717 | S30 | L47 | x751 | S31 | L13 | x785 | S31 | L47 |
| x684 | S30 | L14 | x718 | S30 | L48 | x752 | S31 | L14 | x786 | S31 | L48 |
| x685 | S30 | L15 | x719 | S30 | L49 | x753 | S31 | L15 | x787 | S31 | L49 |
| x686 | S30 | L16 | x720 | S30 | L51 | x754 | S31 | L16 | x788 | S31 | L51 |
| x687 | S30 | L17 | x721 | S30 | L52 | x755 | S31 | L17 | x789 | S31 | L52 |
| x688 | S30 | L18 | x722 | S30 | L53 | x756 | S31 | L18 | x790 | S31 | L53 |
| x689 | S30 | L19 | x723 | S30 | L54 | x757 | S31 | L19 | x791 | S31 | L54 |
| x690 | S30 | L20 | x724 | S30 | L55 | x758 | S31 | L20 | x792 | S31 | L55 |
| x691 | S30 | L21 | x725 | S30 | L56 | x759 | S31 | L21 | x793 | S31 | L56 |
| x692 | S30 | L22 | x726 | S30 | L57 | x760 | S31 | L22 | x794 | S31 | L57 |
| x693 | S30 | L23 | x727 | S30 | L58 | x761 | S31 | L23 | x795 | S31 | L58 |
| x694 | S30 | L24 | x728 | S30 | L59 | x762 | S31 | L24 | x796 | S31 | L59 |
| x695 | S30 | L25 | x729 | S30 | L60 | x763 | S31 | L25 | x797 | S31 | L60 |
| x696 | S30 | L26 | x730 | S30 | L61 | x764 | S31 | L26 | x798 | S31 | L61 |
| x697 | S30 | L27 | x731 | S30 | L62 | x765 | S31 | L27 | x799 | S31 | L62 |
| x698 | S30 | L28 | x732 | S30 | L63 | x766 | S31 | L28 | x800 | S31 | L63 |
| x699 | S30 | L29 | x733 | S30 | L64 | x767 | S31 | L29 | x801 | S31 | L64 |
| x700 | S30 | L30 | x734 | S30 | L65 | x768 | S31 | L30 | x802 | S31 | L65 |
| x701 | S30 | L31 | x735 | S30 | L66 | x769 | S31 | L31 | x803 | S31 | L66 |
| x702 | S30 | L32 | x736 | S30 | L67 | x770 | S31 | L32 | x804 | S31 | L67 |
| x703 | S30 | L33 | x737 | S30 | L68 | x771 | S31 | L33 | x805 | S31 | L68 |
| x704 | S30 | L34 | x738 | S30 | L69 | x772 | S31 | L34 | x806 | S31 | L69 |
| x705 | S30 | L35 | x739 | S30 | L81 | x773 | S31 | L35 | x807 | S31 | L81 |
| x706 | S30 | L36 | x740 | S30 | L82 | x774 | S31 | L36 | x808 | S31 | L82 |
| x707 | S30 | L37 | x741 | S30 | L83 | x775 | S31 | L37 | x809 | S31 | L83 |
| x708 | S30 | L38 | x742 | S30 | L84 | x776 | S31 | L38 | x810 | S31 | L84 |
| x709 | S30 | L39 | x743 | S30 | L85 | x777 | S31 | L39 | x811 | S31 | L85 |
| x710 | S30 | L40 | x744 | S30 | L86 | x778 | S31 | L40 | x812 | S31 | L86 |
| x711 | S30 | L41 | x745 | S30 | L87 | x779 | S31 | L41 | x813 | S31 | L87 |
| x712 | S30 | L42 | x746 | S30 | L88 | x780 | S31 | L42 | x814 | S31 | L88 |
| x713 | S30 | L43 | x747 | S30 | L89 | x781 | S31 | L43 | x815 | S31 | L89 |
| x714 | S30 | L44 | x748 | S30 | L90 | x782 | S31 | L44 | x816 | S31 | L90 |
| x817 | S32 | L11 | x851 | S32 | L45 | x885 | S33 | L11 | x919 | S33 | L45 |
| x818 | S32 | L12 | x852 | S32 | L46 | x886 | S33 | L12 | x920 | S33 | L46 |
| x819 | S32 | L13 | x853 | S32 | L47 | x887 | S33 | L13 | x921 | S33 | L47 |
| x820 | S32 | L14 | x854 | S32 | L48 | x888 | S33 | L14 | x922 | S33 | L48 |
| x821 | S32 | L15 | x855 | S32 | L49 | x889 | S33 | L15 | x923 | S33 | L49 |
| x822 | S32 | L16 | x856 | S32 | L51 | x890 | S33 | L16 | x924 | S33 | L51 |
| x823 | S32 | L17 | x857 | S32 | L52 | x891 | S33 | L17 | x925 | S33 | L52 |
| x824 | S32 | L18 | x858 | S32 | L53 | x892 | S33 | L18 | x926 | S33 | L53 |
| x825 | S32 | L19 | x859 | S32 | L54 | x893 | S33 | L19 | x927 | S33 | L54 |
| x826 | S32 | L20 | x860 | S32 | L55 | x894 | S33 | L20 | x928 | S33 | L55 |
| x827 | S32 | L21 | x861 | S32 | L56 | x895 | S33 | L21 | x929 | S33 | L56 |
| x828 | S32 | L22 | x862 | S32 | L57 | x896 | S33 | L22 | x930 | S33 | L57 |
| x829 | S32 | L23 | x863 | S32 | L58 | x897 | S33 | L23 | x931 | S33 | L58 |
| x830 | S32 | L24 | x864 | S32 | L59 | x898 | S33 | L24 | x932 | S33 | L59 |
| x831 | S32 | L25 | x865 | S32 | L60 | x899 | S33 | L25 | x933 | S33 | L60 |
| x832 | S32 | L26 | x866 | S32 | L61 | x900 | S33 | L26 | x934 | S33 | L61 |
| x833 | S32 | L27 | x867 | S32 | L62 | x901 | S33 | L27 | x935 | S33 | L62 |
| x834 | S32 | L28 | x868 | S32 | L63 | x902 | S33 | L28 | x936 | S33 | L63 |
| x835 | S32 | L29 | x869 | S32 | L64 | x903 | S33 | L29 | x937 | S33 | L64 |
| x836 | S32 | L30 | x870 | S32 | L65 | x904 | S33 | L30 | x938 | S33 | L65 |
| x837 | S32 | L31 | x871 | S32 | L66 | x905 | S33 | L31 | x939 | S33 | L66 |
| x838 | S32 | L32 | x872 | S32 | L67 | x906 | S33 | L32 | x940 | S33 | L67 |
| x839 | S32 | L33 | x873 | S32 | L68 | x907 | S33 | L33 | x941 | S33 | L68 |
| x840 | S32 | L34 | x874 | S32 | L69 | x908 | S33 | L34 | x942 | S33 | L69 |
| x841 | S32 | L35 | x875 | S32 | L81 | x909 | S33 | L35 | x943 | S33 | L81 |
| x842 | S32 | L36 | x876 | S32 | L82 | x910 | S33 | L36 | x944 | S33 | L82 |
| x843 | S32 | L37 | x877 | S32 | L83 | x911 | S33 | L37 | x945 | S33 | L83 |
| x844 | S32 | L38 | x878 | S32 | L84 | x912 | S33 | L38 | x946 | S33 | L84 |
| x845 | S32 | L39 | x879 | S32 | L85 | x913 | S33 | L39 | x947 | S33 | L85 |
| x846 | S32 | L40 | x880 | S32 | L86 | x914 | S33 | L40 | x948 | S33 | L86 |
| x847 | S32 | L41 | x881 | S32 | L87 | x915 | S33 | L41 | x949 | S33 | L87 |
| x848 | S32 | L42 | x882 | S32 | L88 | x916 | S33 | L42 | x950 | S33 | L88 |
| x849 | S32 | L43 | x883 | S32 | L89 | x917 | S33 | L43 | x951 | S33 | L89 |
| x850 | S32 | L44 | x884 | S32 | L90 | x918 | S33 | L44 | x952 | S33 | L90 |
| x953 | S34 | L11 | x987 | S34 | L45 | x1021 | S35 | L11 | x1055 | S35 | L45 |
| x954 | S34 | L12 | x988 | S34 | L46 | x1022 | S35 | L12 | x1056 | S35 | L46 |
| x955 | S34 | L13 | x989 | S34 | L47 | x1023 | S35 | L13 | x1057 | S35 | L47 |
| x956 | S34 | L14 | x990 | S34 | L48 | x1024 | S35 | L14 | x1058 | S35 | L48 |
| x957 | S34 | L15 | x991 | S34 | L49 | x1025 | S35 | L15 | x1059 | S35 | L49 |
| x958 | S34 | L16 | x992 | S34 | L51 | x1026 | S35 | L16 | x1060 | S35 | L51 |
| x959 | S34 | L17 | x993 | S34 | L52 | x1027 | S35 | L17 | x1061 | S35 | L52 |
| x960 | S34 | L18 | x994 | S34 | L53 | x1028 | S35 | L18 | x1062 | S35 | L53 |
| x961 | S34 | L19 | x995 | S34 | L54 | x1029 | S35 | L19 | x1063 | S35 | L54 |
| x962 | S34 | L20 | x996 | S34 | L55 | x1030 | S35 | L20 | x1064 | S35 | L55 |
| x963 | S34 | L21 | x997 | S34 | L56 | x1031 | S35 | L21 | x1065 | S35 | L56 |
| x964 | S34 | L22 | x998 | S34 | L57 | x1032 | S35 | L22 | x1066 | S35 | L57 |
| x965 | S34 | L23 | x999 | S34 | L58 | x1033 | S35 | L23 | x1067 | S35 | L58 |
| x966 | S34 | L24 | x1000 | S34 | L59 | x1034 | S35 | L24 | x1068 | S35 | L59 |
| x967 | S34 | L25 | x1001 | S34 | L60 | x1035 | S35 | L25 | x1069 | S35 | L60 |
| x968 | S34 | L26 | x1002 | S34 | L61 | x1036 | S35 | L26 | x1070 | S35 | L61 |
| x969 | S34 | L27 | x1003 | S34 | L62 | x1037 | S35 | L27 | x1071 | S35 | L62 |
| x970 | S34 | L28 | x1004 | S34 | L63 | x1038 | S35 | L28 | x1072 | S35 | L63 |
| x971 | S34 | L29 | x1005 | S34 | L64 | x1039 | S35 | L29 | x1073 | S35 | L64 |
| x972 | S34 | L30 | x1006 | S34 | L65 | x1040 | S35 | L30 | x1074 | S35 | L65 |
| x973 | S34 | L31 | x1007 | S34 | L66 | x1041 | S35 | L31 | x1075 | S35 | L66 |
| x974 | S34 | L32 | x1008 | S34 | L67 | x1042 | S35 | L32 | x1076 | S35 | L67 |
| x975 | S34 | L33 | x1009 | S34 | L68 | x1043 | S35 | L33 | x1077 | S35 | L68 |
| x976 | S34 | L34 | x1010 | S34 | L69 | x1044 | S35 | L34 | x1078 | S35 | L69 |
| x977 | S34 | L35 | x1011 | S34 | L81 | x1045 | S35 | L35 | x1079 | S35 | L81 |
| x978 | S34 | L36 | x1012 | S34 | L82 | x1046 | S35 | L36 | x1080 | S35 | L82 |
| x979 | S34 | L37 | x1013 | S34 | L83 | x1047 | S35 | L37 | x1081 | S35 | L83 |
| x980 | S34 | L38 | x1014 | S34 | L84 | x1048 | S35 | L38 | x1082 | S35 | L84 |
| x981 | S34 | L39 | x1015 | S34 | L85 | x1049 | S35 | L39 | x1083 | S35 | L85 |
| x982 | S34 | L40 | x1016 | S34 | L86 | x1050 | S35 | L40 | x1084 | S35 | L86 |
| x983 | S34 | L41 | x1017 | S34 | L87 | x1051 | S35 | L41 | x1085 | S35 | L87 |
| x984 | S34 | L42 | x1018 | S34 | L88 | x1052 | S35 | L42 | x1086 | S35 | L88 |
| x985 | S34 | L43 | x1019 | S34 | L89 | x1053 | S35 | L43 | x1087 | S35 | L89 |
| x986 | S34 | L44 | x1020 | S34 | L90 | x1054 | S35 | L44 | x1088 | S35 | L90 |
| x1089 | S40 | L11 | x1123 | S40 | L45 | x1157 | S41 | L11 | x1191 | S41 | L45 |
| x1090 | S40 | L12 | x1124 | S40 | L46 | x1158 | S41 | L12 | x1192 | S41 | L46 |
| x1091 | S40 | L13 | x1125 | S40 | L47 | x1159 | S41 | L13 | x1193 | S41 | L47 |
| x1092 | S40 | L14 | x1126 | S40 | L48 | x1160 | S41 | L14 | x1194 | S41 | L48 |
| x1093 | S40 | L15 | x1127 | S40 | L49 | x1161 | S41 | L15 | x1195 | S41 | L49 |
| x1094 | S40 | L16 | x1128 | S40 | L51 | x1162 | S41 | L16 | x1196 | S41 | L51 |
| x1095 | S40 | L17 | x1129 | S40 | L52 | x1163 | S41 | L17 | x1197 | S41 | L52 |
| x1096 | S40 | L18 | x1130 | S40 | L53 | x1164 | S41 | L18 | x1198 | S41 | L53 |
| x1097 | S40 | L19 | x1131 | S40 | L54 | x1165 | S41 | L19 | x1199 | S41 | L54 |
| x1098 | S40 | L20 | x1132 | S40 | L55 | x1166 | S41 | L20 | x1200 | S41 | L55 |
| x1099 | S40 | L21 | x1133 | S40 | L56 | x1167 | S41 | L21 | x1201 | S41 | L56 |
| x1100 | S40 | L22 | x1134 | S40 | L57 | x1168 | S41 | L22 | x1202 | S41 | L57 |
| x1101 | S40 | L23 | x1135 | S40 | L58 | x1169 | S41 | L23 | x1203 | S41 | L58 |
| x1102 | S40 | L24 | x1136 | S40 | L59 | x1170 | S41 | L24 | x1204 | S41 | L59 |
| x1103 | S40 | L25 | x1137 | S40 | L60 | x1171 | S41 | L25 | x1205 | S41 | L60 |
| x1104 | S40 | L26 | x1138 | S40 | L61 | x1172 | S41 | L26 | x1206 | S41 | L61 |
| x1105 | S40 | L27 | x1139 | S40 | L62 | x1173 | S41 | L27 | x1207 | S41 | L62 |
| x1106 | S40 | L28 | x1140 | S40 | L63 | x1174 | S41 | L28 | x1208 | S41 | L63 |
| x1107 | S40 | L29 | x1141 | S40 | L64 | x1175 | S41 | L29 | x1209 | S41 | L64 |
| x1108 | S40 | L30 | x1142 | S40 | L65 | x1176 | S41 | L30 | x1210 | S41 | L65 |
| x1109 | S40 | L31 | x1143 | S40 | L66 | x1177 | S41 | L31 | x1211 | S41 | L66 |
| x1110 | S40 | L32 | x1144 | S40 | L67 | x1178 | S41 | L32 | x1212 | S41 | L67 |
| x1111 | S40 | L33 | x1145 | S40 | L68 | x1179 | S41 | L33 | x1213 | S41 | L68 |
| x1112 | S40 | L34 | x1146 | S40 | L69 | x1180 | S41 | L34 | x1214 | S41 | L69 |
| x1113 | S40 | L35 | x1147 | S40 | L81 | x1181 | S41 | L35 | x1215 | S41 | L81 |
| x1114 | S40 | L36 | x1148 | S40 | L82 | x1182 | S41 | L36 | x1216 | S41 | L82 |
| x1115 | S40 | L37 | x1149 | S40 | L83 | x1183 | S41 | L37 | x1217 | S41 | L83 |
| x1116 | S40 | L38 | x1150 | S40 | L84 | x1184 | S41 | L38 | x1218 | S41 | L84 |
| x1117 | S40 | L39 | x1151 | S40 | L85 | x1185 | S41 | L39 | x1219 | S41 | L85 |
| x1118 | S40 | L40 | x1152 | S40 | L86 | x1186 | S41 | L40 | x1220 | S41 | L86 |
| x1119 | S40 | L41 | x1153 | S40 | L87 | x1187 | S41 | L41 | x1221 | S41 | L87 |
| x1120 | S40 | L42 | x1154 | S40 | L88 | x1188 | S41 | L42 | x1222 | S41 | L88 |
| x1121 | S40 | L43 | x1155 | S40 | L89 | x1189 | S41 | L43 | x1223 | S41 | L89 |
| x1122 | S40 | L44 | x1156 | S40 | L90 | x1190 | S41 | L44 | x1224 | S41 | L90 |
| x1225 | S42 | L11 | x1259 | S42 | L45 | x1293 | S43 | L11 | x1327 | S43 | L45 |
| x1226 | S42 | L12 | x1260 | S42 | L46 | x1294 | S43 | L12 | x1328 | S43 | L46 |
| x1227 | S42 | L13 | x1261 | S42 | L47 | x1295 | S43 | L13 | x1329 | S43 | L47 |
| x1228 | S42 | L14 | x1262 | S42 | L48 | x1296 | S43 | L14 | x1330 | S43 | L48 |
| x1229 | S42 | L15 | x1263 | S42 | L49 | x1297 | S43 | L15 | x1331 | S43 | L49 |
| x1230 | S42 | L16 | x1264 | S42 | L51 | x1298 | S43 | L16 | x1332 | S43 | L51 |
| x1231 | S42 | L17 | x1265 | S42 | L52 | x1299 | S43 | L17 | x1333 | S43 | L52 |
| x1232 | S42 | L18 | x1266 | S42 | L53 | x1300 | S43 | L18 | x1334 | S43 | L53 |
| x1233 | S42 | L19 | x1267 | S42 | L54 | x1301 | S43 | L19 | x1335 | S43 | L54 |
| x1234 | S42 | L20 | x1268 | S42 | L55 | x1302 | S43 | L20 | x1336 | S43 | L55 |
| x1235 | S42 | L21 | x1269 | S42 | L56 | x1303 | S43 | L21 | x1337 | S43 | L56 |
| x1236 | S42 | L22 | x1270 | S42 | L57 | x1304 | S43 | L22 | x1338 | S43 | L57 |
| x1237 | S42 | L23 | x1271 | S42 | L58 | x1305 | S43 | L23 | x1339 | S43 | L58 |
| x1238 | S42 | L24 | x1272 | S42 | L59 | x1306 | S43 | L24 | x1340 | S43 | L59 |
| x1239 | S42 | L25 | x1273 | S42 | L60 | x1307 | S43 | L25 | x1341 | S43 | L60 |
| x1240 | S42 | L26 | x1274 | S42 | L61 | x1308 | S43 | L26 | x1342 | S43 | L61 |
| x1241 | S42 | L27 | x1275 | S42 | L62 | x1309 | S43 | L27 | x1343 | S43 | L62 |
| x1242 | S42 | L28 | x1276 | S42 | L63 | x1310 | S43 | L28 | x1344 | S43 | L63 |
| x1243 | S42 | L29 | x1277 | S42 | L64 | x1311 | S43 | L29 | x1345 | S43 | L64 |
| x1244 | S42 | L30 | x1278 | S42 | L65 | x1312 | S43 | L30 | x1346 | S43 | L65 |
| x1245 | S42 | L31 | x1279 | S42 | L66 | x1313 | S43 | L31 | x1347 | S43 | L66 |
| x1246 | S42 | L32 | x1280 | S42 | L67 | x1314 | S43 | L32 | x1348 | S43 | L67 |
| x1247 | S42 | L33 | x1281 | S42 | L68 | x1315 | S43 | L33 | x1349 | S43 | L68 |
| x1248 | S42 | L34 | x1282 | S42 | L69 | x1316 | S43 | L34 | x1350 | S43 | L69 |
| x1249 | S42 | L35 | x1283 | S42 | L81 | x1317 | S43 | L35 | x1351 | S43 | L81 |
| x1250 | S42 | L36 | x1284 | S42 | L82 | x1318 | S43 | L36 | x1352 | S43 | L82 |
| x1251 | S42 | L37 | x1285 | S42 | L83 | x1319 | S43 | L37 | x1353 | S43 | L83 |
| x1252 | S42 | L38 | x1286 | S42 | L84 | x1320 | S43 | L38 | x1354 | S43 | L84 |
| x1253 | S42 | L39 | x1287 | S42 | L85 | x1321 | S43 | L39 | x1355 | S43 | L85 |
| x1254 | S42 | L40 | x1288 | S42 | L86 | x1322 | S43 | L40 | x1356 | S43 | L86 |
| x1255 | S42 | L41 | x1289 | S42 | L87 | x1323 | S43 | L41 | x1357 | S43 | L87 |
| x1256 | S42 | L42 | x1290 | S42 | L88 | x1324 | S43 | L42 | x1358 | S43 | L88 |
| x1257 | S42 | L43 | x1291 | S42 | L89 | x1325 | S43 | L43 | x1359 | S43 | L89 |
| x1258 | S42 | L44 | x1292 | S42 | L90 | x1326 | S43 | L44 | x1360 | S43 | L90 |
| x1361 | S50 | L11 | x1395 | S50 | L45 | x1429 | S51 | L11 | x1463 | S51 | L45 |
| x1362 | S50 | L12 | x1396 | S50 | L46 | x1430 | S51 | L12 | x1464 | S51 | L46 |
| x1363 | S50 | L13 | x1397 | S50 | L47 | x1431 | S51 | L13 | x1465 | S51 | L47 |
| x1364 | S50 | L14 | x1398 | S50 | L48 | x1432 | S51 | L14 | x1466 | S51 | L48 |
| x1365 | S50 | L15 | x1399 | S50 | L49 | x1433 | S51 | L15 | x1467 | S51 | L49 |
| x1366 | S50 | L16 | x1400 | S50 | L51 | x1434 | S51 | L16 | x1468 | S51 | L51 |
| x1367 | S50 | L17 | x1401 | S50 | L52 | x1435 | S51 | L17 | x1469 | S51 | L52 |
| x1368 | S50 | L18 | x1402 | S50 | L53 | x1436 | S51 | L18 | x1470 | S51 | L53 |
| x1369 | S50 | L19 | x1403 | S50 | L54 | x1437 | S51 | L19 | x1471 | S51 | L54 |
| x1370 | S50 | L20 | x1404 | S50 | L55 | x1438 | S51 | L20 | x1472 | S51 | L55 |
| x1371 | S50 | L21 | x1405 | S50 | L56 | x1439 | S51 | L21 | x1473 | S51 | L56 |
| x1372 | S50 | L22 | x1406 | S50 | L57 | x1440 | S51 | L22 | x1474 | S51 | L57 |
| x1373 | S50 | L23 | x1407 | S50 | L58 | x1441 | S51 | L23 | x1475 | S51 | L58 |
| x1374 | S50 | L24 | x1408 | S50 | L59 | x1442 | S51 | L24 | x1476 | S51 | L59 |
| x1375 | S50 | L25 | x1409 | S50 | L60 | x1443 | S51 | L25 | x1477 | S51 | L60 |
| x1376 | S50 | L26 | x1410 | S50 | L61 | x1444 | S51 | L26 | x1478 | S51 | L61 |
| x1377 | S50 | L27 | x1411 | S50 | L62 | x1445 | S51 | L27 | x1479 | S51 | L62 |
| x1378 | S50 | L28 | x1412 | S50 | L63 | x1446 | S51 | L28 | x1480 | S51 | L63 |
| x1379 | S50 | L29 | x1413 | S50 | L64 | x1447 | S51 | L29 | x1481 | S51 | L64 |
| x1380 | S50 | L30 | x1414 | S50 | L65 | x1448 | S51 | L30 | x1482 | S51 | L65 |
| x1381 | S50 | L31 | x1415 | S50 | L66 | x1449 | S51 | L31 | x1483 | S51 | L66 |
| x1382 | S50 | L32 | x1416 | S50 | L67 | x1450 | S51 | L32 | x1484 | S51 | L67 |
| x1383 | S50 | L33 | x1417 | S50 | L68 | x1451 | S51 | L33 | x1485 | S51 | L68 |
| x1384 | S50 | L34 | x1418 | S50 | L69 | x1452 | S51 | L34 | x1486 | S51 | L69 |
| x1385 | S50 | L35 | x1419 | S50 | L81 | x1453 | S51 | L35 | x1487 | S51 | L81 |
| x1386 | S50 | L36 | x1420 | S50 | L82 | x1454 | S51 | L36 | x1488 | S51 | L82 |
| x1387 | S50 | L37 | x1421 | S50 | L83 | x1455 | S51 | L37 | x1489 | S51 | L83 |
| x1388 | S50 | L38 | x1422 | S50 | L84 | x1456 | S51 | L38 | x1490 | S51 | L84 |
| x1389 | S50 | L39 | x1423 | S50 | L85 | x1457 | S51 | L39 | x1491 | S51 | L85 |
| x1390 | S50 | L40 | x1424 | S50 | L86 | x1458 | S51 | L40 | x1492 | S51 | L86 |
| x1391 | S50 | L41 | x1425 | S50 | L87 | x1459 | S51 | L41 | x1493 | S51 | L87 |
| x1392 | S50 | L42 | x1426 | S50 | L88 | x1460 | S51 | L42 | x1494 | S51 | L88 |
| x1393 | S50 | L43 | x1427 | S50 | L89 | x1461 | S51 | L43 | x1495 | S51 | L89 |
| x1394 | S50 | L44 | x1428 | S50 | L90 | x1462 | S51 | L44 | x1496 | S51 | L90 |
| x1497 | S52 | L11 | x1531 | S52 | L45 | x1565 | S53 | L11 | x1599 | S53 | L45 |
| x1498 | S52 | L12 | x1532 | S52 | L46 | x1566 | S53 | L12 | x1600 | S53 | L46 |
| x1499 | S52 | L13 | x1533 | S52 | L47 | x1567 | S53 | L13 | x1601 | S53 | L47 |
| x1500 | S52 | L14 | x1534 | S52 | L48 | x1568 | S53 | L14 | x1602 | S53 | L48 |
| x1501 | S52 | L15 | x1535 | S52 | L49 | x1569 | S53 | L15 | x1603 | S53 | L49 |
| x1502 | S52 | L16 | x1536 | S52 | L51 | x1570 | S53 | L16 | x1604 | S53 | L51 |
| x1503 | S52 | L17 | x1537 | S52 | L52 | x1571 | S53 | L17 | x1605 | S53 | L52 |
| x1504 | S52 | L18 | x1538 | S52 | L53 | x1572 | S53 | L18 | x1606 | S53 | L53 |
| x1505 | S52 | L19 | x1539 | S52 | L54 | x1573 | S53 | L19 | x1607 | S53 | L54 |
| x1506 | S52 | L20 | x1540 | S52 | L55 | x1574 | S53 | L20 | x1608 | S53 | L55 |
| x1507 | S52 | L21 | x1541 | S52 | L56 | x1575 | S53 | L21 | x1609 | S53 | L56 |
| x1508 | S52 | L22 | x1542 | S52 | L57 | x1576 | S53 | L22 | x1610 | S53 | L57 |
| x1509 | S52 | L23 | x1543 | S52 | L58 | x1577 | S53 | L23 | x1611 | S53 | L58 |
| x1510 | S52 | L24 | x1544 | S52 | L59 | x1578 | S53 | L24 | x1612 | S53 | L59 |
| x1511 | S52 | L25 | x1545 | S52 | L60 | x1579 | S53 | L25 | x1613 | S53 | L60 |
| x1512 | S52 | L26 | x1546 | S52 | L61 | x1580 | S53 | L26 | x1614 | S53 | L61 |
| x1513 | S52 | L27 | x1547 | S52 | L62 | x1581 | S53 | L27 | x1615 | S53 | L62 |
| x1514 | S52 | L28 | x1548 | S52 | L63 | x1582 | S53 | L28 | x1616 | S53 | L63 |
| x1515 | S52 | L29 | x1549 | S52 | L64 | x1583 | S53 | L29 | x1617 | S53 | L64 |
| x1516 | S52 | L30 | x1550 | S52 | L65 | x1584 | S53 | L30 | x1618 | S53 | L65 |
| x1517 | S52 | L31 | x1551 | S52 | L66 | x1585 | S53 | L31 | x1619 | S53 | L66 |
| x1518 | S52 | L32 | x1552 | S52 | L67 | x1586 | S53 | L32 | x1620 | S53 | L67 |
| x1519 | S52 | L33 | x1553 | S52 | L68 | x1587 | S53 | L33 | x1621 | S53 | L68 |
| x1520 | S52 | L34 | x1554 | S52 | L69 | x1588 | S53 | L34 | x1622 | S53 | L69 |
| x1521 | S52 | L35 | x1555 | S52 | L81 | x1589 | S53 | L35 | x1623 | S53 | L81 |
| x1522 | S52 | L36 | x1556 | S52 | L82 | x1590 | S53 | L36 | x1624 | S53 | L82 |
| x1523 | S52 | L37 | x1557 | S52 | L83 | x1591 | S53 | L37 | x1625 | S53 | L83 |
| x1524 | S52 | L38 | x1558 | S52 | L84 | x1592 | S53 | L38 | x1626 | S53 | L84 |
| x1525 | S52 | L39 | x1559 | S52 | L85 | x1593 | S53 | L39 | x1627 | S53 | L85 |
| x1526 | S52 | L40 | x1560 | S52 | L86 | x1594 | S53 | L40 | x1628 | S53 | L86 |
| x1527 | S52 | L41 | x1561 | S52 | L87 | x1595 | S53 | L41 | x1629 | S53 | L87 |
| x1528 | S52 | L42 | x1562 | S52 | L88 | x1596 | S53 | L42 | x1630 | S53 | L88 |
| x1529 | S52 | L43 | x1563 | S52 | L89 | x1597 | S53 | L43 | x1631 | S53 | L89 |
| x1530 | S52 | L44 | x1564 | S52 | L90 | x1598 | S53 | L44 | x1632 | S53 | L90 |
| x1633 | S54 | L11 | x1667 | S54 | L45 | x1701 | S55 | L11 | x1735 | S55 | L45 |
| x1634 | S54 | L12 | x1668 | S54 | L46 | x1702 | S55 | L12 | x1736 | S55 | L46 |
| x1635 | S54 | L13 | x1669 | S54 | L47 | x1703 | S55 | L13 | x1737 | S55 | L47 |
| x1636 | S54 | L14 | x1670 | S54 | L48 | x1704 | S55 | L14 | x1738 | S55 | L48 |
| x1637 | S54 | L15 | x1671 | S54 | L49 | x1705 | S55 | L15 | x1739 | S55 | L49 |
| x1638 | S54 | L16 | x1672 | S54 | L51 | x1706 | S55 | L16 | x1740 | S55 | L51 |
| x1639 | S54 | L17 | x1673 | S54 | L52 | x1707 | S55 | L17 | x1741 | S55 | L52 |
| x1640 | S54 | L18 | x1674 | S54 | L53 | x1708 | S55 | L18 | x1742 | S55 | L53 |
| x1641 | S54 | L19 | x1675 | S54 | L54 | x1709 | S55 | L19 | x1743 | S55 | L54 |
| x1642 | S54 | L20 | x1676 | S54 | L55 | x1710 | S55 | L20 | x1744 | S55 | L55 |
| x1643 | S54 | L21 | x1677 | S54 | L56 | x1711 | S55 | L21 | x1745 | S55 | L56 |
| x1644 | S54 | L22 | x1678 | S54 | L57 | x1712 | S55 | L22 | x1746 | S55 | L57 |
| x1645 | S54 | L23 | x1679 | S54 | L58 | x1713 | S55 | L23 | x1747 | S55 | L58 |
| x1646 | S54 | L24 | x1680 | S54 | L59 | x1714 | S55 | L24 | x1748 | S55 | L59 |
| x1647 | S54 | L25 | x1681 | S54 | L60 | x1715 | S55 | L25 | x1749 | S55 | L60 |
| x1648 | S54 | L26 | x1682 | S54 | L61 | x1716 | S55 | L26 | x1750 | S55 | L61 |
| x1649 | S54 | L27 | x1683 | S54 | L62 | x1717 | S55 | L27 | x1751 | S55 | L62 |
| x1650 | S54 | L28 | x1684 | S54 | L63 | x1718 | S55 | L28 | x1752 | S55 | L63 |
| x1651 | S54 | L29 | x1685 | S54 | L64 | x1719 | S55 | L29 | x1753 | S55 | L64 |
| x1652 | S54 | L30 | x1686 | S54 | L65 | x1720 | S55 | L30 | x1754 | S55 | L65 |
| x1653 | S54 | L31 | x1687 | S54 | L66 | x1721 | S55 | L31 | x1755 | S55 | L66 |
| x1654 | S54 | L32 | x1688 | S54 | L67 | x1722 | S55 | L32 | x1756 | S55 | L67 |
| x1655 | S54 | L33 | x1689 | S54 | L68 | x1723 | S55 | L33 | x1757 | S55 | L68 |
| x1656 | S54 | L34 | x1690 | S54 | L69 | x1724 | S55 | L34 | x1758 | S55 | L69 |
| x1657 | S54 | L35 | x1691 | S54 | L81 | x1725 | S55 | L35 | x1759 | S55 | L81 |
| x1658 | S54 | L36 | x1692 | S54 | L82 | x1726 | S55 | L36 | x1760 | S55 | L82 |
| x1659 | S54 | L37 | x1693 | S54 | L83 | x1727 | S55 | L37 | x1761 | S55 | L83 |
| x1660 | S54 | L38 | x1694 | S54 | L84 | x1728 | S55 | L38 | x1762 | S55 | L84 |
| x1661 | S54 | L39 | x1695 | S54 | L85 | x1729 | S55 | L39 | x1763 | S55 | L85 |
| x1662 | S54 | L40 | x1696 | S54 | L86 | x1730 | S55 | L40 | x1764 | S55 | L86 |
| x1663 | S54 | L41 | x1697 | S54 | L87 | x1731 | S55 | L41 | x1765 | S55 | L87 |
| x1664 | S54 | L42 | x1698 | S54 | L88 | x1732 | S55 | L42 | x1766 | S55 | L88 |
| x1665 | S54 | L43 | x1699 | S54 | L89 | x1733 | S55 | L43 | x1767 | S55 | L89 |
| x1666 | S54 | L44 | x1700 | S54 | L90 | x1734 | S55 | L44 | x1768 | S55 | L90 |
| x1769 | S60 | L11 | x1803 | S60 | L45 | x1837 | S62 | L11 | x1871 | S62 | L45 |
| x1770 | S60 | L12 | x1804 | S60 | L46 | x1838 | S62 | L12 | x1872 | S62 | L46 |
| x1771 | S60 | L13 | x1805 | S60 | L47 | x1839 | S62 | L13 | x1873 | S62 | L47 |
| x1772 | S60 | L14 | x1806 | S60 | L48 | x1840 | S62 | L14 | x1874 | S62 | L48 |
| x1773 | S60 | L15 | x1807 | S60 | L49 | x1841 | S62 | L15 | x1875 | S62 | L49 |
| x1774 | S60 | L16 | x1808 | S60 | L51 | x1842 | S62 | L16 | x1876 | S62 | L51 |
| x1775 | S60 | L17 | x1809 | S60 | L52 | x1843 | S62 | L17 | x1877 | S62 | L52 |
| x1776 | S60 | L18 | x1810 | S60 | L53 | x1844 | S62 | L18 | x1878 | S62 | L53 |
| x1777 | S60 | L19 | x1811 | S60 | L54 | x1845 | S62 | L19 | x1879 | S62 | L54 |
| x1778 | S60 | L20 | x1812 | S60 | L55 | x1846 | S62 | L20 | x1880 | S62 | L55 |
| x1779 | S60 | L21 | x1813 | S60 | L56 | x1847 | S62 | L21 | x1881 | S62 | L56 |
| x1780 | S60 | L22 | x1814 | S60 | L57 | x1848 | S62 | L22 | x1882 | S62 | L57 |
| x1781 | S60 | L23 | x1815 | S60 | L58 | x1849 | S62 | L23 | x1883 | S62 | L58 |
| x1782 | S60 | L24 | x1816 | S60 | L59 | x1850 | S62 | L24 | x1884 | S62 | L59 |
| x1783 | S60 | L25 | x1817 | S60 | L60 | x1851 | S62 | L25 | x1885 | S62 | L60 |
| x1784 | S60 | L26 | x1818 | S60 | L61 | x1852 | S62 | L26 | x1886 | S62 | L61 |
| x1785 | S60 | L27 | x1819 | S60 | L62 | x1853 | S62 | L27 | x1887 | S62 | L62 |
| x1786 | S60 | L28 | x1820 | S60 | L63 | x1854 | S62 | L28 | x1888 | S62 | L63 |
| x1787 | S60 | L29 | x1821 | S60 | L64 | x1855 | S62 | L29 | x1889 | S62 | L64 |
| x1788 | S60 | L30 | x1822 | S60 | L65 | x1856 | S62 | L30 | x1890 | S62 | L65 |
| x1789 | S60 | L31 | x1823 | S60 | L66 | x1857 | S62 | L31 | x1891 | S62 | L66 |
| x1790 | S60 | L32 | x1824 | S60 | L67 | x1858 | S62 | L32 | x1892 | S62 | L67 |
| x1791 | S60 | L33 | x1825 | S60 | L68 | x1859 | S62 | L33 | x1893 | S62 | L68 |
| x1792 | S60 | L34 | x1826 | S60 | L69 | x1860 | S62 | L34 | x1894 | S62 | L69 |
| x1793 | S60 | L35 | x1827 | S60 | L81 | x1861 | S62 | L35 | x1895 | S62 | L81 |
| x1794 | S60 | L36 | x1828 | S60 | L82 | x1862 | S62 | L36 | x1896 | S62 | L82 |
| x1795 | S60 | L37 | x1829 | S60 | L83 | x1863 | S62 | L37 | x1897 | S62 | L83 |
| x1796 | S60 | L38 | x1830 | S60 | L84 | x1864 | S62 | L38 | x1898 | S62 | L84 |
| x1797 | S60 | L39 | x1831 | S60 | L85 | x1865 | S62 | L39 | x1899 | S62 | L85 |
| x1798 | S60 | L40 | x1832 | S60 | L86 | x1866 | S62 | L40 | x1900 | S62 | L86 |
| x1799 | S60 | L41 | x1833 | S60 | L87 | x1867 | S62 | L41 | x1901 | S62 | L87 |
| x1800 | S60 | L42 | x1834 | S60 | L88 | x1868 | S62 | L42 | x1902 | S62 | L88 |
| x1801 | S60 | L43 | x1835 | S60 | L89 | x1869 | S62 | L43 | x1903 | S62 | L89 |
| x1802 | S60 | L44 | x1836 | S60 | L90 | x1870 | S62 | L44 | x1904 | S62 | L90 |
| x1905 | S63 | L11 | x1939 | S63 | L45 | x1973 | S64 | L11 | x2007 | S64 | L45 |
| x1906 | S63 | L12 | x1940 | S63 | L46 | x1974 | S64 | L12 | x2008 | S64 | L46 |
| x1907 | S63 | L13 | x1941 | S63 | L47 | x1975 | S64 | L13 | x2009 | S64 | L47 |
| x1908 | S63 | L14 | x1942 | S63 | L48 | x1976 | S64 | L14 | x2010 | S64 | L48 |
| x1909 | S63 | L15 | x1943 | S63 | L49 | x1977 | S64 | L15 | x2011 | S64 | L49 |
| x1910 | S63 | L16 | x1944 | S63 | L51 | x1978 | S64 | L16 | x2012 | S64 | L51 |
| x1911 | S63 | L17 | x1945 | S63 | L52 | x1979 | S64 | L17 | x2013 | S64 | L52 |
| x1912 | S63 | L18 | x1946 | S63 | L53 | x1980 | S64 | L18 | x2014 | S64 | L53 |
| x1913 | S63 | L19 | x1947 | S63 | L54 | x1981 | S64 | L19 | x2015 | S64 | L54 |
| x1914 | S63 | L20 | x1948 | S63 | L55 | x1982 | S64 | L20 | x2016 | S64 | L55 |
| x1915 | S63 | L21 | x1949 | S63 | L56 | x1983 | S64 | L21 | x2017 | S64 | L56 |
| x1916 | S63 | L22 | x1950 | S63 | L57 | x1984 | S64 | L22 | x2018 | S64 | L57 |
| x1917 | S63 | L23 | x1951 | S63 | L58 | x1985 | S64 | L23 | x2019 | S64 | L58 |
| x1918 | S63 | L24 | x1952 | S63 | L59 | x1986 | S64 | L24 | x2020 | S64 | L59 |
| x1919 | S63 | L25 | x1953 | S63 | L60 | x1987 | S64 | L25 | x2021 | S64 | L60 |
| x1920 | S63 | L26 | x1954 | S63 | L61 | x1988 | S64 | L26 | x2022 | S64 | L61 |
| x1921 | S63 | L27 | x1955 | S63 | L62 | x1989 | S64 | L27 | x2023 | S64 | L62 |
| x1922 | S63 | L28 | x1956 | S63 | L63 | x1990 | S64 | L28 | x2024 | S64 | L63 |
| x1923 | S63 | L29 | x1957 | S63 | L64 | x1991 | S64 | L29 | x2025 | S64 | L64 |
| x1924 | S63 | L30 | x1958 | S63 | L65 | x1992 | S64 | L30 | x2026 | S64 | L65 |
| x1925 | S63 | L31 | x1959 | S63 | L66 | x1993 | S64 | L31 | x2027 | S64 | L66 |
| x1926 | S63 | L32 | x1960 | S63 | L67 | x1994 | S64 | L32 | x2028 | S64 | L67 |
| x1927 | S63 | L33 | x1961 | S63 | L68 | x1995 | S64 | L33 | x2029 | S64 | L68 |
| x1928 | S63 | L34 | x1962 | S63 | L69 | x1996 | S64 | L34 | x2030 | S64 | L69 |
| x1929 | S63 | L35 | x1963 | S63 | L81 | x1997 | S64 | L35 | x2031 | S64 | L81 |
| x1930 | S63 | L36 | x1964 | S63 | L82 | x1998 | S64 | L36 | x2032 | S64 | L82 |
| x1931 | S63 | L37 | x1965 | S63 | L83 | x1999 | S64 | L37 | x2033 | S64 | L83 |
| x1932 | S63 | L38 | x1966 | S63 | L84 | x2000 | S64 | L38 | x2034 | S64 | L84 |
| x1933 | S63 | L39 | x1967 | S63 | L85 | x2001 | S64 | L39 | x2035 | S64 | L85 |
| x1934 | S63 | L40 | x1968 | S63 | L86 | x2002 | S64 | L40 | x2036 | S64 | L86 |
| x1935 | S63 | L41 | x1969 | S63 | L87 | x2003 | S64 | L41 | x2037 | S64 | L87 |
| x1936 | S63 | L42 | x1970 | S63 | L88 | x2004 | S64 | L42 | x2038 | S64 | L88 |
| x1937 | S63 | L43 | x1971 | S63 | L89 | x2005 | S64 | L43 | x2039 | S64 | L89 |
| x1938 | S63 | L44 | x1972 | S63 | L90 | x2006 | S64 | L44 | x2040 | S64 | L90 |
| x2041 | S65 | L11 | x2075 | S65 | L45 | x2109 | S70 | L11 | x2143 | S70 | L45 |
| x2042 | S65 | L12 | x2076 | S65 | L46 | x2110 | S70 | L12 | x2144 | S70 | L46 |
| x2043 | S65 | L13 | x2077 | S65 | L47 | x2111 | S70 | L13 | x2145 | S70 | L47 |
| x2044 | S65 | L14 | x2078 | S65 | L48 | x2112 | S70 | L14 | x2146 | S70 | L48 |
| x2045 | S65 | L15 | x2079 | S65 | L49 | x2113 | S70 | L15 | x2147 | S70 | L49 |
| x2046 | S65 | L16 | x2080 | S65 | L51 | x2114 | S70 | L16 | x2148 | S70 | L51 |
| x2047 | S65 | L17 | x2081 | S65 | L52 | x2115 | S70 | L17 | x2149 | S70 | L52 |
| x2048 | S65 | L18 | x2082 | S65 | L53 | x2116 | S70 | L18 | x2150 | S70 | L53 |
| x2049 | S65 | L19 | x2083 | S65 | L54 | x2117 | S70 | L19 | x2151 | S70 | L54 |
| x2050 | S65 | L20 | x2084 | S65 | L55 | x2118 | S70 | L20 | x2152 | S70 | L55 |
| x2051 | S65 | L21 | x2085 | S65 | L56 | x2119 | S70 | L21 | x2153 | S70 | L56 |
| x2052 | S65 | L22 | x2086 | S65 | L57 | x2120 | S70 | L22 | x2154 | S70 | L57 |
| x2053 | S65 | L23 | x2087 | S65 | L58 | x2121 | S70 | L23 | x2155 | S70 | L58 |
| x2054 | S65 | L24 | x2088 | S65 | L59 | x2122 | S70 | L24 | x2156 | S70 | L59 |
| x2055 | S65 | L25 | x2089 | S65 | L60 | x2123 | S70 | L25 | x2157 | S70 | L60 |
| x2056 | S65 | L26 | x2090 | S65 | L61 | x2124 | S70 | L26 | x2158 | S70 | L61 |
| x2057 | S65 | L27 | x2091 | S65 | L62 | x2125 | S70 | L27 | x2159 | S70 | L62 |
| x2058 | S65 | L28 | x2092 | S65 | L63 | x2126 | S70 | L28 | x2160 | S70 | L63 |
| x2059 | S65 | L29 | x2093 | S65 | L64 | x2127 | S70 | L29 | x2161 | S70 | L64 |
| x2060 | S65 | L30 | x2094 | S65 | L65 | x2128 | S70 | L30 | x2162 | S70 | L65 |
| x2061 | S65 | L31 | x2095 | S65 | L66 | x2129 | S70 | L31 | x2163 | S70 | L66 |
| x2062 | S65 | L32 | x2096 | S65 | L67 | x2130 | S70 | L32 | x2164 | S70 | L67 |
| x2063 | S65 | L33 | x2097 | S65 | L68 | x2131 | S70 | L33 | x2165 | S70 | L68 |
| x2064 | S65 | L34 | x2098 | S65 | L69 | x2132 | S70 | L34 | x2166 | S70 | L69 |
| x2065 | S65 | L35 | x2099 | S65 | L81 | x2133 | S70 | L35 | x2167 | S70 | L81 |
| x2066 | S65 | L36 | x2100 | S65 | L82 | x2134 | S70 | L36 | x2168 | S70 | L82 |
| x2067 | S65 | L37 | x2101 | S65 | L83 | x2135 | S70 | L37 | x2169 | S70 | L83 |
| x2068 | S65 | L38 | x2102 | S65 | L84 | x2136 | S70 | L38 | x2170 | S70 | L84 |
| x2069 | S65 | L39 | x2103 | S65 | L85 | x2137 | S70 | L39 | x2171 | S70 | L85 |
| x2070 | S65 | L40 | x2104 | S65 | L86 | x2138 | S70 | L40 | x2172 | S70 | L86 |
| x2071 | S65 | L41 | x2105 | S65 | L87 | x2139 | S70 | L41 | x2173 | S70 | L87 |
| x2072 | S65 | L42 | x2106 | S65 | L88 | x2140 | S70 | L42 | x2174 | S70 | L88 |
| x2073 | S65 | L43 | x2107 | S65 | L89 | x2141 | S70 | L43 | x2175 | S70 | L89 |
| x2074 | S65 | L44 | x2108 | S65 | L90 | x2142 | S70 | L44 | x2176 | S70 | L90 |
| x2177 | S71 | L11 | x2211 | S71 | L45 | x2245 | S72 | L11 | x2279 | S72 | L45 |
| x2178 | S71 | L12 | x2212 | S71 | L46 | x2246 | S72 | L12 | x2280 | S72 | L46 |
| x2179 | S71 | L13 | x2213 | S71 | L47 | x2247 | S72 | L13 | x2281 | S72 | L47 |
| x2180 | S71 | L14 | x2214 | S71 | L48 | x2248 | S72 | L14 | x2282 | S72 | L48 |
| x2181 | S71 | L15 | x2215 | S71 | L49 | x2249 | S72 | L15 | x2283 | S72 | L49 |
| x2182 | S71 | L16 | x2216 | S71 | L51 | x2250 | S72 | L16 | x2284 | S72 | L51 |
| x2183 | S71 | L17 | x2217 | S71 | L52 | x2251 | S72 | L17 | x2285 | S72 | L52 |
| x2184 | S71 | L18 | x2218 | S71 | L53 | x2252 | S72 | L18 | x2286 | S72 | L53 |
| x2185 | S71 | L19 | x2219 | S71 | L54 | x2253 | S72 | L19 | x2287 | S72 | L54 |
| x2186 | S71 | L20 | x2220 | S71 | L55 | x2254 | S72 | L20 | x2288 | S72 | L55 |
| x2187 | S71 | L21 | x2221 | S71 | L56 | x2255 | S72 | L21 | x2289 | S72 | L56 |
| x2188 | S71 | L22 | x2222 | S71 | L57 | x2256 | S72 | L22 | x2290 | S72 | L57 |
| x2189 | S71 | L23 | x2223 | S71 | L58 | x2257 | S72 | L23 | x2291 | S72 | L58 |
| x2190 | S71 | L24 | x2224 | S71 | L59 | x2258 | S72 | L24 | x2292 | S72 | L59 |
| x2191 | S71 | L25 | x2225 | S71 | L60 | x2259 | S72 | L25 | x2293 | S72 | L60 |
| x2192 | S71 | L26 | x2226 | S71 | L61 | x2260 | S72 | L26 | x2294 | S72 | L61 |
| x2193 | S71 | L27 | x2227 | S71 | L62 | x2261 | S72 | L27 | x2295 | S72 | L62 |
| x2194 | S71 | L28 | x2228 | S71 | L63 | x2262 | S72 | L28 | x2296 | S72 | L63 |
| x2195 | S71 | L29 | x2229 | S71 | L64 | x2263 | S72 | L29 | x2297 | S72 | L64 |
| x2196 | S71 | L30 | x2230 | S71 | L65 | x2264 | S72 | L30 | x2298 | S72 | L65 |
| x2197 | S71 | L31 | x2231 | S71 | L66 | x2265 | S72 | L31 | x2299 | S72 | L66 |
| x2198 | S71 | L32 | x2232 | S71 | L67 | x2266 | S72 | L32 | x2300 | S72 | L67 |
| x2199 | S71 | L33 | x2233 | S71 | L68 | x2267 | S72 | L33 | x2301 | S72 | L68 |
| x2200 | S71 | L34 | x2234 | S71 | L69 | x2268 | S72 | L34 | x2302 | S72 | L69 |
| x2201 | S71 | L35 | x2235 | S71 | L81 | x2269 | S72 | L35 | x2303 | S72 | L81 |
| x2202 | S71 | L36 | x2236 | S71 | L82 | x2270 | S72 | L36 | x2304 | S72 | L82 |
| x2203 | S71 | L37 | x2237 | S71 | L83 | x2271 | S72 | L37 | x2305 | S72 | L83 |
| x2204 | S71 | L38 | x2238 | S71 | L84 | x2272 | S72 | L38 | x2306 | S72 | L84 |
| x2205 | S71 | L39 | x2239 | S71 | L85 | x2273 | S72 | L39 | x2307 | S72 | L85 |
| x2206 | S71 | L40 | x2240 | S71 | L86 | x2274 | S72 | L40 | x2308 | S72 | L86 |
| x2207 | S71 | L41 | x2241 | S71 | L87 | x2275 | S72 | L41 | x2309 | S72 | L87 |
| x2208 | S71 | L42 | x2242 | S71 | L88 | x2276 | S72 | L42 | x2310 | S72 | L88 |
| x2209 | S71 | L43 | x2243 | S71 | L89 | x2277 | S72 | L43 | x2311 | S72 | L89 |
| x2210 | S71 | L44 | x2244 | S71 | L90 | x2278 | S72 | L44 | x2312 | S72 | L90 |
| x2313 | S73 | L11 | x2347 | S73 | L45 | x2381 | S74 | L11 | x2415 | S74 | L45 |
| x2314 | S73 | L12 | x2348 | S73 | L46 | x2382 | S74 | L12 | x2416 | S74 | L46 |
| x2315 | S73 | L13 | x2349 | S73 | L47 | x2383 | S74 | L13 | x2417 | S74 | L47 |
| x2316 | S73 | L14 | x2350 | S73 | L48 | x2384 | S74 | L14 | x2418 | S74 | L48 |
| x2317 | S73 | L15 | x2351 | S73 | L49 | x2385 | S74 | L15 | x2419 | S74 | L49 |
| x2318 | S73 | L16 | x2352 | S73 | L51 | x2386 | S74 | L16 | x2420 | S74 | L51 |
| x2319 | S73 | L17 | x2353 | S73 | L52 | x2387 | S74 | L17 | x2421 | S74 | L52 |
| x2320 | S73 | L18 | x2354 | S73 | L53 | x2388 | S74 | L18 | x2422 | S74 | L53 |
| x2321 | S73 | L19 | x2355 | S73 | L54 | x2389 | S74 | L19 | x2423 | S74 | L54 |
| x2322 | S73 | L20 | x2356 | S73 | L55 | x2390 | S74 | L20 | x2424 | S74 | L55 |
| x2323 | S73 | L21 | x2357 | S73 | L56 | x2391 | S74 | L21 | x2425 | S74 | L56 |
| x2324 | S73 | L22 | x2358 | S73 | L57 | x2392 | S74 | L22 | x2426 | S74 | L57 |
| x2325 | S73 | L23 | x2359 | S73 | L58 | x2393 | S74 | L23 | x2427 | S74 | L58 |
| x2326 | S73 | L24 | x2360 | S73 | L59 | x2394 | S74 | L24 | x2428 | S74 | L59 |
| x2327 | S73 | L25 | x2361 | S73 | L60 | x2395 | S74 | L25 | x2429 | S74 | L60 |
| x2328 | S73 | L26 | x2362 | S73 | L61 | x2396 | S74 | L26 | x2430 | S74 | L61 |
| x2329 | S73 | L27 | x2363 | S73 | L62 | x2397 | S74 | L27 | x2431 | S74 | L62 |
| x2330 | S73 | L28 | x2364 | S73 | L63 | x2398 | S74 | L28 | x2432 | S74 | L63 |
| x2331 | S73 | L29 | x2365 | S73 | L64 | x2399 | S74 | L29 | x2433 | S74 | L64 |
| x2332 | S73 | L30 | x2366 | S73 | L65 | x2400 | S74 | L30 | x2434 | S74 | L65 |
| x2333 | S73 | L31 | x2367 | S73 | L66 | x2401 | S74 | L31 | x2435 | S74 | L66 |
| x2334 | S73 | L32 | x2368 | S73 | L67 | x2402 | S74 | L32 | x2436 | S74 | L67 |
| x2335 | S73 | L33 | x2369 | S73 | L68 | x2403 | S74 | L33 | x2437 | S74 | L68 |
| x2336 | S73 | L34 | x2370 | S73 | L69 | x2404 | S74 | L34 | x2438 | S74 | L69 |
| x2337 | S73 | L35 | x2371 | S73 | L81 | x2405 | S74 | L35 | x2439 | S74 | L81 |
| x2338 | S73 | L36 | x2372 | S73 | L82 | x2406 | S74 | L36 | x2440 | S74 | L82 |
| x2339 | S73 | L37 | x2373 | S73 | L83 | x2407 | S74 | L37 | x2441 | S74 | L83 |
| x2340 | S73 | L38 | x2374 | S73 | L84 | x2408 | S74 | L38 | x2442 | S74 | L84 |
| x2341 | S73 | L39 | x2375 | S73 | L85 | x2409 | S74 | L39 | x2443 | S74 | L85 |
| x2342 | S73 | L40 | x2376 | S73 | L86 | x2410 | S74 | L40 | x2444 | S74 | L86 |
| x2343 | S73 | L41 | x2377 | S73 | L87 | x2411 | S74 | L41 | x2445 | S74 | L87 |
| x2344 | S73 | L42 | x2378 | S73 | L88 | x2412 | S74 | L42 | x2446 | S74 | L88 |
| x2345 | S73 | L43 | x2379 | S73 | L89 | x2413 | S74 | L43 | x2447 | S74 | L89 |
| x2346 | S73 | L44 | x2380 | S73 | L90 | x2414 | S74 | L44 | x2448 | S74 | L90 |
| x2449 | S80 | L11 | x2483 | S80 | L45 | x2517 | S81 | L11 | x2551 | S81 | L45 |
| x2450 | S80 | L12 | x2484 | S80 | L46 | x2518 | S81 | L12 | x2552 | S81 | L46 |
| x2451 | S80 | L13 | x2485 | S80 | L47 | x2519 | S81 | L13 | x2553 | S81 | L47 |
| x2452 | S80 | L14 | x2486 | S80 | L48 | x2520 | S81 | L14 | x2554 | S81 | L48 |
| x2453 | S80 | L15 | x2487 | S80 | L49 | x2521 | S81 | L15 | x2555 | S81 | L49 |
| x2454 | S80 | L16 | x2488 | S80 | L51 | x2522 | S81 | L16 | x2556 | S81 | L51 |
| x2455 | S80 | L17 | x2489 | S80 | L52 | x2523 | S81 | L17 | x2557 | S81 | L52 |
| x2456 | S80 | L18 | x2490 | S80 | L53 | x2524 | S81 | L18 | x2558 | S81 | L53 |
| x2457 | S80 | L19 | x2491 | S80 | L54 | x2525 | S81 | L19 | x2559 | S81 | L54 |
| x2458 | S80 | L20 | x2492 | S80 | L55 | x2526 | S81 | L20 | x2560 | S81 | L55 |
| x2459 | S80 | L21 | x2493 | S80 | L56 | x2527 | S81 | L21 | x2561 | S81 | L56 |
| x2460 | S80 | L22 | x2494 | S80 | L57 | x2528 | S81 | L22 | x2562 | S81 | L57 |
| x2461 | S80 | L23 | x2495 | S80 | L58 | x2529 | S81 | L23 | x2563 | S81 | L58 |
| x2462 | S80 | L24 | x2496 | S80 | L59 | x2530 | S81 | L24 | x2564 | S81 | L59 |
| x2463 | S80 | L25 | x2497 | S80 | L60 | x2531 | S81 | L25 | x2565 | S81 | L60 |
| x2464 | S80 | L26 | x2498 | S80 | L61 | x2532 | S81 | L26 | x2566 | S81 | L61 |
| x2465 | S80 | L27 | x2499 | S80 | L62 | x2533 | S81 | L27 | x2567 | S81 | L62 |
| x2466 | S80 | L28 | x2500 | S80 | L63 | x2534 | S81 | L28 | x2568 | S81 | L63 |
| x2467 | S80 | L29 | x2501 | S80 | L64 | x2535 | S81 | L29 | x2569 | S81 | L64 |
| x2468 | S80 | L30 | x2502 | S80 | L65 | x2536 | S81 | L30 | x2570 | S81 | L65 |
| x2469 | S80 | L31 | x2503 | S80 | L66 | x2537 | S81 | L31 | x2571 | S81 | L66 |
| x2470 | S80 | L32 | x2504 | S80 | L67 | x2538 | S81 | L32 | x2572 | S81 | L67 |
| x2471 | S80 | L33 | x2505 | S80 | L68 | x2539 | S81 | L33 | x2573 | S81 | L68 |
| x2472 | S80 | L34 | x2506 | S80 | L69 | x2540 | S81 | L34 | x2574 | S81 | L69 |
| x2473 | S80 | L35 | x2507 | S80 | L81 | x2541 | S81 | L35 | x2575 | S81 | L81 |
| x2474 | S80 | L36 | x2508 | S80 | L82 | x2542 | S81 | L36 | x2576 | S81 | L82 |
| x2475 | S80 | L37 | x2509 | S80 | L83 | x2543 | S81 | L37 | x2577 | S81 | L83 |
| x2476 | S80 | L38 | x2510 | S80 | L84 | x2544 | S81 | L38 | x2578 | S81 | L84 |
| x2477 | S80 | L39 | x2511 | S80 | L85 | x2545 | S81 | L39 | x2579 | S81 | L85 |
| x2478 | S80 | L40 | x2512 | S80 | L86 | x2546 | S81 | L40 | x2580 | S81 | L86 |
| x2479 | S80 | L41 | x2513 | S80 | L87 | x2547 | S81 | L41 | x2581 | S81 | L87 |
| x2480 | S80 | L42 | x2514 | S80 | L88 | x2548 | S81 | L42 | x2582 | S81 | L88 |
| x2481 | S80 | L43 | x2515 | S80 | L89 | x2549 | S81 | L43 | x2583 | S81 | L89 |
| x2482 | S80 | L44 | x2516 | S80 | L90 | x2550 | S81 | L44 | x2584 | S81 | L90 |
| x2585 | S82 | L11 | x2619 | S82 | L45 | x2653 | S83 | L11 | x2687 | S83 | L45 |
| x2586 | S82 | L12 | x2620 | S82 | L46 | x2654 | S83 | L12 | x2688 | S83 | L46 |
| x2587 | S82 | L13 | x2621 | S82 | L47 | x2655 | S83 | L13 | x2689 | S83 | L47 |
| x2588 | S82 | L14 | x2622 | S82 | L48 | x2656 | S83 | L14 | x2690 | S83 | L48 |
| x2589 | S82 | L15 | x2623 | S82 | L49 | x2657 | S83 | L15 | x2691 | S83 | L49 |
| x2590 | S82 | L16 | x2624 | S82 | L51 | x2658 | S83 | L16 | x2692 | S83 | L51 |
| x2591 | S82 | L17 | x2625 | S82 | L52 | x2659 | S83 | L17 | x2693 | S83 | L52 |
| x2592 | S82 | L18 | x2626 | S82 | L53 | x2660 | S83 | L18 | x2694 | S83 | L53 |
| x2593 | S82 | L19 | x2627 | S82 | L54 | x2661 | S83 | L19 | x2695 | S83 | L54 |
| x2594 | S82 | L20 | x2628 | S82 | L55 | x2662 | S83 | L20 | x2696 | S83 | L55 |
| x2595 | S82 | L21 | x2629 | S82 | L56 | x2663 | S83 | L21 | x2697 | S83 | L56 |
| x2596 | S82 | L22 | x2630 | S82 | L57 | x2664 | S83 | L22 | x2698 | S83 | L57 |
| x2597 | S82 | L23 | x2631 | S82 | L58 | x2665 | S83 | L23 | x2699 | S83 | L58 |
| x2598 | S82 | L24 | x2632 | S82 | L59 | x2666 | S83 | L24 | x2700 | S83 | L59 |
| x2599 | S82 | L25 | x2633 | S82 | L60 | x2667 | S83 | L25 | x2701 | S83 | L60 |
| x2600 | S82 | L26 | x2634 | S82 | L61 | x2668 | S83 | L26 | x2702 | S83 | L61 |
| x2601 | S82 | L27 | x2635 | S82 | L62 | x2669 | S83 | L27 | x2703 | S83 | L62 |
| x2602 | S82 | L28 | x2636 | S82 | L63 | x2670 | S83 | L28 | x2704 | S83 | L63 |
| x2603 | S82 | L29 | x2637 | S82 | L64 | x2671 | S83 | L29 | x2705 | S83 | L64 |
| x2604 | S82 | L30 | x2638 | S82 | L65 | x2672 | S83 | L30 | x2706 | S83 | L65 |
| x2605 | S82 | L31 | x2639 | S82 | L66 | x2673 | S83 | L31 | x2707 | S83 | L66 |
| x2606 | S82 | L32 | x2640 | S82 | L67 | x2674 | S83 | L32 | x2708 | S83 | L67 |
| x2607 | S82 | L33 | x2641 | S82 | L68 | x2675 | S83 | L33 | x2709 | S83 | L68 |
| x2608 | S82 | L34 | x2642 | S82 | L69 | x2676 | S83 | L34 | x2710 | S83 | L69 |
| x2609 | S82 | L35 | x2643 | S82 | L81 | x2677 | S83 | L35 | x2711 | S83 | L81 |
| x2610 | S82 | L36 | x2644 | S82 | L82 | x2678 | S83 | L36 | x2712 | S83 | L82 |
| x2611 | S82 | L37 | x2645 | S82 | L83 | x2679 | S83 | L37 | x2713 | S83 | L83 |
| x2612 | S82 | L38 | x2646 | S82 | L84 | x2680 | S83 | L38 | x2714 | S83 | L84 |
| x2613 | S82 | L39 | x2647 | S82 | L85 | x2681 | S83 | L39 | x2715 | S83 | L85 |
| x2614 | S82 | L40 | x2648 | S82 | L86 | x2682 | S83 | L40 | x2716 | S83 | L86 |
| x2615 | S82 | L41 | x2649 | S82 | L87 | x2683 | S83 | L41 | x2717 | S83 | L87 |
| x2616 | S82 | L42 | x2650 | S82 | L88 | x2684 | S83 | L42 | x2718 | S83 | L88 |
| x2617 | S82 | L43 | x2651 | S82 | L89 | x2685 | S83 | L43 | x2719 | S83 | L89 |
| x2618 | S82 | L44 | x2652 | S82 | L90 | x2686 | S83 | L44 | x2720 | S83 | L90 |
| x2721 | S84 | L11 | x2755 | S84 | L45 | x2789 | S85 | L11 | x2823 | S85 | L45 |
| x2722 | S84 | L12 | x2756 | S84 | L46 | x2790 | S85 | L12 | x2824 | S85 | L46 |
| x2723 | S84 | L13 | x2757 | S84 | L47 | x2791 | S85 | L13 | x2825 | S85 | L47 |
| x2724 | S84 | L14 | x2758 | S84 | L48 | x2792 | S85 | L14 | x2826 | S85 | L48 |
| x2725 | S84 | L15 | x2759 | S84 | L49 | x2793 | S85 | L15 | x2827 | S85 | L49 |
| x2726 | S84 | L16 | x2760 | S84 | L51 | x2794 | S85 | L16 | x2828 | S85 | L51 |
| x2727 | S84 | L17 | x2761 | S84 | L52 | x2795 | S85 | L17 | x2829 | S85 | L52 |
| x2728 | S84 | L18 | x2762 | S84 | L53 | x2796 | S85 | L18 | x2830 | S85 | L53 |
| x2729 | S84 | L19 | x2763 | S84 | L54 | x2797 | S85 | L19 | x2831 | S85 | L54 |
| x2730 | S84 | L20 | x2764 | S84 | L55 | x2798 | S85 | L20 | x2832 | S85 | L55 |
| x2731 | S84 | L21 | x2765 | S84 | L56 | x2799 | S85 | L21 | x2833 | S85 | L56 |
| x2732 | S84 | L22 | x2766 | S84 | L57 | x2800 | S85 | L22 | x2834 | S85 | L57 |
| x2733 | S84 | L23 | x2767 | S84 | L58 | x2801 | S85 | L23 | x2835 | S85 | L58 |
| x2734 | S84 | L24 | x2768 | S84 | L59 | x2802 | S85 | L24 | x2836 | S85 | L59 |
| x2735 | S84 | L25 | x2769 | S84 | L60 | x2803 | S85 | L25 | x2837 | S85 | L60 |
| x2736 | S84 | L26 | x2770 | S84 | L61 | x2804 | S85 | L26 | x2838 | S85 | L61 |
| x2737 | S84 | L27 | x2771 | S84 | L62 | x2805 | S85 | L27 | x2839 | S85 | L62 |
| x2738 | S84 | L28 | x2772 | S84 | L63 | x2806 | S85 | L28 | x2840 | S85 | L63 |
| x2739 | S84 | L29 | x2773 | S84 | L64 | x2807 | S85 | L29 | x2841 | S85 | L64 |
| x2740 | S84 | L30 | x2774 | S84 | L65 | x2808 | S85 | L30 | x2842 | S85 | L65 |
| x2741 | S84 | L31 | x2775 | S84 | L66 | x2809 | S85 | L31 | x2843 | S85 | L66 |
| x2742 | S84 | L32 | x2776 | S84 | L67 | x2810 | S85 | L32 | x2844 | S85 | L67 |
| x2743 | S84 | L33 | x2777 | S84 | L68 | x2811 | S85 | L33 | x2845 | S85 | L68 |
| x2744 | S84 | L34 | x2778 | S84 | L69 | x2812 | S85 | L34 | x2846 | S85 | L69 |
| x2745 | S84 | L35 | x2779 | S84 | L81 | x2813 | S85 | L35 | x2847 | S85 | L81 |
| x2746 | S84 | L36 | x2780 | S84 | L82 | x2814 | S85 | L36 | x2848 | S85 | L82 |
| x2747 | S84 | L37 | x2781 | S84 | L83 | x2815 | S85 | L37 | x2849 | S85 | L83 |
| x2748 | S84 | L38 | x2782 | S84 | L84 | x2816 | S85 | L38 | x2850 | S85 | L84 |
| x2749 | S84 | L39 | x2783 | S84 | L85 | x2817 | S85 | L39 | x2851 | S85 | L85 |
| x2750 | S84 | L40 | x2784 | S84 | L86 | x2818 | S85 | L40 | x2852 | S85 | L86 |
| x2751 | S84 | L41 | x2785 | S84 | L87 | x2819 | S85 | L41 | x2853 | S85 | L87 |
| x2752 | S84 | L42 | x2786 | S84 | L88 | x2820 | S85 | L42 | x2854 | S85 | L88 |
| x2753 | S84 | L43 | x2787 | S84 | L89 | x2821 | S85 | L43 | x2855 | S85 | L89 |
| x2754 | S84 | L44 | x2788 | S84 | L90 | x2822 | S85 | L44 | x2856 | S85 | L90 |
| x2857 | S86 | L11 | x2891 | S86 | L45 | x2925 | S87 | L11 | x2959 | S87 | L45 |
| x2858 | S86 | L12 | x2892 | S86 | L46 | x2926 | S87 | L12 | x2960 | S87 | L46 |
| x2859 | S86 | L13 | x2893 | S86 | L47 | x2927 | S87 | L13 | x2961 | S87 | L47 |
| x2860 | S86 | L14 | x2894 | S86 | L48 | x2928 | S87 | L14 | x2962 | S87 | L48 |
| x2861 | S86 | L15 | x2895 | S86 | L49 | x2929 | S87 | L15 | x2963 | S87 | L49 |
| x2862 | S86 | L16 | x2896 | S86 | L51 | x2930 | S87 | L16 | x2964 | S87 | L51 |
| x2863 | S86 | L17 | x2897 | S86 | L52 | x2931 | S87 | L17 | x2965 | S87 | L52 |
| x2864 | S86 | L18 | x2898 | S86 | L53 | x2932 | S87 | L18 | x2966 | S87 | L53 |
| x2865 | S86 | L19 | x2899 | S86 | L54 | x2933 | S87 | L19 | x2967 | S87 | L54 |
| x2866 | S86 | L20 | x2900 | S86 | L55 | x2934 | S87 | L20 | x2968 | S87 | L55 |
| x2867 | S86 | L21 | x2901 | S86 | L56 | x2935 | S87 | L21 | x2969 | S87 | L56 |
| x2868 | S86 | L22 | x2902 | S86 | L57 | x2936 | S87 | L22 | x2970 | S87 | L57 |
| x2869 | S86 | L23 | x2903 | S86 | L58 | x2937 | S87 | L23 | x2971 | S87 | L58 |
| x2870 | S86 | L24 | x2904 | S86 | L59 | x2938 | S87 | L24 | x2972 | S87 | L59 |
| x2871 | S86 | L25 | x2905 | S86 | L60 | x2939 | S87 | L25 | x2973 | S87 | L60 |
| x2872 | S86 | L26 | x2906 | S86 | L61 | x2940 | S87 | L26 | x2974 | S87 | L61 |
| x2873 | S86 | L27 | x2907 | S86 | L62 | x2941 | S87 | L27 | x2975 | S87 | L62 |
| x2874 | S86 | L28 | x2908 | S86 | L63 | x2942 | S87 | L28 | x2976 | S87 | L63 |
| x2875 | S86 | L29 | x2909 | S86 | L64 | x2943 | S87 | L29 | x2977 | S87 | L64 |
| x2876 | S86 | L30 | x2910 | S86 | L65 | x2944 | S87 | L30 | x2978 | S87 | L65 |
| x2877 | S86 | L31 | x2911 | S86 | L66 | x2945 | S87 | L31 | x2979 | S87 | L66 |
| x2878 | S86 | L32 | x2912 | S86 | L67 | x2946 | S87 | L32 | x2980 | S87 | L67 |
| x2879 | S86 | L33 | x2913 | S86 | L68 | x2947 | S87 | L33 | x2981 | S87 | L68 |
| x2880 | S86 | L34 | x2914 | S86 | L69 | x2948 | S87 | L34 | x2982 | S87 | L69 |
| x2881 | S86 | L35 | x2915 | S86 | L81 | x2949 | S87 | L35 | x2983 | S87 | L81 |
| x2882 | S86 | L36 | x2916 | S86 | L82 | x2950 | S87 | L36 | x2984 | S87 | L82 |
| x2883 | S86 | L37 | x2917 | S86 | L83 | x2951 | S87 | L37 | x2985 | S87 | L83 |
| x2884 | S86 | L38 | x2918 | S86 | L84 | x2952 | S87 | L38 | x2986 | S87 | L84 |
| x2885 | S86 | L39 | x2919 | S86 | L85 | x2953 | S87 | L39 | x2987 | S87 | L85 |
| x2886 | S86 | L40 | x2920 | S86 | L86 | x2954 | S87 | L40 | x2988 | S87 | L86 |
| x2887 | S86 | L41 | x2921 | S86 | L87 | x2955 | S87 | L41 | x2989 | S87 | L87 |
| x2888 | S86 | L42 | x2922 | S86 | L88 | x2956 | S87 | L42 | x2990 | S87 | L88 |
| x2889 | S86 | L43 | x2923 | S86 | L89 | x2957 | S87 | L43 | x2991 | S87 | L89 |
| x2890 | S86 | L44 | x2924 | S86 | L90 | x2958 | S87 | L44 | x2992 | S87 | L90 |
| x2993 | S90 | L11 | x3027 | S90 | L45 | x3061 | S61 | L11 | x3095 | S61 | L45 |
| x2994 | S90 | L12 | x3028 | S90 | L46 | x3062 | S61 | L12 | x3096 | S61 | L46 |
| x2995 | S90 | L13 | x3029 | S90 | L47 | x3063 | S61 | L13 | x3097 | S61 | L47 |
| x2996 | S90 | L14 | x3030 | S90 | L48 | x3064 | S61 | L14 | x3098 | S61 | L48 |
| x2997 | S90 | L15 | x3031 | S90 | L49 | x3065 | S61 | L15 | x3099 | S61 | L49 |
| x2998 | S90 | L16 | x3032 | S90 | L51 | x3066 | S61 | L16 | x3100 | S61 | L51 |
| x2999 | S90 | L17 | x3033 | S90 | L52 | x3067 | S61 | L17 | x3101 | S61 | L52 |
| x3000 | S90 | L18 | x3034 | S90 | L53 | x3068 | S61 | L18 | x3102 | S61 | L53 |
| x3001 | S90 | L19 | x3035 | S90 | L54 | x3069 | S61 | L19 | x3103 | S61 | L54 |
| x3002 | S90 | L20 | x3036 | S90 | L55 | x3070 | S61 | L20 | x3104 | S61 | L55 |
| x3003 | S90 | L21 | x3037 | S90 | L56 | x3071 | S61 | L21 | x3105 | S61 | L56 |
| x3004 | S90 | L22 | x3038 | S90 | L57 | x3072 | S61 | L22 | x3106 | S61 | L57 |
| x3005 | S90 | L23 | x3039 | S90 | L58 | x3073 | S61 | L23 | x3107 | S61 | L58 |
| x3006 | S90 | L24 | x3040 | S90 | L59 | x3074 | S61 | L24 | x3108 | S61 | L59 |
| x3007 | S90 | L25 | x3041 | S90 | L60 | x3075 | S61 | L25 | x3109 | S61 | L60 |
| x3008 | S90 | L26 | x3042 | S90 | L61 | x3076 | S61 | L26 | x3110 | S61 | L61 |
| x3009 | S90 | L27 | x3043 | S90 | L62 | x3077 | S61 | L27 | x3111 | S61 | L62 |
| x3010 | S90 | L28 | x3044 | S90 | L63 | x3078 | S61 | L28 | x3112 | S61 | L63 |
| x3011 | S90 | L29 | x3045 | S90 | L64 | x3079 | S61 | L29 | x3113 | S61 | L64 |
| x3012 | S90 | L30 | x3046 | S90 | L65 | x3080 | S61 | L30 | x3114 | S61 | L65 |
| x3013 | S90 | L31 | x3047 | S90 | L66 | x3081 | S61 | L31 | x3115 | S61 | L66 |
| x3014 | S90 | L32 | x3048 | S90 | L67 | x3082 | S61 | L32 | x3116 | S61 | L67 |
| x3015 | S90 | L33 | x3049 | S90 | L68 | x3083 | S61 | L33 | x3117 | S61 | L68 |
| x3016 | S90 | L34 | x3050 | S90 | L69 | x3084 | S61 | L34 | x3118 | S61 | L69 |
| x3017 | S90 | L35 | x3051 | S90 | L81 | x3085 | S61 | L35 | x3119 | S61 | L81 |
| x3018 | S90 | L36 | x3052 | S90 | L82 | x3086 | S61 | L36 | x3120 | S61 | L82 |
| x3019 | S90 | L37 | x3053 | S90 | L83 | x3087 | S61 | L37 | x3121 | S61 | L83 |
| x3020 | S90 | L38 | x3054 | S90 | L84 | x3088 | S61 | L38 | x3122 | S61 | L84 |
| x3021 | S90 | L39 | x3055 | S90 | L85 | x3089 | S61 | L39 | x3123 | S61 | L85 |
| x3022 | S90 | L40 | x3056 | S90 | L86 | x3090 | S61 | L40 | x3124 | S61 | L86 |
| x3023 | S90 | L41 | x3057 | S90 | L87 | x3091 | S61 | L41 | x3125 | S61 | L87 |
| x3024 | S90 | L42 | x3058 | S90 | L88 | x3092 | S61 | L42 | x3126 | S61 | L88 |
| x3025 | S90 | L43 | x3059 | S90 | L89 | x3093 | S61 | L43 | x3127 | S61 | L89 |
| x3026 | S90 | L44 | x3060 | S90 | L90 | x3094 | S61 | L44 | x3128 | S61 | L90 |
| x3129 | S10 | L91 | x3163 | S72 | L91 | x3197 | S52 | L92 | x3231 | S30 | L7 |
| x3130 | S11 | L91 | x3164 | S73 | L91 | x3198 | S53 | L92 | x3232 | S31 | L7 |
| x3131 | S12 | L91 | x3165 | S74 | L91 | x3199 | S54 | L92 | x3233 | S32 | L7 |
| x3132 | S13 | L91 | x3166 | S80 | L91 | x3200 | S55 | L92 | x3234 | S33 | L7 |
| x3133 | S20 | L91 | x3167 | S81 | L91 | x3201 | S60 | L92 | x3235 | S34 | L7 |
| x3134 | S21 | L91 | x3168 | S82 | L91 | x3202 | S61 | L92 | x3236 | S35 | L7 |
| x3135 | S22 | L91 | x3169 | S83 | L91 | x3203 | S62 | L92 | x3237 | S40 | L7 |
| x3136 | S23 | L91 | x3170 | S84 | L91 | x3204 | S63 | L92 | x3238 | S41 | L7 |
| x3137 | S24 | L91 | x3171 | S85 | L91 | x3205 | S64 | L92 | x3239 | S42 | L7 |
| x3138 | S25 | L91 | x3172 | S86 | L91 | x3206 | S65 | L92 | x3240 | S43 | L7 |
| x3139 | S30 | L91 | x3173 | S87 | L91 | x3207 | S70 | L92 | x3241 | S50 | L7 |
| x3140 | S31 | L91 | x3174 | S90 | L91 | x3208 | S71 | L92 | x3242 | S51 | L7 |
| x3141 | S32 | L91 | x3175 | S10 | L92 | x3209 | S72 | L92 | x3243 | S52 | L7 |
| x3142 | S33 | L91 | x3176 | S11 | L92 | x3210 | S73 | L92 | x3244 | S53 | L7 |
| x3143 | S34 | L91 | x3177 | S12 | L92 | x3211 | S74 | L92 | x3245 | S54 | L7 |
| x3144 | S35 | L91 | x3178 | S13 | L92 | x3212 | S80 | L92 | x3246 | S55 | L7 |
| x3145 | S40 | L91 | x3179 | S20 | L92 | x3213 | S81 | L92 | x3247 | S60 | L7 |
| x3146 | S41 | L91 | x3180 | S21 | L92 | x3214 | S82 | L92 | x3248 | S61 | L7 |
| x3147 | S42 | L91 | x3181 | S22 | L92 | x3215 | S83 | L92 | x3249 | S62 | L7 |
| x3148 | S43 | L91 | x3182 | S23 | L92 | x3216 | S84 | L92 | x3250 | S63 | L7 |
| x3149 | S50 | L91 | x3183 | S24 | L92 | x3217 | S85 | L92 | x3251 | S64 | L7 |
| x3150 | S51 | L91 | x3184 | S25 | L92 | x3218 | S86 | L92 | x3252 | S65 | L7 |
| x3151 | S52 | L91 | x3185 | S30 | L92 | x3219 | S87 | L92 | x3253 | S70 | L7 |
| x3152 | S53 | L91 | x3186 | S31 | L92 | x3220 | S90 | L92 | x3254 | S71 | L7 |
| x3153 | S54 | L91 | x3187 | S32 | L92 | x3221 | S10 | L7 | | | |
| x3154 | S55 | L91 | x3188 | S33 | L92 | x3222 | S11 | L7 | | | |
| x3155 | S60 | L91 | x3189 | S34 | L92 | x3223 | S12 | L7 | | | |
| x3156 | S61 | L91 | x3190 | S35 | L92 | x3224 | S13 | L7 | | | |
| x3157 | S62 | L91 | x3191 | S40 | L92 | x3225 | S20 | L7 | | | |
| x3158 | S63 | L91 | x3192 | S41 | L92 | x3226 | S21 | L7 | | | |
| x3159 | S64 | L91 | x3193 | S42 | L92 | x3227 | S22 | L7 | | | |
| x3160 | S65 | L91 | x3194 | S43 | L92 | x3228 | S23 | L7 | | | |
| x3161 | S70 | L91 | x3195 | S50 | L92 | x3229 | S24 | L7 | | | |
| x3162 | S71 | L91 | x3196 | S51 | L92 | x3230 | S25 | L7 | | | |
| x3255 | S10 | L93 | x3289 | S72 | L93 | x3323 | S52 | L94 | x3357 | S30 | L95 |
| x3256 | S11 | L93 | x3290 | S73 | L93 | x3324 | S53 | L94 | x3358 | S31 | L95 |
| x3257 | S12 | L93 | x3291 | S74 | L93 | x3325 | S54 | L94 | x3359 | S32 | L95 |
| x3258 | S13 | L93 | x3292 | S80 | L93 | x3326 | S55 | L94 | x3360 | S33 | L95 |
| x3259 | S20 | L93 | x3293 | S81 | L93 | x3327 | S60 | L94 | x3361 | S34 | L95 |
| x3260 | S21 | L93 | x3294 | S82 | L93 | x3328 | S61 | L94 | x3362 | S35 | L95 |
| x3261 | S22 | L93 | x3295 | S83 | L93 | x3329 | S62 | L94 | x3363 | S40 | L95 |
| x3262 | S23 | L93 | x3296 | S84 | L93 | x3330 | S63 | L94 | x3364 | S41 | L95 |
| x3263 | S24 | L93 | x3297 | S85 | L93 | x3331 | S64 | L94 | x3365 | S42 | L95 |
| x3264 | S25 | L93 | x3298 | S86 | L93 | x3332 | S65 | L94 | x3366 | S43 | L95 |
| x3265 | S30 | L93 | x3299 | S87 | L93 | x3333 | S70 | L94 | x3367 | S50 | L95 |
| x3266 | S31 | L93 | x3300 | S90 | L93 | x3334 | S71 | L94 | x3368 | S51 | L95 |
| x3267 | S32 | L93 | x3301 | S10 | L94 | x3335 | S72 | L94 | x3369 | S52 | L95 |
| x3268 | S33 | L93 | x3302 | S11 | L94 | x3336 | S73 | L94 | x3370 | S53 | L95 |
| x3269 | S34 | L93 | x3303 | S12 | L94 | x3337 | S74 | L94 | x3371 | S54 | L95 |
| x3270 | S35 | L93 | x3304 | S13 | L94 | x3338 | S80 | L94 | x3372 | S55 | L95 |
| x3271 | S40 | L93 | x3305 | S20 | L94 | x3339 | S81 | L94 | x3373 | S60 | L95 |
| x3272 | S41 | L93 | x3306 | S21 | L94 | x3340 | S82 | L94 | x3374 | S61 | L95 |
| x3273 | S42 | L93 | x3307 | S22 | L94 | x3341 | S83 | L94 | x3375 | S62 | L95 |
| x3274 | S43 | L93 | x3308 | S23 | L94 | x3342 | S84 | L94 | x3376 | S63 | L95 |
| x3275 | S50 | L93 | x3309 | S24 | L94 | x3343 | S85 | L94 | x3377 | S64 | L95 |
| x3276 | S51 | L93 | x3310 | S25 | L94 | x3344 | S86 | L94 | x3378 | S65 | L95 |
| x3277 | S52 | L93 | x3311 | S30 | L94 | x3345 | S87 | L94 | x3379 | S70 | L95 |
| x3278 | S53 | L93 | x3312 | S31 | L94 | x3346 | S90 | L94 | x3380 | S71 | L95 |
| x3279 | S54 | L93 | x3313 | S32 | L94 | x3347 | S10 | L95 | x3381 | S72 | L95 |
| x3280 | S55 | L93 | x3314 | S33 | L94 | x3348 | S11 | L95 | x3382 | S73 | L95 |
| x3281 | S60 | L93 | x3315 | S34 | L94 | x3349 | S12 | L95 | x3383 | S74 | L95 |
| x3282 | S61 | L93 | x3316 | S35 | L94 | x3350 | S13 | L95 | x3384 | S80 | L95 |
| x3283 | S62 | L93 | x3317 | S40 | L94 | x3351 | S20 | L95 | x3385 | S81 | L95 |
| x3284 | S63 | L93 | x3318 | S41 | L94 | x3352 | S21 | L95 | x3386 | S82 | L95 |
| x3285 | S64 | L93 | x3319 | S42 | L94 | x3353 | S22 | L95 | x3387 | S83 | L95 |
| x3286 | S65 | L93 | x3320 | S43 | L94 | x3354 | S23 | L95 | x3388 | S84 | L95 |
| x3287 | S70 | L93 | x3321 | S50 | L94 | x3355 | S24 | L95 | x3389 | S85 | L95 |
| x3288 | S71 | L93 | x3322 | S51 | L94 | x3356 | S25 | L95 | x3390 | S86 | L95 |
| x3391 | S10 | L96 | x3425 | S72 | L96 | x3459 | S52 | L97 | x3493 | S30 | L98 |
| x3392 | S11 | L96 | x3426 | S73 | L96 | x3460 | S53 | L97 | x3494 | S31 | L98 |
| x3393 | S12 | L96 | x3427 | S74 | L96 | x3461 | S54 | L97 | x3495 | S32 | L98 |
| x3394 | S13 | L96 | x3428 | S80 | L96 | x3462 | S55 | L97 | x3496 | S33 | L98 |
| x3395 | S20 | L96 | x3429 | S81 | L96 | x3463 | S60 | L97 | x3497 | S34 | L98 |
| x3396 | S21 | L96 | x3430 | S82 | L96 | x3464 | S61 | L97 | x3498 | S35 | L98 |
| x3397 | S22 | L96 | x3431 | S83 | L96 | x3465 | S62 | L97 | x3499 | S40 | L98 |
| x3398 | S23 | L96 | x3432 | S84 | L96 | x3466 | S63 | L97 | x3500 | S41 | L98 |
| x3399 | S24 | L96 | x3433 | S85 | L96 | x3467 | S64 | L97 | x3501 | S42 | L98 |
| x3400 | S25 | L96 | x3434 | S86 | L96 | x3468 | S65 | L97 | x3502 | S43 | L98 |
| x3401 | S30 | L96 | x3435 | S87 | L96 | x3469 | S70 | L97 | x3503 | S50 | L98 |
| x3402 | S31 | L96 | x3436 | S90 | L96 | x3470 | S71 | L97 | x3504 | S51 | L98 |
| x3403 | S32 | L96 | x3437 | S10 | L97 | x3471 | S72 | L97 | x3505 | S52 | L98 |
| x3404 | S33 | L96 | x3438 | S11 | L97 | x3472 | S73 | L97 | x3506 | S53 | L98 |
| x3405 | S34 | L96 | x3439 | S12 | L97 | x3473 | S74 | L97 | x3507 | S54 | L98 |
| x3406 | S35 | L96 | x3440 | S13 | L97 | x3474 | S80 | L97 | x3508 | S55 | L98 |
| x3407 | S40 | L96 | x3441 | S20 | L97 | x3475 | S81 | L97 | x3509 | S60 | L98 |
| x3408 | S41 | L96 | x3442 | S21 | L97 | x3476 | S82 | L97 | x3510 | S61 | L98 |
| x3409 | S42 | L96 | x3443 | S22 | L97 | x3477 | S83 | L97 | x3511 | S62 | L98 |
| x3410 | S43 | L96 | x3444 | S23 | L97 | x3478 | S84 | L97 | x3512 | S63 | L98 |
| x3411 | S50 | L96 | x3445 | S24 | L97 | x3479 | S85 | L97 | x3513 | S64 | L98 |
| x3412 | S51 | L96 | x3446 | S25 | L97 | x3480 | S86 | L97 | x3514 | S65 | L98 |
| x3413 | S52 | L96 | x3447 | S30 | L97 | x3481 | S87 | L97 | x3515 | S70 | L98 |
| x3414 | S53 | L96 | x3448 | S31 | L97 | x3482 | S90 | L97 | x3516 | S71 | L98 |
| x3415 | S54 | L96 | x3449 | S32 | L97 | x3483 | S10 | L98 | x3517 | S72 | L98 |
| x3416 | S55 | L96 | x3450 | S33 | L97 | x3484 | S11 | L98 | x3518 | S73 | L98 |
| x3417 | S60 | L96 | x3451 | S34 | L97 | x3485 | S12 | L98 | x3519 | S74 | L98 |
| x3418 | S61 | L96 | x3452 | S35 | L97 | x3486 | S13 | L98 | x3520 | S80 | L98 |
| x3419 | S62 | L96 | x3453 | S40 | L97 | x3487 | S20 | L98 | x3521 | S81 | L98 |
| x3420 | S63 | L96 | x3454 | S41 | L97 | x3488 | S21 | L98 | x3522 | S82 | L98 |
| x3421 | S64 | L96 | x3455 | S42 | L97 | x3489 | S22 | L98 | x3523 | S83 | L98 |
| x3422 | S65 | L96 | x3456 | S43 | L97 | x3490 | S23 | L98 | x3524 | S84 | L98 |
| x3423 | S70 | L96 | x3457 | S50 | L97 | x3491 | S24 | L98 | x3525 | S85 | L98 |
| x3424 | S71 | L96 | x3458 | S51 | L97 | x3492 | S25 | L98 | x3526 | S86 | L98 |
| x3527 | S10 | L99 | x3561 | S72 | L99 | x3595 | S52 | L71 | x3629 | S83 | L7 |
| x3528 | S11 | L99 | x3562 | S73 | L99 | x3596 | S53 | L71 | x3630 | S84 | L7 |
| x3529 | S12 | L99 | x3563 | S74 | L99 | x3597 | S54 | L71 | x3631 | S85 | L7 |
| x3530 | S13 | L99 | x3564 | S80 | L99 | x3598 | S55 | L71 | x3632 | S86 | L7 |
| x3531 | S20 | L99 | x3565 | S81 | L99 | x3599 | S60 | L71 | x3633 | S87 | L7 |
| x3532 | S21 | L99 | x3566 | S82 | L99 | x3600 | S61 | L71 | x3634 | S90 | L7 |
| x3533 | S22 | L99 | x3567 | S83 | L99 | x3601 | S62 | L71 | | | |
| x3534 | S23 | L99 | x3568 | S84 | L99 | x3602 | S63 | L71 | | | |
| x3535 | S24 | L99 | x3569 | S85 | L99 | x3603 | S64 | L71 | | | |
| x3536 | S25 | L99 | x3570 | S86 | L99 | x3604 | S65 | L71 | | | |
| x3537 | S30 | L99 | x3571 | S87 | L99 | x3605 | S70 | L71 | | | |
| x3538 | S31 | L99 | x3572 | S90 | L99 | x3606 | S71 | L71 | | | |
| x3539 | S32 | L99 | x3573 | S10 | L71 | x3607 | S72 | L71 | | | |
| x3540 | S33 | L99 | x3574 | S11 | L71 | x3608 | S73 | L71 | | | |
| x3541 | S34 | L99 | x3575 | S12 | L71 | x3609 | S74 | L71 | | | |
| x3542 | S35 | L99 | x3576 | S13 | L71 | x3610 | S80 | L71 | | | |
| x3543 | S40 | L99 | x3577 | S20 | L71 | x3611 | S81 | L71 | | | |
| x3544 | S41 | L99 | x3578 | S21 | L71 | x3612 | S82 | L71 | | | |
| x3545 | S42 | L99 | x3579 | S22 | L71 | x3613 | S83 | L71 | | | |
| x3546 | S43 | L99 | x3580 | S23 | L71 | x3614 | S84 | L71 | | | |
| x3547 | S50 | L99 | x3581 | S24 | L71 | x3615 | S85 | L71 | | | |
| x3548 | S51 | L99 | x3582 | S25 | L71 | x3616 | S86 | L71 | | | |
| x3549 | S52 | L99 | x3583 | S30 | L71 | x3617 | S87 | L71 | | | |
| x3550 | S53 | L99 | x3584 | S31 | L71 | x3618 | S90 | L71 | | | |
| x3551 | S54 | L99 | x3585 | S32 | L71 | x3619 | S87 | L95 | | | |
| x3552 | S55 | L99 | x3586 | S33 | L71 | x3620 | S90 | L95 | | | |
| x3553 | S60 | L99 | x3587 | S34 | L71 | x3621 | S87 | L98 | | | |
| x3554 | S61 | L99 | x3588 | S35 | L71 | x3622 | S90 | L98 | | | |
| x3555 | S62 | L99 | x3589 | S40 | L71 | x3623 | S72 | L7 | | | |
| x3556 | S63 | L99 | x3590 | S41 | L71 | x3624 | S73 | L7 | | | |
| x3557 | S64 | L99 | x3591 | S42 | L71 | x3625 | S74 | L7 | | | |
| x3558 | S65 | L99 | x3592 | S43 | L71 | x3626 | S80 | L7 | | | |
| x3559 | S70 | L99 | x3593 | S50 | L71 | x3627 | S81 | L7 | | | |
| x3560 | S71 | L99 | x3594 | S51 | L71 | x3628 | S82 | L7 | | | |

Each row of Table 2 is identical to each row of table 1, but “x#” stands here in Table 2 for the serial number of the method for conducting the combined application.
For example, x2992 denotes a method for conducting the combined application of S87, which stands for the SAP (S87) as defined above, and L90, which stands for the biopesticide (L90) as defined above, in agriculture, preferably for improving soil quality, enhancing plant growth, for the control of harmful fungi or insects, soil treatment or seed treatment, most preferably for improving soil quality and enhancing plant growth.

1.-15. (canceled)

16. A mixture or a kit-of-parts comprising:
1) at least one superabsorbent polymer (S) selected from the groups (S10), (S20), (S30), (S40), (S50), (S60), (S70), (S80), and (S90):
(S10) Peptide/protein-based SAP selected from the groups (S11), (S12), and (S13):
(S11) Naturally occurring peptide/protein-based SAP: elastin, collagen, Gelatin A, Gelatin B, silk fibroin, globular proteins, beta-lactoglobulin, bovine serum albumin, ovalbumin;
(S12) Semi-synthetic or fully-synthetic peptide/protein-based SAP: collagen-based synthetic hydrogels, elastin-like polypeptides, silk-elastin-like polypeptides, hydrogels based on a coiled coil motif, triblock polypeptides, polyaspartic acid, polyaspartates, polyglutamic acid, polyglutamates;
(S13) Peptide/protein-based SAP other than those listed in (S11) or (S12);
(S20) Polysaccharide selected from the groups (S21), (S22), (S23), (S24), and (S25):
(S21) Naturally occurring polysaccharide: agar, alginate, beta-glucan, carrageenan, cellulose, micro-/nanofibrillar cellulose, chitin, dextran, galactomannan, glucomannan, guar gum, gum arabic, hyaluronan, pectin starch, starch, starch derivatives, xanthan;
(S22) Semi-synthetic or fully-synthetic polysaccharide: carboxymethyl starch (CMS), sulfoethyl starch (SES), carboxymethyl cellulose (CMC), sulfoethyl cellulose (SEC), hydroxypropyl cellulose, hydroxyethyl cellulose, methylcellulose, chitosan;
(S23) Cross-linked polysaccharide: CMS cross-linked with multi-functional carboxylic acids (MFC) or multi-functional epoxides (MFE), SES cross-linked with MFC or MFE, CMC cross-linked with MFC or MFE, SEC cross-linked with MFC or MFE, hydroxypropyl cellulose cross-linked with MFC or MFE, hydroxyethyl cellulose cross-linked with MFC or MFE, methylcellulose cross-linked with MFC or MFE, chitosan cross-linked with MFC or MFE;
(S24) Polysaccharide graft copolymer: Polysaccharides obtained by graft polymerizing a monomer onto a polysaccharide, wherein the monomer is selected from acrylonitrile, acrylic acid, methacrylic acid, acrylamide, methacrylamide, 2-acrylamido-2-methyl-propanesulfonic acid (AMPS), vinyl sulfonic acid, ethyl acrylate, and potassium acrylate;
(S25) Polysaccharide other than those listed in (S21), (S22), (S23) or (S24);
(S30) Polymer containing one or more unsaturated carboxylic acid, or its salts thereof, as monomeric units, selected from the groups (S31), (S32), (S33), (S34), and (S35):
(S31) Polymer containing acrylic acid, or its salts thereof, as monomeric units;
(S32) Polymer containing methacrylic acid, or its salts thereof, as monomeric units;
(S33) Polymer containing as monomeric units at least one of the unsaturated carboxylic acids—or salts thereof—selected from: crotonic acid, isocrotonic acid, 2′-methylisocrotonic acid, maleic acid, fumaric acid, vinyl acetic acid, ethacrylic acid, alpha-chloroacrylic acid, alpha-cyanoacrylic acid, alpha-phenylacrylic acid, beta-acryloxypropionic acid, sorbinic acid, alpha-chlorosorbinic acid, cinnamic acid, p-chlorocinnamic acid, beta-stearic acid, itaconic acid, citraconic acid, mesaconic acid, glutaconic acid, aconitic acid, tricarboxy ethylene, and maleic acid anhydride;
(S34) Polymer containing as monomeric units at least one of the unsaturated carboxylic acids—or salts thereof—selected from: terephthalic acid, dimethyl terephthalate, phthalic acid, isophthalic acid, naphthalene dicarboxylic acid, 4-hydroxybenzoic acid, 6-hydroxynaphthalene-2-carboxylic acid:
(S35) Polymer containing as monomeric units one or more unsaturated carboxylic acid—or salts thereof—which are not listed in (S31), (S32), (S33), or (S34);
(S40) Polymer containing one or more unsaturated sulfonic acid, or one or more unsaturated phosphonic acid, or its salts thereof, as monomeric units, selected from the groups (S41), (S42), and (S43):
(S41) Polymer containing as monomeric units at least one of the unsaturated sulfonic acids—or salts thereof—selected from: 2-acrylamido-2-methyl-1-propanesulfonic acid (AMPS), methallyl sulfonic acid, allyl sulfonic acid, acrylic sulfonic acid, methacrylic sulfonic acid, vinyl sulfonic acid, 4-vinylbenzylsulfonic acid, vinyltoluenesulfonic acid, styrenesulfonic acid, sulfoethyl(meth)acrylate, sulfopropyl(meth)acrylate, and 2-hydroxy-3-methacryloxypropylsulfonic acid;
(S42) Polymer containing as monomeric units at least one of the unsaturated phosphonic acids—or salts thereof—selected from: vinylphosphonic acid, allylphosphonic acid, vinylbenzylphosphonic acid, (meth)acrylamidoalkylphosphonic acids, acrylamidoalkyldiphosphonic acids, phosphonomethylated vinylamines and (meth)acrylphosphonic acid derivatives;
(S43) Polymer containing as monomeric units one or more unsaturated sulfonic acids not listed in (S41) or one or more unsaturated phosphonic acids not listed in (S42);
(S50) Polymer containing one or more amines or amides as monomeric units, selected from the groups (S51), (S52), (S53), (S54) and (S55):
(S51) Polymer containing acrylamide or methacrylamide as monomeric units;
(S52) Polymer containing as monomeric units at least one of the unsaturated amides selected from; N-methylol(meth)acrylamide, N, N-dimethylamino(meth)acrylamide, dimethyl(meth)acrylamide, diethyl(meth)acrylamide, N-vinylamides, N-vinylformamides, N-vinylacetamides, N-vinyl-N-methylacetamide, N-vinyl-N-methylformamides, vinylpyrrolidone;
(S53) Polymer containing as monomeric units one or more amides not listed in (S51) or (S52);
(S54) Polymer containing as monomeric units at least one primary amine, secondary amine, tertiary amine, or quarternary ammonium salt;
(S55) Polyamidoamines;
(S60) Polymer containing optionally cross-linked polyethers or polyols, selected from the groups (S61), (S62), (S63), (S64), and (S65):
(S61) Polymer containing optionally cross-linked polyethylene glycol (PEG);
(S62) Polymer containing optionally cross-linked polypropylene glycol (PPG) or poly(oxyethylene-oxypropylene) copolymer;
(S63) Polymer containing at least one optionally cross-linked polyether selected from: polyoxymethylene, poly(tetrahydrofuran), polyphenyl ether (PPE), and poly(p-phenylene oxide) (PPO);
(S64) Polymer containing optionally cross-linked polyvinyl alcohol;
(S65) Polymer containing optionally cross-linked polyethers or polyols not listed in (S61), (S62), (S63) or (S64);
(S70) Polymer selected from the groups (S71), (S72), (S73), and (S74):
(S71) Polymer containing monoethylenically unsaturated acidic group-containing monomers S70A and monoethylenically unsaturated monomers S70B which are cross-linked with at least one cross-linker S71C selected from: alkenyldi(meth)acrylates, ethyleneglycoldi(meth)acrylate, 1,3-propyleneglycoldi(meth)acrylate, 1,4-butyleneglycoldi(meth)acrylate, 1,3-butyleneglycoldi(meth)acrylate, 1,6-hexanedioldi(meth)acrylate, 1,10-decanedioldi(meth)acrylate, 1,12-dodecanedioldi(meth)acrylate, 1,18-octadecanedioldi(meth)acrylate, cyclopentanedioldi(meth)acrylate, neopentylglycoldi(meth)acrylate, methylenedi(meth)acrylate or pentaerythritoldi(meth)acrylate, alkenyldi(meth)acrylamides, N-methyldi(meth)acrylamide, N,N′-3-methylbutylidenebis(meth)acrylamide, N, N′-(1,2-dihydroxyethylene)bis(meth)acrylamide, N,N-hexamethylenebis-(meth)acrylamide or N,N-methylenebis(meth)acrylamide, polyalkoxydi(meth)acrylates, diethyleneglycoldi(meth)acrylate, triethyleneglycoldi(meth)acrylate, tetraethyleneglycoldi(meth)acrylate, dipropyleneglycoldi(meth)acrylate, tripropyleneglycoldi(meth)acrylate or tetrapropyleneglycoldi(meth)acrylate, bisphenol-A-di(meth)acrylate, ethoxylated bisphenol-A-di(meth)acrylate, benzylidenedi(meth)acrylate, 1,3-di(meth)acryloyloxypropanol-2, hydroquinonedi(meth)acrylate, di(meth)acrylate esters of trimethylolpropane, ethoxylated di(meth)acrylate esters of trimethylolpropane, thioethyleneglycoldi(meth)acrylate, thiopropyleneglycoldi(meth)acrylate, thiopolyethyleneglycoldi(meth)acrylate, thiopolypropyleneglycoldi(meth)acrylate, divinyl ethers, 1,4-butanedioldivinylether, divinyl esters, divinyladipate, alkanedienes, butadiene or 1,6-hexadiene, divinylbenzene, di(meth)allyl compounds, di(meth)allylphthalate or di(meth)allylsuccinate, homo- and co-polymers of di(meth)allyldimethylammonium chloride and homo- and co-polymers of diethyl(meth)allylaminomethyl(meth)acrylateammonium chloride, vinyl(meth)acrylic compounds, vinyl(meth)acrylate, (meth)allyl(meth)acrylic compounds, (meth)allyl(meth)acrylate, (meth)allyl(meth)acrylate ethoxylated with 1 to 30 mol ethylene oxide per hydroxyl group, di(meth)allylesters of polycarbonic acids, di(meth)allylmaleate, di(meth)allylfumarate, di(meth)allylsuccinate or di(meth)allylterephthalate, compounds with 3 or more ethylenically unsaturated, glycerine tri(meth)acrylate, (meth)acrylate esters of glycerins which are ethoxylated, trimethylolpropanetri(meth)acrylate, tri(meth)acrylate esters of trimethylolpropane, ethoxylated tri(meth)acrylate esters of trimethylolpropane, trimethacrylamide, (meth)allylidenedi(meth)acrylate, 3-allyloxy-1,2-propanedioldi(meth)acrylate, tri(meth)allylcyanurate, tri(meth)allylisocyanurate, pentaerythritoltetra(meth)acrylate, pentaerythritoltri(meth)acrylate, (meth)acrylic acid esters of pentaerythritol which is ethoxylated, tris(2-hydroxyethyl)isocyanuratetri(meth)acrylate, trivinyltrimellitate, tri(meth)allylamine, di(meth)allylalkylamines, di(meth)allylmethylamine, tri(meth)allylphosphate, tetra(meth)allylethylenediamine, poly(meth)allyl ester, tetra(meth)allyloxyethane or tetra(meth)allylammonium halides;
(S72) Polymer containing monoethylenically unsaturated acidic group-containing monomers S70A and monoethylenically unsaturated monomers S70B which are cross-linked with at least one cross-linker S72C selected from:
polyols, ethyleneglycol, polyethyleneglycols, diethyleneglycol, triethyleneglycol, tetraethyleneglycol, propyleneglycol, polypropyleneglycols, dipropyleneglycol, tripropyleneglycol, tetrapropyleneglycol, 1,3-butanediol, 1,4-butanediol, 1,5-pentanediol, 2,4-pentanediol, 1,6-hexanediol, 2,5-hexanediol, glycerine, polyglycerin, trimethylolpropane, polyoxypropylene, oxyethylene-oxypropylene-block copolymer, sorbitan fatty acid esters, polyoxyethylenesorbitan fatty acid esters, pentaerythritol, polyvinylalcohol and sorbitol, aminoalcohols, ethanolamine, diethanolamine, triethanolamine or propanolamine, polyamine compounds, ethylenediamine, diethylenetriamine, triethylenetetraamine, tetraethylenepentaamine or pentaethylenehexaamine, polyglycidyl ether compounds, ethyleneglycol diglycidyl ether, polyethyleneglycol diglycidyl ether, glycerinediglycidyl ether, glycerinepolyglycidyl ether, pentaerithritolpolyglycidyl ether, propyleneglycoldiglycidyl ether, polypropyleneglycoldiglycidyl ether, neopentylglycoldiglycidyl ether, hexanediolglycidyl ether, trimethylolpropanepolyglycidyl ether, sorbitolpolyglycidyl ether, phthalic acid diglycidyl ester, adipinic acid diglycidyl ether, 1,4-phenylenebis(2-oxazoline), glycidol, polyisocyanates, diisocyanates, 2,4-toluenediioscyanate, hexamethylenediisocyanate, polyaziridine compounds, 2,2-bishydroxymethylbutanol-tris[3-(1-aziridinyl-)propionate], 1,6-hexamethylenediethyleneurea, diphenylmethane-bis-4,4′-N, N′-diethyleneurea, halogen epoxides, epichlorohydrin, epibromohydrin and alpha-methylepichlorohydrin, alkylenecarbonates, 1,3-dioxolane-2-one (ethylene carbonate), 4-methyl-1, 3-dioxolane-2-one(propylene carbonate), 4,5-dimethyl-1,3-dioxolane-2-one, 4,4-dimethyl-1,3-dioxolane-2-one, 4-ethyl-1, 3-dioxolane-2-one, 4-hydroxymethyl-1,3-dioxolane-2-one, 1, 3-dioxane-2-one, 4-methyl-1,3-dioxane-2-one, 4,6-dimethyl-1,3-dioxane-2-one, 1,3-dioxolane-2-one, poly-1,3-dioxolane-2-one, polyquaternary amines, condensation products from dimethylamines and epichlorohydrin, polyoxazolines, 1, 2-ethylenebisoxazoline, crosslinkers with silane groups, 7-glycidooxypropyltrimethoxysilane, 7-aminopropyltrimethoxysilane, oxazolidinones, 2-oxazolidinone, bis- and poly-2-oxazolidinone and diglycolsilicates;
(S73) Polymer containing monoethylenically unsaturated acidic group-containing monomers S70A and monoethylenically unsaturated monomers S70B which are cross-linked with at least one cross-linker S73C selected from:
hydroxyl or amino group-containing esters of (meth)acrylic acid, 2-hydroxyethyl(meth)acrylate, as well as hydroxyl or amino group-containing (meth)acrylamides, or mono(meth)allylic compounds of diols;
(S74) Polymer containing monoethylenically unsaturated acidic group-containing monomers S70A and monoethylenically unsaturated monomers S70B which are cross-linked with at least one polyvalent metal cross-linker S74C selected from:
singly charged cations,
doubly charged cations derived from zinc, beryllium, alkaline earth metals, magnesium, calcium, strontium,
cations with higher charge selected from cations from aluminium, iron, chromium, manganese, titanium, zirconium and other transition metals as well as double salts of such cations or mixtures of said salts;
(S80) Polymer selected from the groups (S81), (S82), (S83), (S84), (S85), (S86), and (S87):
(S81) Polymer produced by the process disclosed in WO2013/060848;
(S82) polymer produced by the process (S80P1);
(S83) polymer produced by the process (S80P2);
(S84) polymer mixed or grafted with lignocellulose material;
(S85) polymer mixed or grafted with lignocellulose material selected from list (S80L1);
(S86) polymer containing acrylic acid, or its salts thereof, as monomeric units, mixed or grafted with lignocellulose material selected from list (S80L1);
(S87) polymer selected from the groups (S11), (S12), (S13), (S21), (S22), (S23), (S24), (S25), (S32), (S33), (S34), (S35), (S41), (S42), (S43), (S51), (S52), (S53), (S54), (S55), (S61), (S62), (S63), (S64), (S65), (S71), (S72), (S73), and (S74), mixed or grafted with lignocellulose material selected from list (S80L1),
wherein (S80P1) is a process for producing polymer composites suitable for absorbing and storing aqueous liquids, comprising:
a free-radical polymerization of a monomer composition S80M which
a) 50 to 100% by weight, based on the total amount of monomers S80A and S80B, of at least one monomer S80A having one ethylenic double bond and at least one neutralizable acid group,
b) 0 to 50% by weight of optionally one or more comonomers S80B which are different than the monomers S80A and have one ethylenic double bond, and
c) 0 to 10% by weight, based on the total amount of monomers S80A and S80B, of at least one crosslinker S80C,
in an aqueous suspension of a water-insoluble particulate substance S80S comprising cellulose or lignocellulose, the weight ratio of the monomer composition S80M to the substance S80S being in the range from 9:1 to 1:9;
wherein the monomers S80A used for polymerization are present in the aqueous suspension in anionic form to an extent of at least 10 mol %,
wherein (S80P2) is the process according to (S80P1), wherein the particulate substance S80S comprises a lignocellulose material and the substance S80S is selected to an extent of at least 50% by weight, based on the total amount of substance S80S, from the list (S80L1),
wherein the list (S80L1) is: hemp dust, flax dust, sawdust, bran, ground straw, ground olive stones, ground tree bark, reject material from pulp production, sugar beet peel, sugar cane waste, rice husks, cereal husks, ground hemp fibers, ground flax fibers, ground Chinese silvergrass fibers, ground coconut fibers, ground kenaf fibers or ground wood fibers, pulp or mechanical pulp from papermaking, and wastes from biogas production,
(S90) Inorganic superabsorbent materials: phyllosilicates, phyllosilicates in form of exfoliated or semi-exfoliated clay, clay selected from the group consisting of smectites, hectorites, bentonites, montmorillonites, celites, illites and mixtures thereof;
and
2) at least one biopesticide (L) selected from the groups (L1), (L3), (L5) and (L7):
(L1) Microbial pesticides with fungicidal, bactericidal, viricidal and/or plant defense activator activity selected from:
(L11) Ampelomyces quisqualis,
(L12) Aspergillus flavus,
(L13) Aureobasidium pullulans,
(L14) Bacillus amyloliquefaciens,
(L15) Bacillus mojavensis,
(L16) Bacillus pumilus,
(L17) Bacillus simplex,
(L18) Bacillus solisalsi,
(L19) Bacillus subtilis,
(L20) Bacillus subtilis var. amyloliquefaciens,
(L21) Candida oleophila, or C. saitoana,
(L22) Clavibacter michiganensis (bacteriophages),
(L23) Coniothyrium minitans,
(L24) Cryphonectria parasitica,
(L25) Cryptococcus albidus,
(L26) Dilophosphora alopecuri,
(L27) Fusarium oxysporum,
(L28) Clonostachys rosea f catenulate (also named Gliocladium catenulatum),
(L29) Gliocladium roseum,
(L30) Lysobacter antibioticus, or L. enzymogenes,
(L31) Metschnikowia fructicola,
(L32) Microdochium dimerum,
(L33) Microsphaeropsis ochracea,
(L34) Muscodor albus,
(L35) Paenibacillus polymyxa,
(L36) Pantoea vagans,
(L37) Phlebiopsis gigantea,
(L38) Pseudomonas sp., or Pseudomonas chloraphis,
(L39) Pseudozyma flocculosa,
(L40) Pichia anomala,
(L41) Pythium oligandrum,
(L42) Sphaerodes mycoparasitica,
(L43) Streptomyces griseoviridis, S. lydicus, or S. violaceusniger,
(L44) Talaromyces flavus,
(L45) Trichoderma asperellum, T. atroviride, T. fertile, T. gamsii, T. harmatum, T. harzianum, T. stromaticum, T. virens (also named Gliocladium virens), T. viride, or mixture of T. harzianum and T. viride, or mixture of T. polysporum and T. harzianum,
(L46) Typhula phacorrhiza,
(L47) Ulocladium oudemansii,
(L48) Verticillium dahlia,
(L49) zucchini yellow mosaic virus (avirulent strain);
(L3) Microbial pesticides with insecticidal, acaricidal, molluscidal and/or nematicidal activity selected from:
(L51) Agrobacterium radiobacter,
(L52) Bacillus cereus,
(L53) Bacillus firmus,
(L54) Bacillus thuringiensis, B. t. ssp. aizawai, B. t. ssp. israelensis, B. t. ssp. galleriae, B. t. ssp. kurstaki, or B. t. ssp. tenebrionis,
(L55) Beauveria bassiana, or B. brongniartii,
(L56) Burkholderia sp.,
(L57) Chromobacterium subtsugae,
(L58) Cydia pomonella granulosis virus,
(L59) Cryptophlebia leucotreta granulovirus (Cr1eGV),
(L60) Isaria fumosorosea,
(L61) Heterorhabditis bacteriophora,
(L62) Lecanicillium longisporum, or L. muscarium (formerly Verticillium lecanii),
(L63) Metarhizium anisopliae, or M. anisopliae var. acridum,
(L64) Nomuraea rileyi,
(L65) Paecilomyces fumosoroseus, or P. lilacinus,
(L66) Paenibacillus popilliae,
(L67) Pasteuria spp., P. nishizawae, P. penetrans, P. ramose, P. reneformis, P. thornea, or P. usgae,
(L68) Pseudomonas fluorescens,
(L69) Steinernema carpocapsae, S. feltiae, or S. kraussei;
(L5) Microbial pesticides with plant stress reducing, plant growth regulator, plant growth promoting and/or yield enhancing activity selected from:
(L81) Azospirillum amazonense, A. brasilense, A. lipoferum, A. irakense, or A. halopraeferens,
(L82) Bradyrhizobium sp., B. elkanii, B. japonicum, B. liaoningense, or B. lupini,
(L83) Delftia acidovorans,
(L84) VA mycorrhiza selected from the genera Glomus, Acaulospora, Entrophosphora, Gigaspora, Scutellospora and Sclerocytis,
(L85) VA mycorrhiza selected from the group consisting of Glomus fasciculatum, G. caledonium, G. mosseae, G. versiforme, G. intraradices and G. etunicatum,
(L86) Mesorhizobium sp.,
(L87) Paenibacillus alvei,
(L88) Penicillium bilaiae,
(L89) Rhizobium leguminosarum bv. phaseoli, R. l. trifolii, R. l. bv. viciae, or R. tropici,
(L90) Sinorhizobium meliloti,
(L91) Enterobacter spp., E. ludwigii, E. aerogenes, E. amnigenus, E. agglomerans, E. arachidis, E. asburiae, E. cancerogenous, E. cloacae, E. cowanii, E. dissolvens, E. gergoviae, E. helveticus, E. hormaechei, E. intermedius, E. kobei, E. mori, E. nimipressuralis, E. oryzae, E. pulveris, E. pyrinus, E. radicincitans, E. taylorae, E. turicensis, or E. sakazakii,
(L92) Oxalobacteraceae spp., Herbaspirillum seropedicae (DSM No.: 6445) (free-living nitrogen fixing bacterium), Janthinobacterium lividum (DSM No.: 1522) (violacein-producing bacterium), or Pseudoduganella violaceinigra (DSM No.: 15887) (violacein-producing bacterium);
(L7) Metabolites produced by the microbial pesticides selected from:
(L93) siderophores, bacillibactin
(L94) antibiotiics such as zwittermicin-A, kanosamine, polyoxine, bacilysin, violacein
(L95) enzymes such as alpha-amylase, chitinases, pektinases, phosphatase (acid and alkaline) and phytase
(L96) phytohormones and precursors thereof and volatile compounds, such as auxines, gibberellin-like substances, cytokinin-like compounds, acetoin, 2,3-butanediol, ethylene, indole acetic acid,
(L97) lipopeptides such as iturins, plipastatins, surfactins, agrastatin, agrastatin A, bacillomycin, bacillomycin D, fengycin,
(L98) antibacterial polyketides such as difficidin, macrolactin and bacilaene
(L99) antifungal metabolites such as pyrones, cytosporone, 6-pentyl-2H-pyran-2-one (also termed 6-pentyl-a-pyrone), koninginins (complex pyranes), in particular those metabolites produced by Trichoderma species.

17. A mixture or a kit-of-parts according to claim 16, wherein the at least one biopesticide (L) is (L14), (L15), (L16), (L17), (L18), (L19), (L20), (L45), (L51), (L65), (L81), (L82), (L84), (L85), (L87), (L89), or (L91).

18. The mixture or a kit-of-parts according to claim 16, wherein the at least one biopesticide (L) is (L16), (L51), (L81), (L82), (L85), (L87), (L89) or (L91).

19. The mixture or a kit-of-parts according to claim 16, wherein the at least one biopesticide (L) is Bacillus pumilus, Bacillus amyloliquefaciens, Bacillus subtilis, Bacillus subtilis var. amyloliquefaciens, Bacillus simplex, Trichoderma fertile, Agrobacterium radiobacter, Paecilomyces lilacinus, Azospirillum amazonense, A. brasilense, A. lipoferum, A. irakense, A. halopraeferens, Glomus intraradices, Bradyrhizobium sp., B. elkanii, B. japonicum, B. liaoningense, B. lupini, Paenibacillus alvei, Rhizobium leguminosarum bv. phaseoli, R. l. trifolii, R. l. bv. viciae, R. tropici or Enterobacter ludwigii.

20. The mixture or a kit-of-parts according to claim 16, wherein the at least one superabsorbent polymer (S) is
(S80) a polymer selected from the groups (S81), (S82), (S83), (S84), (S85), (S86) and (S87).

21. The mixture or a kit-of-parts according to claim 16, wherein the at least one superabsorbent polymer (S) is
(S86) polymer containing acrylic acid, or its salts thereof, as monomeric units, mixed or grafted with lignocellulose material selected from list (S80L1).

22. The mixture or a kit-of-parts according to claim 16, wherein the at least one superabsorbent polymer (S) is
(S86) polymer containing acrylic acid, or its salts thereof, as monomeric units, mixed or grafted with lignocellulose material selected from list (S80L1), and the at least one biopesticide (L) is Bacillus pumilus, Bacillus amyloliquefaciens, Bacillus subtilis, Bacillus subtilis var. amyloliquefaciens, Bacillus simplex, Trichoderma fertile, Agrobacterium radiobacter, Paecilomyces lilacinus, Azospirillum amazonense, A. brasilense, A. lipoferum, A. irakense, A. halopraeferens, Glomus intraradices, Bradyrhizobium sp., B. elkanii, B. japonicum, B. liaoningense, B. lupini, Paenibacillus alvei, Rhizobium leguminosarum bv. phaseoli, R. l. trifolii, R. l. bv. viciae, R. tropici, or Enterobacter ludwigii.

23. The method for conducting the combined application of
1) at least one superabsorbent polymer (S) selected from the groups (S10), (S20), (S30), (S40), (S50), (S60), (S70), (S80), and (S90):
(S10) Peptide/protein-based SAP selected from the groups (S11), (S12), and (S13):
(S11) Naturally occurring peptide/protein-based SAP: elastin, collagen, Gelatin A, Gelatin B, silk fibroin, globular proteins, beta-lactoglobulin, bovine serum albumin, ovalbumin;
(S12) Semi-synthetic or fully-synthetic peptide/protein-based SAP: collagen-based synthetic hydrogels, elastin-like polypeptides, silk-elastin-like polypeptides, hydrogels based on a coiled coil motif, triblock polypeptides, polyaspartic acid, polyaspartates, polyglutamic acid, polyglutamates;
(S13) Peptide/protein-based SAP other than those listed in (S11) or (S12);
(S20) Polysaccharide selected from the groups (S21), (S22), (S23), (S24), and (S25):
(S21) Naturally occurring polysaccharide: agar, alginate, beta-glucan, carrageenan, cellulose, micro-/nanofibrillar cellulose, chitin, dextran, galactomannan, glucomannan, guar gum, gum arabic, hyaluronan, pectin starch, starch, starch derivatives, xanthan;
(S22) Semi-synthetic or fully-synthetic polysaccharide: carboxymethyl starch (CMS), sulfoethyl starch (SES), carboxymethyl cellulose (CMC), sulfoethyl cellulose (SEC), hydroxypropyl cellulose, hydroxyethyl cellulose, methylcellulose, chitosan;
(S23) Cross-linked polysaccharide: CMS cross-linked with multi-functional carboxylic acids (MFC) or multi-functional epoxides (MFE), SES cross-linked with MFC or MFE, CMC cross-linked with MFC or MFE, SEC cross-linked with MFC or MFE, hydroxypropyl cellulose cross-linked with MFC or MFE, hydroxyethyl cellulose cross-linked with MFC or MFE, methylcellulose cross-linked with MFC or MFE, chitosan cross-linked with MFC or MFE;
(S24) Polysaccharide graft copolymer: Polysaccharides obtained by graft polymerizing a monomer onto a polysaccharide, wherein the monomer is selected from acrylonitrile, acrylic acid, methacrylic acid, acrylamide, methacrylamide, 2 -acrylamido-2-methyl-propanesulfonic acid (AMPS), vinyl sulfonic acid, ethyl acrylate, and potassium acrylate;
(S25) Polysaccharide other than those listed in (S21), (S22), (S23) or (S24);
(S30) Polymer containing one or more unsaturated carboxylic acid, or its salts thereof, as monomeric units, selected from the groups (S31), (S32), (S33), (S34), and (S35):
(S31) Polymer containing acrylic acid, or its salts thereof, as monomeric units;
(S32) Polymer containing methacrylic acid, or its salts thereof, as monomeric units;
(S33) Polymer containing as monomeric units at least one of the unsaturated carboxylic acids—or salts thereof—selected from: crotonic acid, isocrotonic acid, 2′-methylisocrotonic acid, maleic acid, fumaric acid, vinyl acetic acid, ethacrylic acid, alpha-chloroacrylic acid, alpha-cyanoacrylic acid, alpha-phenylacrylic acid, beta-acryloxypropionic acid, sorbinic acid, alpha-chlorosorbinic acid, cinnamic acid, p-chlorocinnamic acid, beta-stearic acid, itaconic acid, citraconic acid, mesaconic acid, glutaconic acid, aconitic acid, tricarboxy ethylene, and maleic acid anhydride;
(S34) Polymer containing as monomeric units at least one of the unsaturated carboxylic acids—or salts thereof—selected from: terephthalic acid, dimethyl terephthalate, phthalic acid, isophthalic acid, naphthalene dicarboxylic acid, 4-hydroxybenzoic acid, 6-hydroxynaphthalene-2-carboxylic acid:
(S35) Polymer containing as monomeric units one or more unsaturated carboxylic acid—or salts thereof—which are not listed in (S31), (S32), (S33), or (S34);
(S40) Polymer containing one or more unsaturated sulfonic acid, or one or more unsaturated phosphonic acid, or its salts thereof, as monomeric units, selected from the groups (S41), (S42), and (S43):
(S41) Polymer containing as monomeric units at least one of the unsaturated sulfonic acids—or salts thereof—selected from: 2-acrylamido-2-methyl-1-propanesulfonic acid (AMPS), methallyl sulfonic acid, allyl sulfonic acid, acrylic sulfonic acid, methacrylic sulfonic acid, vinyl sulfonic acid, 4-vinylbenzylsulfonic acid, vinyltoluenesulfonic acid, styrenesulfonic acid, sulfoethyl(meth)acrylate, sulfopropyl(meth)acrylate, and 2-hydroxy-3-methacryloxypropylsulfonic acid;
(S42) Polymer containing as monomeric units at least one of the unsaturated phosphonic acids—or salts thereof—selected from: vinylphosphonic acid, allylphosphonic acid, vinylbenzylphosphonic acid, (meth)acrylamidoalkylphosphonic acids, acrylamidoalkyldiphosphonic acids, phosphonomethylated vinylamines and (meth)acrylphosphonic acid derivatives;
(S43) Polymer containing as monomeric units one or more unsaturated sulfonic acids not listed in (S41) or one or more unsaturated phosphonic acids not listed in (S42);
(S50) Polymer containing one or more amines or amides as monomeric units, selected from the groups (S51), (S52), (S53), (S54) and (S55):
(S51) Polymer containing acrylamide or methacrylamide as monomeric units;
(S52) Polymer containing as monomeric units at least one of the unsaturated amides selected from; N-methylol(meth)acrylamide, N, N-dimethylamino(meth)acrylamide, dimethyl(meth)acrylamide, diethyl(meth)acrylamide, N-vinylamides, N-vinylformamides, N-vinylacetamides, N-vinyl-N-methylacetamide, N-vinyl-N-methylformamides, vinylpyrrolidone;
(S53) Polymer containing as monomeric units one or more amides not listed in (S51) or (S52);
(S54) Polymer containing as monomeric units at least one primary amine, secondary amine, tertiary amine, or quarternary ammonium salt;
(S55) Polyamidoamines;
(S60) Polymer containing optionally cross-linked polyethers or polyols, selected from the groups (S61), (S62), (S63), (S64), and (S65):
(S61) Polymer containing optionally cross-linked polyethylene glycol (PEG);
(S62) Polymer containing optionally cross-linked polypropylene glycol (PPG) or poly(oxyethylene-oxypropylene) copolymer;
(S63) Polymer containing at least one optionally cross-linked polyether selected from: polyoxymethylene, poly(tetrahydrofuran), polyphenyl ether (PPE), and poly(p-phenylene oxide) (PPO);
(S64) Polymer containing optionally cross-linked polyvinyl alcohol;
(S65) Polymer containing optionally cross-linked polyethers or polyols not listed in (S61), (S62), (S63) or (S64);
(S70) Polymer selected from the groups (S71), (S72), (S73), and (S74):
(S71) Polymer containing monoethylenically unsaturated acidic group-containing monomers S70A and monoethylenically unsaturated monomers S70B which are cross-linked with at least one cross-linker S71C selected from: alkenyldi(meth)acrylates, ethyleneglycol di(meth)acrylate, 1,3-propyleneglycol di(meth)acrylate, 1,4-butyleneglycol di(meth)acrylate, 1,3-butyleneglycol di(meth)acrylate, 1,6-hexanedioldi(meth)acrylate, 1,10-decanedioldi(meth)acrylate, 1,12-dodecanedioldi(meth)acrylate, 1,18-octadecanedioldi(meth)acrylate, cyclopentanedioldi(meth)acrylate, neopentylglycoldi(meth)acrylate, methylenedi(meth)acrylate or pentaerythritoldi(meth)acrylate, alkenyldi(meth)acrylamides, N-methyldi(meth)acrylamide, N,N′-3-methylbutylidenebis(meth)acrylamide, N, N′-(1,2-dihydroxyethylene)bis(meth)acrylamide, N,N′-hexamethylenebis-(meth)acrylamide or N,N-methylenebis(meth)acrylamide, polyalkoxydi(meth)acrylates, diethyleneglycoldi(meth)acrylate, triethyleneglycoldi(meth)acrylate, tetraethyleneglycoldi(meth)acrylate, dipropyleneglycoldi(meth)acrylate, tripropyleneglycoldi(meth)acrylate or tetrapropyleneglycoldi(meth)acrylate, bisphenol-A-di(meth)acrylate, ethoxylated bisphenol-A-di(meth)acrylate, benzylidenedi(meth)acrylate, 1,3-di(meth)acryloyloxypropanol-2, hydroquinonedi(meth)acrylate, di(meth)acrylate esters of trimethylolpropane, ethoxylated di(meth)acrylate esters of trimethylolpropane, thioethyleneglycoldi(meth)acrylate, thiopropyleneglycoldi(meth)acrylate, thiopolyethyleneglycoldi(meth)acrylate, thiopolypropyleneglycoldi(meth)acrylate, divinyl ethers, 1,4-butanedioldivinylether, divinyl esters, divinyladipate, alkanedienes, butadiene or 1,6-hexadiene, divinylbenzene, di(meth)allyl compounds, di(meth)allylphthalate or di(meth)allylsuccinate, homo- and co-polymers of di(meth)allyldimethylammonium chloride and homo- and co-polymers of diethyl(meth)allylaminomethyl(meth)acrylateammonium chloride, vinyl(meth)acrylic compounds, vinyl(meth)acrylate, (meth)allyl(meth)acrylic compounds, (meth)allyl(meth)acrylate, (meth)allyl(meth)acrylate ethoxylated with 1 to 30 mol ethylene oxide per hydroxyl group, di(meth)allylesters of polycarbonic acids, di(meth)allylmaleate, di(meth)allylfumarate, di(meth)allylsuccinate or di(meth)allylterephthalate, compounds with 3 or more ethylenically unsaturated, glycerine tri(meth)acrylate, (meth)acrylate esters of glycerins which are ethoxylated, trimethylolpropanetri(meth)acrylate, tri(meth)acrylate esters of trimethylolpropane, ethoxylated tri(meth)acrylate esters of trimethylolpropane, trimethacrylamide, (meth)allydenedi(meth)acrylate, 3-allyloxy-1,2-propanedioldi(meth)acrylate, tri(meth)allylcyanurate, tri(meth)allylisocyanurate, pentaerythritoltetra(meth)acrylate, pentaerythritoltri(meth)acrylate, (meth)acrylic acid esters of pentaerythritol which is ethoxylated, tris(2-hydroxyethyl)isocyanuratetri(meth)acrylate, trivinyltrimellitate, tri(meth)allylamine, di(meth)allylalkylamines, di(meth)allylmethylamine, tri(meth)allylphosphate, tetra(meth)allylethylenediamine, poly(meth)allyl ester, tetra(meth)allyloxyethane or tetra(meth)allylammonium halides;
(S72) Polymer containing monoethylenically unsaturated acidic group-containing monomers S70A and monoethylenically unsaturated monomers S70B which are cross-linked with at least one cross-linker S72C selected from: polyols, ethyleneglycol, polyethyleneglycols, diethyleneglycol, triethyleneglycol, tetraethyleneglycol, propyleneglycol, polypropyleneglycols, dipropyleneglycol, tripropyleneglycol, tetrapropyleneglycol, 1,3-butanediol, 1,4-butanediol, 1,5-pentanediol, 2,4-pentanediol, 1,6-hexanediol, 2,5-hexanediol, glycerine, polyglycerin, trimethylolpropane, polyoxypropylene, oxyethylene-oxypropylene-block copolymer, sorbitan fatty acid esters, polyoxyethylenesorbitan fatty acid esters, pentaerythritol, polyvinylalcohol and sorbitol, aminoalcohols, ethanolamine, diethanolamine, triethanolamine or propanolamine, polyamine compounds, ethylenediamine, diethylenetriamine, triethylenetetraamine, tetraethylenepentaamine or pentaethylenehexaamine, polyglycidyl ether compounds, ethyleneglycol diglycidyl ether, polyethyleneglycol diglycidyl ether, glycerinediglycidyl ether, glycerinepolyglycidyl ether, pentaerithritolpolyglycidyl ether, propyleneglycoldiglycidyl ether, polypropyleneglycoldiglycidyl ether, neopentylglycoldiglycidyl ether, hexanediolglycidyl ether, trimethylolpropanepolyglycidyl ether, sorbitolpolyglycidyl ether, phthalic acid diglycidyl ester, adipinic acid diglycidyl ether, 1,4-phenylenebis(2-oxazoline), glycidol, polyisocyanates, diisocyanates, 2,4-toluenediioscyanate, hexamethylenediisocymate, polyaziridine compounds, 2,2-bishydroxymethylbutanol-tris[3-(1-aziridinyl-)propionate], 1,6-hexamethylenediethyleneurea, diphenylmethane-bis-4,4′-N, N′-diethyleneurea, halogen epoxides, epichlorohydrin, epibromohydrin and alpha-methylepichlorohydrin, alkylenecarbonates, 1,3-dioxolane-2-one (ethylene carbonate), 4-methyl-1, 3-dioxolane-2-one(propylene carbonate), 4,5-dimethyl-1,3-dioxolane-2-one, 4,4-dimethyl-1,3-dioxolane-2-one, 4-ethyl-1,3-dioxolane-2-one, 4-hydroxymethyl-1,3-dioxolane-2-one, 1, 3-dioxane-2-one, 4-methyl-1,3-dioxane-2-one, 4,6-dimethyl-1,3-dioxane-2-one, 1,3-dioxolane-2-one, poly-1,3-dioxolane-2-one, polyquaternary amines, condensation products from dimethylamines and epichlorohydrin, polyoxazolines, 1, 2-ethylenebisoxazoline, crosslinkers with silane groups, 7-glycidooxypropyltrimethoxysilane, 7-aminopropyltrimethoxysilane, oxazolidinones, 2-oxazolidinone, bis- and poly-2-oxazolidinone and diglycolsilicates;
(S73) Polymer containing monoethylenically unsaturated acidic group-containing monomers S70A and monoethylenically unsaturated monomers S70B which are cross-linked with at least one cross-linker S73C selected from:
hydroxyl or amino group-containing esters of (meth)acrylic acid, 2-hydroxyethyl(meth)acrylate, as well as hydroxyl or amino group-containing (meth)acrylamides, or mono(meth)allylic compounds of diols;
(S74) Polymer containing monoethylenically unsaturated acidic group-containing monomers S70A and monoethylenically unsaturated monomers S70B which are cross-linked with at least one polyvalent metal cross-linker S74C selected from:
singly charged cations,
doubly charged cations derived from zinc, beryllium, alkaline earth metals, magnesium, calcium, strontium,
cations with higher charge selected from cations from aluminium, iron, chromium, manganese, titanium, zirconium and other transition metals as well as double salts of such cations or mixtures of said salts;
(S80) Polymer selected from the groups (S81), (S82), (S83), (S84), (S85), (S86), and (S87):
(S81) Polymer produced by the process disclosed in WO2013/060848;
(S82) polymer produced by the process (S80P1);
(S83) polymer produced by the process (S80P2);
(S84) polymer mixed or grafted with lignocellulose material;
(S85) polymer mixed or grafted with lignocellulose material selected from list (S80L1);
(S86) polymer containing acrylic acid, or its salts thereof, as monomeric units, mixed or grafted with lignocellulose material selected from list (S80L1);
(S87) polymer selected from the groups (S11), (S12), (S13), (S21), (S22), (S23), (S24), (S25), (S32), (S33), (S34), (S35), (S41), (S42), (S43), (S51), (S52), (S53), (S54), (S55), (S61), (S62), (S63), (S64), (S65), (S71), (S72), (S73), and (S74), mixed or grafted with lignocellulose material selected from list (S80L1),
wherein (S80P1) is a process for producing polymer composites suitable for absorbing and storing aqueous liquids, comprising:
a free-radical polymerization of a monomer composition S80M which
a) 50 to 100% by weight, based on the total amount of monomers S80A and S80B, of at least one monomer S80A having one ethylenic double bond and at least one neutralizable acid group,
b) 0 to 50% by weight of optionally one or more comonomers S80B which are different than the monomers S80A and have one ethylenic double bond, and
c) 0 to 10% by weight, based on the total amount of monomers S80A and S80B, of at least one crosslinker S80C,
in an aqueous suspension of a water-insoluble particulate substance S80S comprising cellulose or lignocellulose, the weight ratio of the monomer composition S80M to the substance S80S being in the range from 9:1 to 1:9;
wherein the monomers S80A used for polymerization are present in the aqueous suspension in anionic form to an extent of at least 10 mol %,
wherein (S80P2) is the process according to (S80P1), wherein the particulate substance S80S comprises a lignocellulose material and the substance S80S is selected to an extent of at least 50% by weight, based on the total amount of substance S80S, from the list (S80L1),
wherein the list (S80L1) is: hemp dust, flax dust, sawdust, bran, ground straw, ground olive stones, ground tree bark, reject material from pulp production, sugar beet peel, sugar cane waste, rice husks, cereal husks, ground hemp fibers, ground flax fibers, ground Chinese silvergrass fibers, ground coconut fibers, ground kenaf fibers or ground wood fibers, pulp or mechanical pulp from papermaking, and wastes from biogas production,
(S90) Inorganic superabsorbent materials: phyllosilicates, phyllosilicates in form of exfoliated or semi-exfoliated clay, clay selected from the group consisting of smectites, hectorites, bentonites, montmorillonites, celites, illites and mixtures thereof;
and of
2) at least one biopesticide (L) selected from the groups (L1), (L3), (L5) and (L7):
(L1) Microbial pesticides with fungicidal, bactericidal, viricidal and/or plant defense activator activity selected from:
(L11) Ampelomyces quisqualis,
(L12) Aspergillus flavus,
(L13) Aureobasidium pullulans,
(L14) Bacillus amyloliquefaciens,
(L15) Bacillus mojavensis,
(L16) Bacillus pumilus,
(L17) Bacillus simplex,
(L18) Bacillus solisalsi,
(L19) Bacillus subtilis,
(L20) Bacillus subtilis var. amyloliquefaciens,
(L21) Candida oleophila, or C. saitoana,
(L22) Clavibacter michiganensis (bacteriophages),
(L23) Coniothyrium minitans,
(L24) Cryphonectria parasitica,
(L25) Cryptococcus albidus,
(L26) Dilophosphora alopecuri,
(L27) Fusarium oxysporum,
(L28) Clonostachys rosea f. catenulate (also named Gliocladium catenulatum),
(L29) Gliocladium roseum,
(L30) Lysobacter antibioticus, or L. enzymogenes,
(L31) Metschnikowia fructicola,
(L32) Microdochium dimerum,
(L33) Microsphaeropsis ochracea,
(L34) Muscodor albus,
(L35) Paenibacillus polymyxa,
(L36) Pantoea vagans,
(L37) Phlebiopsis gigantea,
(L38) Pseudomonas sp., or Pseudomonas chloraphis,
(L39) Pseudozyma flocculosa,
(L40) Pichia anomala,
(L41) Pythium oligandrum,
(L42) Sphaerodes mycoparasitica,
(L43) Streptomyces griseoviridis, S. lydicus, or S. violaceusniger,
(L44) Talaromyces flavus,
(L45) Trichoderma asperellum, T. atroviride, T. fertile, T. gamsii, T. harmatum, T. harzianum, T. stromaticum, T. virens (also named Gliocladium virens), T. viride, or mixture of T. harzianum and T. viride, or mixture of T. polysporum and T. harzianum,
(L46) Typhula phacorrhiza,
(L47) Ulocladium oudemansii,
(L48) Verticillium dahlia,
(L49) zucchini yellow mosaic virus (avirulent strain);
(L3) Microbial pesticides with insecticidal, acaricidal, molluscidal and/or nematicidal activity selected from:
(L51) Agrobacterium radiobacter,
(L52) Bacillus cereus,
(L53) Bacillus firmus,
(L54) Bacillus thuringiensis, B. t. ssp. aizawai, B. t. ssp. israelensis, B. t. ssp. galleriae, B. t. ssp. kurstaki, or B. t. ssp. tenebrionis,
(L55) Beauveria bassiana, or B. brongniartii,
(L56) Burkholderia sp.,
(L57) Chromobacterium subtsugae,
(L58) Cydia pomonella granulosis virus,
(L59) Cryptophlebia leucotreta granulovirus (Cr1eGV),
(L60) Isaria fumosorosea,
(L61) Heterorhabditis bacteriophora,
(L62) Lecanicillium longisporum, or L. muscarium (formerly Verticillium lecanii),
(L63) Metarhizium anisopliae, or M. anisopliae var. acridum,
(L64) Nomuraea rileyi,
(L65) Paecilomyces fumosoroseus, or P. lilacinus,
(L66) Paenibacillus popilliae,
(L67) Pasteuria spp., P. nishizawae, P. penetrans, P. ramose, P. reneformis, P. thornea, or P. usgae,
(L68) Pseudomonas fluorescens,
(L69) Steinernema carpocapsae, S. feltiae, or S. kraussei;
(L5) Microbial pesticides with plant stress reducing, plant growth regulator, plant growth promoting and/or yield enhancing activity selected from:
(L81) Azospirillum amazonense, A. brasilense, A. lipoferum, A. irakense, or A. halopraeferens,
(L82) Bradyrhizobium sp., B. elkanii, B. japonicum, B. liaoningense, or B. lupini,
(L83) Delftia acidovorans,
(L84) VA mycorrhiza selected from the genera Glomus, Acaulospora, Entrophosphora, Gigaspora, Scutellospora and Sclerocytis,
(L85) VA mycorrhiza selected from the group consisting of Glomus fasciculatum, G. caledonium, G. mosseae, G. versiforme, G. intraradices and G. etunicatum,
(L86) Mesorhizobium sp.,
(L87) Paenibacillus alvei,
(L88) Penicillium bilaiae,
(L89) Rhizobium leguminosarum bv. phaseoli, R. l. trifolii, R. l. bv. viciae, or R. tropici,
(L90) Sinorhizobium meliloti;
(L91) Enterobacter spp., E. ludwigii, E. aerogenes, E. amnigenus, E. agglomerans, E. arachidis, E. asburiae, E. cancerogenous, E. cloacae, E. cowanii, E. dissolvens, E. gergoviae, E. helveticus, E. hormaechei, E. intermedius, E. kobei, E. mori, E. nimipressuralis, E. oryzae, E. pulveris, E. pyrinus, E. radicincitans, E. taylorae, E. turicensis, or E. sakazakii,
(L92) Oxalobacteraceae spp., Herbaspirillum seropedicae (DSM No.: 6445) (free-living nitrogen fixing bacterium), Janthinobacterium lividum (DSM No.: 1522) (violacein-producing bacterium), or Pseudoduganella violaceinigra (DSM No.: 15887) (violacein-producing bacterium);
(L7) Metabolites produced by the microbial pesticides selected from:
(L93) siderophores, bacillibactin,
(L94) antibiotiics such as zwittermicin-A, kanosamine, polyoxine, bacilysin, violacein
(L95) enzymes such as alpha-amylase, chitinases, pektinases, phosphatase (acid and alkaline) and phytase,
(L96) phytohormones and precursors thereof and volatile compounds, such as auxines, gibberellin-like substances, cytokinin-like compounds, acetoin, 2,3-butanediol, ethylene, indole acetic acid,
(L97) lipopeptides such as iturins, plipastatins, surfactins, agrastatin, agrastatin A, bacillomycin, bacillomycin D, fengycin,
(L98) antibacterial polyketides such as difficidin, macrolactin and bacilaene,
(L99) antifungal metabolites such as pyrones, cytosporone, 6-pentyl-2H-pyran-2-one (also termed 6-pentyl-a-pyrone), koninginins (complex pyranes), in particular those metabolites produced by Trichoderma species
for improving soil quality, enhancing plant growth, for the control of harmful fungi or insects, soil treatment or seed treatment.

24. The method according to claim 23, wherein the at least one biopesticide (L) is (L14), (L15), (L16), (L17), (L18), (L19), (L20), (L45), (L51), (L65), (L81), (L82), (L84), (L85), (L87), (L89) or (L91).

25. The method according to claim 23, wherein the at least one biopesticide (L) is (L16), (L51), (L81), (L82), (L85), (L87), (L89) or (L91).

26. The method according to claim 23, wherein the at least one biopesticide (L) is Bacillus pumilus, Bacillus amyloliquefaciens, Bacillus subtilis, Bacillus subtilis var. amyloliquefaciens, Bacillus simplex, Trichoderma fertile, Agrobacterium radiobacter, Paecilomyces lilacinus, Azospirillum amazonense, A. brasilense, A. lipoferum, A. irakense, A. halopraeferens, Glomus intraradices, Bradyrhizobium sp., B. elkanii, B. japonicum, B. liaoningense, B. lupini, Paenibacillus alvei, Rhizobium leguminosarum bv. phaseoli, R. l. trifolii, R. l. bv. viciae, R. tropici, or Enterobacter ludwigii.

27. The method according to claim 23, wherein the at least one superabsorbent polymer (S) is
(S80) a polymer selected from the groups (S81), (S82), (S83), (S84), (S85), (S86) and (S87).

28. The method according to claim 23, wherein the at least one superabsorbent polymer (S) is
(S86) polymer containing acrylic acid, or its salts thereof, as monomeric units, mixed or grafted with lignocellulose material selected from list (S80L1).

29. The method according to claim 23, wherein the at least one superabsorbent polymer (S) is
(S86) polymer containing acrylic acid, or its salts thereof, as monomeric units, mixed or grafted with lignocellulose material selected from list (S80L1), and
the at least one biopesticide (L) is Bacillus pumilus, Bacillus amyloliquefaciens, Bacillus subtilis, Bacillus subtilis var. amyloliquefaciens, Bacillus simplex, Trichoderma fertile, Agrobacterium radiobacter, Paecilomyces lilacinus, Azospirillum amazonense, A. brasilense, A. lipoferum, A. irakense, A. halopraeferens, Glomus intraradices, Bradyrhizobium sp., B. elkanii, B. japonicum, B. liaoningense, B. lupini, Paenibacillus alvei, Rhizobium leguminosarum bv. phaseoli, R. l. trifolii, R. l. bv. viciae, R. tropici or Enterobacter ludwigii.

30. Use of the mixture of kit-of-parts according to claim 16 for improving soil quality, enhancing plant growth, for the control of harmful fungi or insects, soil treatment or seed treatment.
